(19) United States
(12) Patent Application Publication
(10) Pub. No.: US 2012/0316992 A1
(43) Pub. Date: Dec. 13, 2012

(54) PAYMENT PRIVACY TOKENIZATION APPARATUSES, METHODS AND SYSTEMS

(76) Inventor: Timothy W. Oborne, San Francisco, CA (US)

(21) Appl. No.: 13/491,591

(22) Filed: Jun. 7, 2012

Related U.S. Application Data
(60) Provisional application No. 61/494,402, filed on Jun. 7, 2011.

(51) Int. Cl. G06Q 30/06; G06F 17/30

(52) U.S. Cl. 705/26.41

(57) ABSTRACT

The PAYMENT PRIVACY TOKENIZATION APPARATUSES, METHODS AND SYSTEMS (“PPT”) transform payment token-based purchase orders via PPT components into multi-issuer purchase payment funds transfers. In one embodiment, the PPT obtains a token arbitration request including unique source-neutral universally-resolvable payment token information from a merchant for processing a purchase order from a user. The PPT queries a token database for issuer information on an issuer using the payment token information, and obtains the issuer information. The PPT also determines that the user should be queried for payment options based on the issuer information, and provides a payment options request to a user mobile device. Upon obtaining a response from the mobile device, the PPT generates a purchase authorization request based on the payment options and pre-defined settings for issuers to be contacted for processing the purchase order, and provides the generated purchase authorization request to the issuer.

### PRIORITY claim

Applicant hereby claims priority under 35 USC §119 for: U.S. provisional patent application Ser. No. 61/494,402 filed Jun. 7, 2011, entitled “PAYMENT PRIVACY TOKENIZATION APPARATUSES, METHODS AND SYSTEMS,” attorney docket no. P-42304PRV 120270-167PV. The entire contents of the aforementioned application are expressly incorporated herein by reference.

This application for letters patent discloses and describes various novel innovations and inventive aspects of PAYMENT PRIVACY TOKENIZATION technology (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address apparatuses, methods, and systems for purchase transactions, and more particularly, include PAYMENT PRIVACY TOKENIZATION APPARATUSES, METHODS AND SYSTEMS (“PPT”).

### BACKGROUND

Card-based consumer transactions typically require a customer to enter numerous details of a credit or debit card, or utilize a payment method such as cash or check. Engaging in card transactions requires transmission of personal information to a wide range of third-party merchants.

### BRIEF DESCRIPTION OF THE DRAWINGS

The accompanying appendices and/or drawings illustrate various non-limiting, example, inventive aspects in accordance with the present disclosure:

FIGS. 1A-B show block diagrams illustrating example aspects of payment tokenization in some embodiments of the PPT;

FIGS. 2A-B shows application user interface diagrams illustrating example features of application interfaces for controlling tokenized payments for purchase transactions in some embodiments of the PPT;

FIGS. 3A-C show application user interface diagrams illustrating example features of a payment tokenization mobile app for securing user data and preventing fraud in some embodiments of the PPT;

FIG. 4 shows a data flow diagram illustrating an example procedure to enroll in a token-based purchase payment program in some embodiments of the PPT;

FIG. 5 shows a logic flow diagram illustrating example aspects of enrolling in a token-based purchase payment program in some embodiments of the PPT, e.g., a Token-Based Purchase Enrollment (“TPE”) component 500;

FIGS. 6A-E show data flow diagrams illustrating an example procedure to execute a token-based purchase transaction in some embodiments of the PPT;

FIGS. 7A-F show logic flow diagrams illustrating example aspects of executing a token-based purchase transaction in some embodiments of the PPT, e.g., a Token-Based Purchase Transaction Execution (“tPTE”) component 700;

FIG. 8 shows a user interface diagram illustrating an overview of example features of virtual wallet applications in some embodiments of the PPT;

FIGS. 9A-G show user interface diagrams illustrating example features of virtual wallet applications in a shopping mode, in some embodiments of the PPT;

FIGS. 10A-F show user interface diagrams illustrating example features of virtual wallet applications in a payment mode, in some embodiments of the PPT;

FIG. 11 shows a user interface diagram illustrating example features of virtual wallet applications, in a history mode, in some embodiments of the PPT;

FIGS. 12A-E show user interface diagrams illustrating example features of virtual wallet applications in a snap mode, in some embodiments of the PPT;

FIG. 13 shows a user interface diagram illustrating example features of virtual wallet applications, in an offers mode, in some embodiments of the PPT;

FIGS. 14A-B show user interface diagrams illustrating example features of virtual wallet applications, in a security and privacy mode, in some embodiments of the PPT; and

FIG. 15 shows a block diagram illustrating embodiments of a PPT controller.

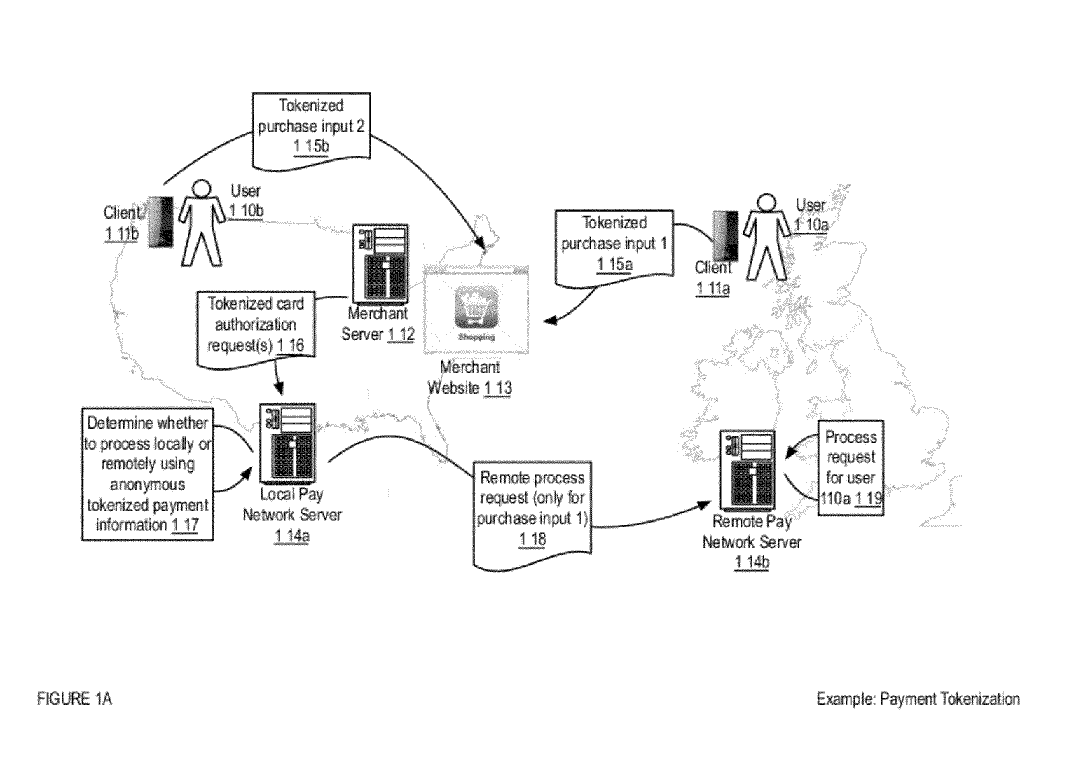

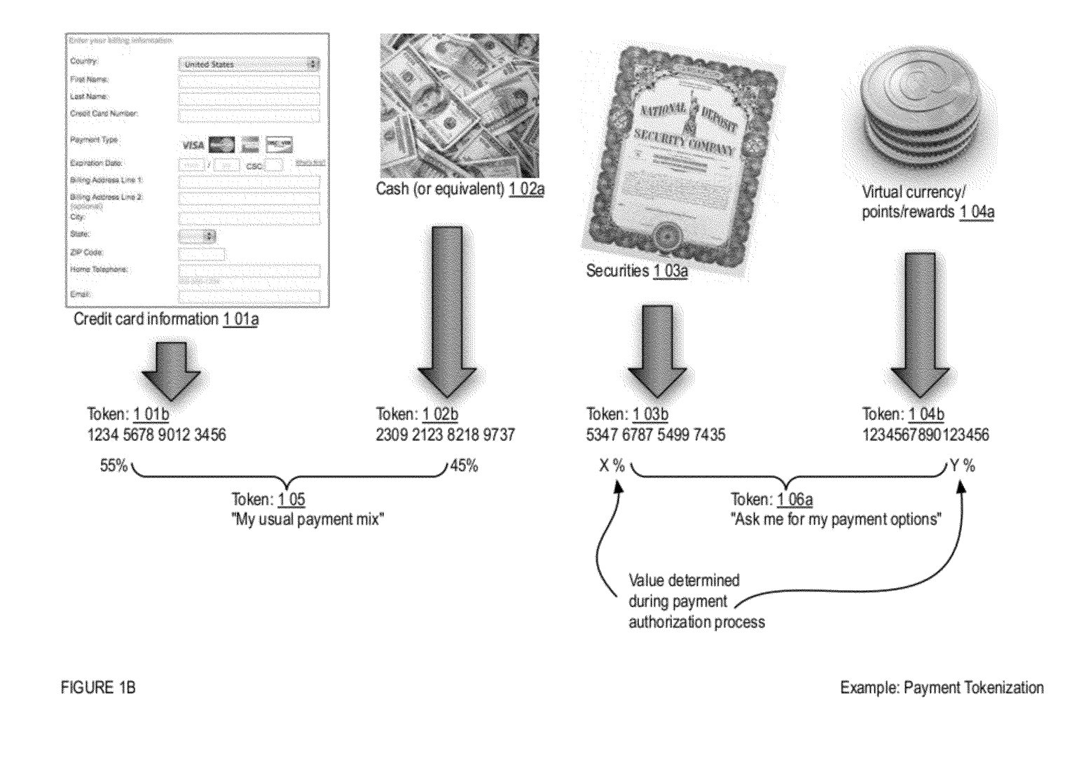

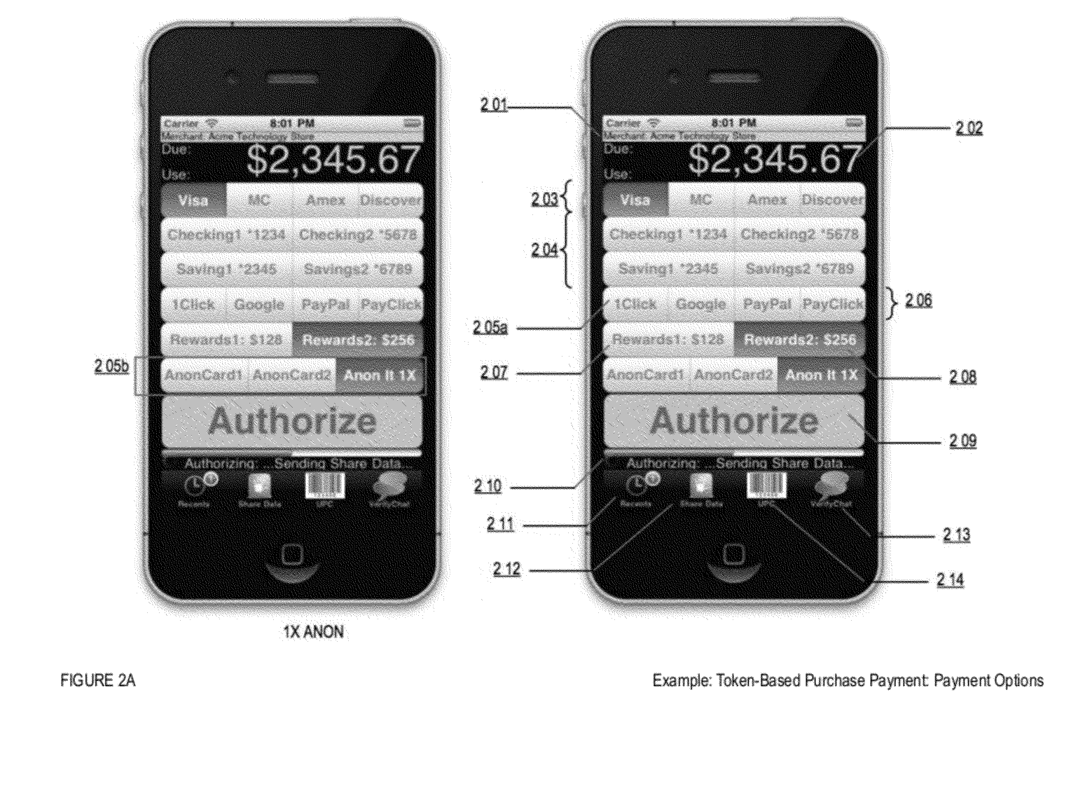

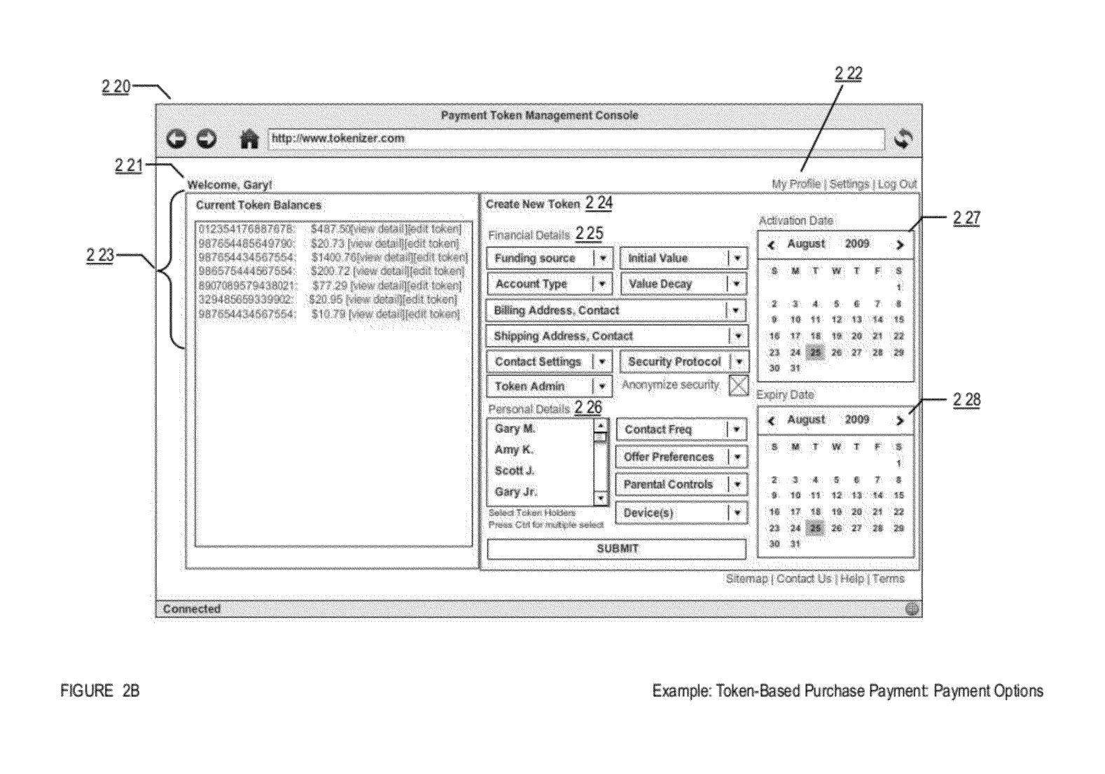

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Payment Privacy Tokenization (PPT)

The PAYMENT PRIVACY TOKENIZATION APPARATUSES, METHODS AND SYSTEMS (hereinafter “PPT”) transform payment token-based purchase orders, via PPT components, into multi-issuer purchase payment funds transfers.

FIGS. 1A-B show block diagrams illustrating example aspects of payment tokenization in some embodiments of the PPT. With reference to FIG. 1A, in some implementations, a payment network system, comprised of payment network servers located in distant geographical regions (e.g., local pay network server 114a and remote pay network server 114b) may be required to determine where to process a purchase transaction. For example, a user 110a may be located in a remote geographical region, and may access the website, e.g., 113, of a merchant, e.g., 112, in a different geographical region. In some implementations, the user 110a may utilize a client ma to provide the purchase input (e.g., 115a) to the merchant server 112. For example, the client ma may provide a payment token (e.g., via a Playspan UltimatePay Lightbox object executing within a browser environment on the client ma) to maintain the anonymity of the user. For example, the payment token may be an MD5 one-way cryptographic hash of the payment financial information, and may not provide any personally identifying information of the user. Although the token may not include identifying information, it may be based off of identifying information (e.g., based of a unique identifier); this has the advantage that a privacy enhancing data table may be populated by such hashes with the a country code of the user's information; the resulting table would maintain the anonymity of the user as the hash and country code cannot be used to identify the user's identity, however, such a table may then be used apply privacy regulations specific to the country code and thereby route the token and payment processing to payment servers in the appropriate country, thereby preventing the user's private information from being seen in inappropriate jurisdictions. In some implementations, the user 110a may desire to utilize, via the payment token, a payment mechanism (e.g., credit card, debit card, prepaid card, stored value account, etc.) that is generally for use in the remote geographical location. Thus, in some scenarios, a user from a remote geographical location may desire to utilize a payment mechanism designed for use in the remote geographical location to pay for a purchase made at a merchant located at a local geographical location, without revealing any personally identifying information of the user to the merchant or the payment network server located in the local geographical region.

For example, this scenario may be contrasted with a user 111b, utilizing a client 110b, and located in the local geographical location. For example, user 110b may utilize client 111b to provide a purchase input to the same merchant website 113 of the merchant 112 located in the local geographical location. In some implementations, the merchant server 112 may provide the purchase requests from both users to the same locally-situated payment network server, e.g., 114a. Thus, in some implementations, the local pay network server 114a may be required to determine whether to process the payment for an incoming card authorization request locally, or transfer the request to a remotely located pay network server, e.g., 114b. In some implementations, the local pay network server 114a may be required to make such a determination without utilizing any personally identifying information of the user. In some implementations, the local pay network server 114a may utilize the payment token provided by the client of the user as a search term to query a database. For example, the local pay network server may utilize a hypertext preprocessor (“PHP”) script including structured query language (“SQL”) commands (e.g., such as in the examples provided further below), to query a database using the anonymized privacy-protecting payment token. In response, the database may provide a variable indicating whether the request should be processed locally or remotely. In some implementations, the database may provide the IP address of a remote pay network server (such as, e.g., remote pay network server 114b) to which the local pay network server should forward the request. Thus, in some implementations, the request for processing the user's payment token may be provided for processing (e.g., 119) to the appropriate pay network server depending on the location of the user, the type of payment token used by the user, the account(s) to which the privacy-protecting anonymized payment token is linked, and/or the like. As such, the PPT is capable of routing requests to pay network servers that are local to such requests. This may have the advantage of increased security, and privacy in that the user's identifying information is not sent abroad unnecessarily. This may also have the advantage of potentially load-balancing processing of payment requests. In some implementations, the merchant's payment server may be aware of other regional payment server and may include a purchase origination regulation rule set, wherein certain jurisdictions may be flagged as requiring maintenance of varying levels of privacy. In such implementations, e.g., when a payment request originates from a country (e.g., European Union) requiring that the highest levels of privacy be maintained, the PPT may send the tokens and route the purchase transaction to an appropriate locality relative to the purchase origination. However, an alternative example where the purchase origination is from a locality that does not have rigorous privacy requirements, the pay network server that is most readily available (e.g., the current server, a less loaded alternative server, etc.) may instead handle the request.

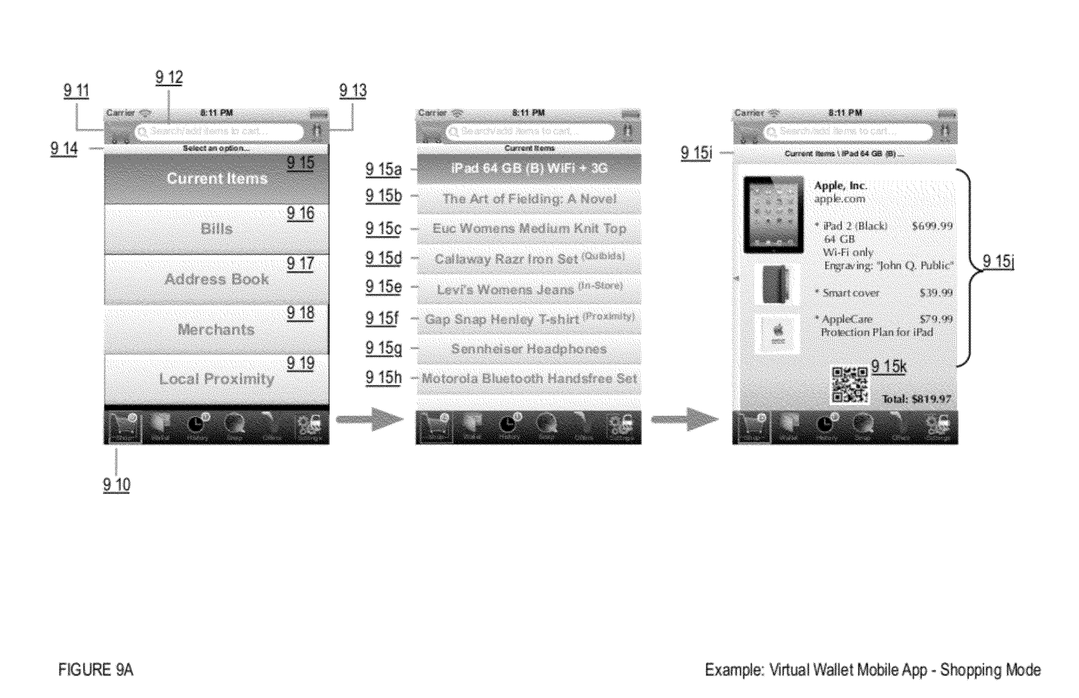

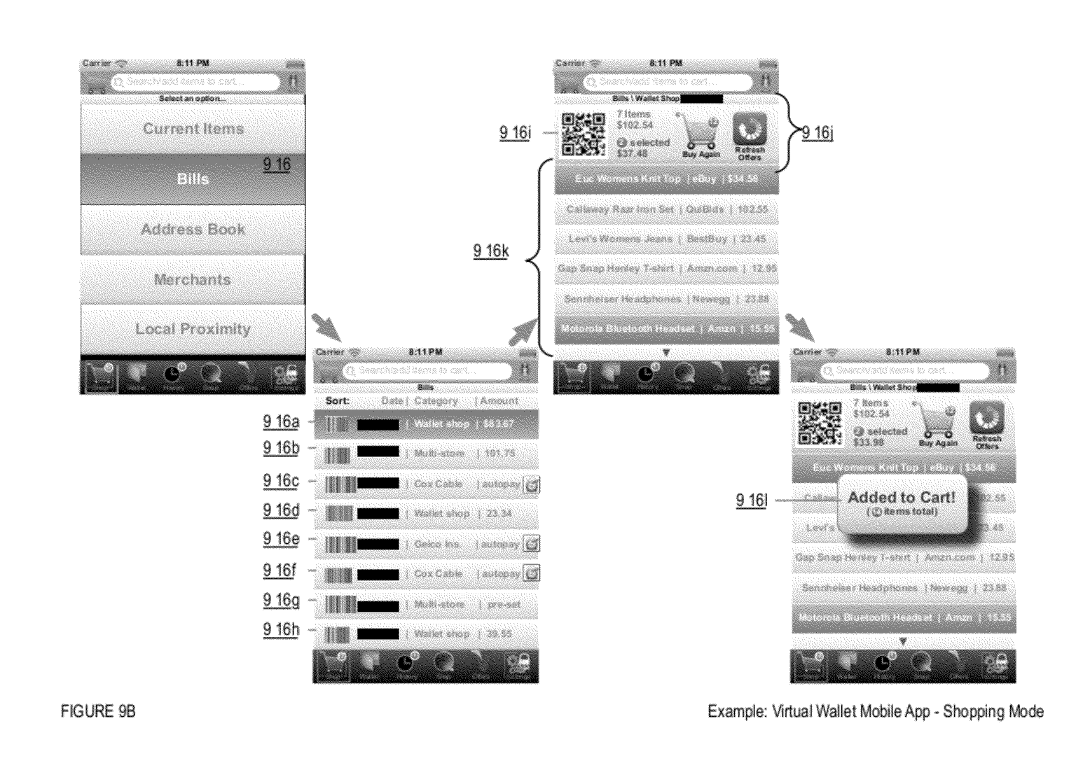

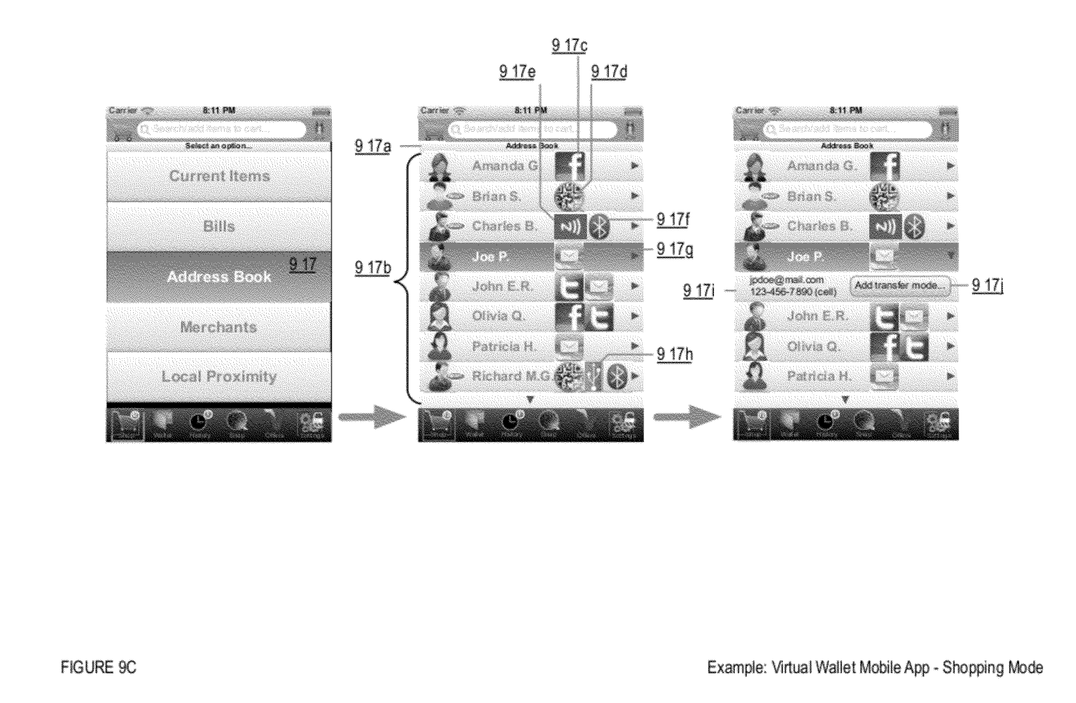

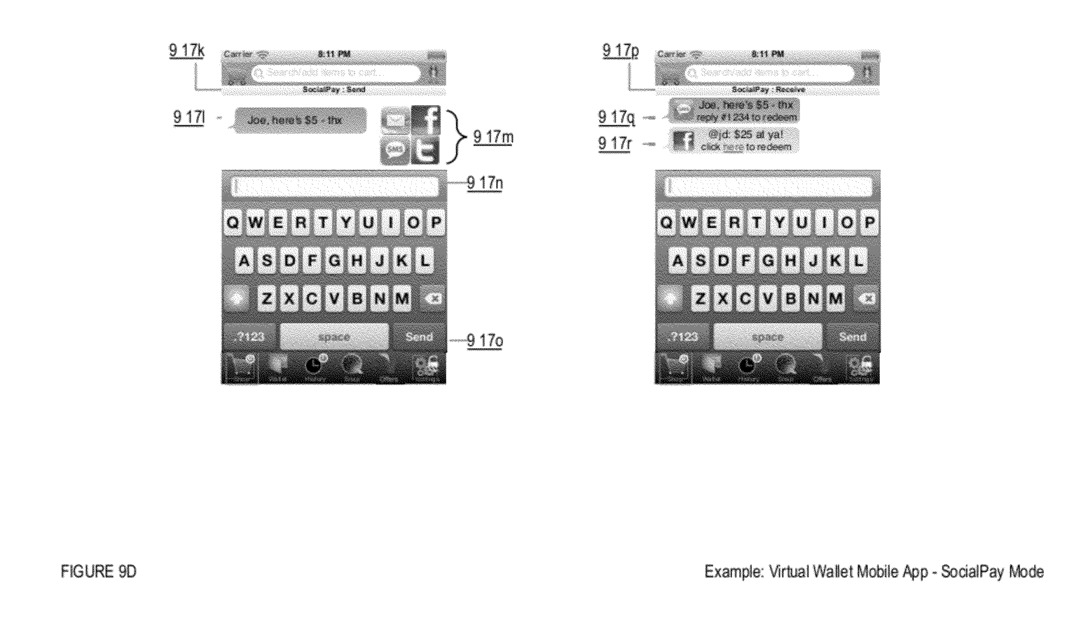

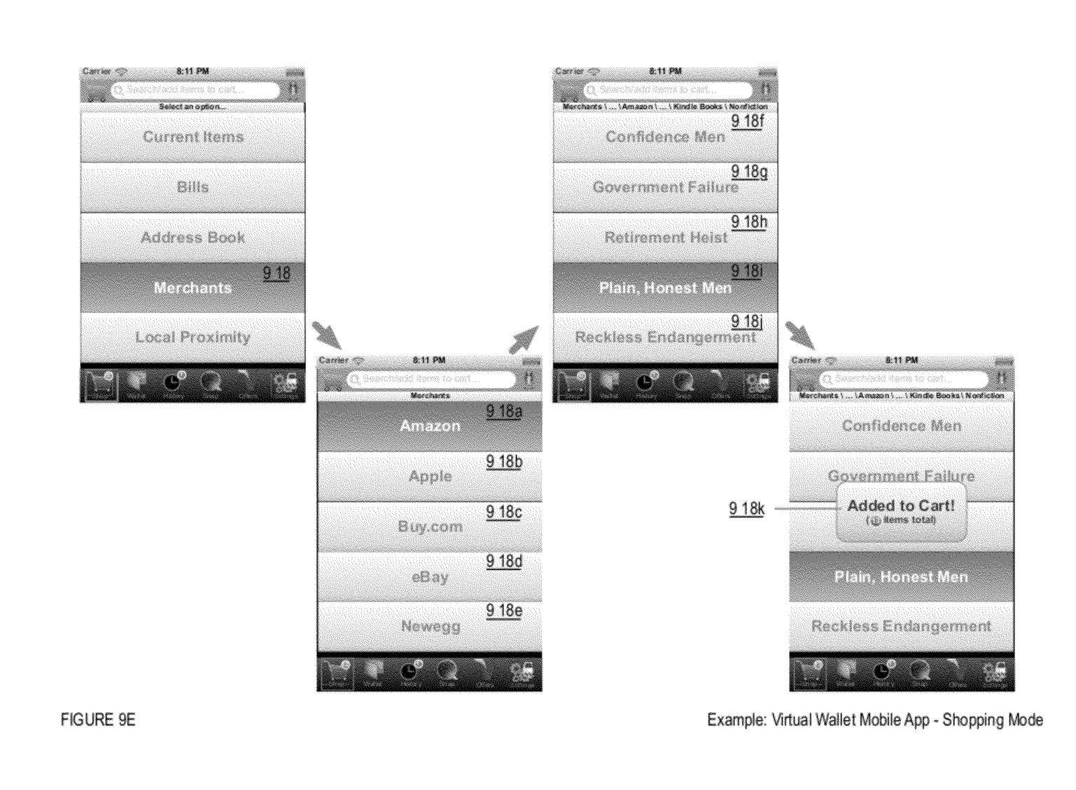

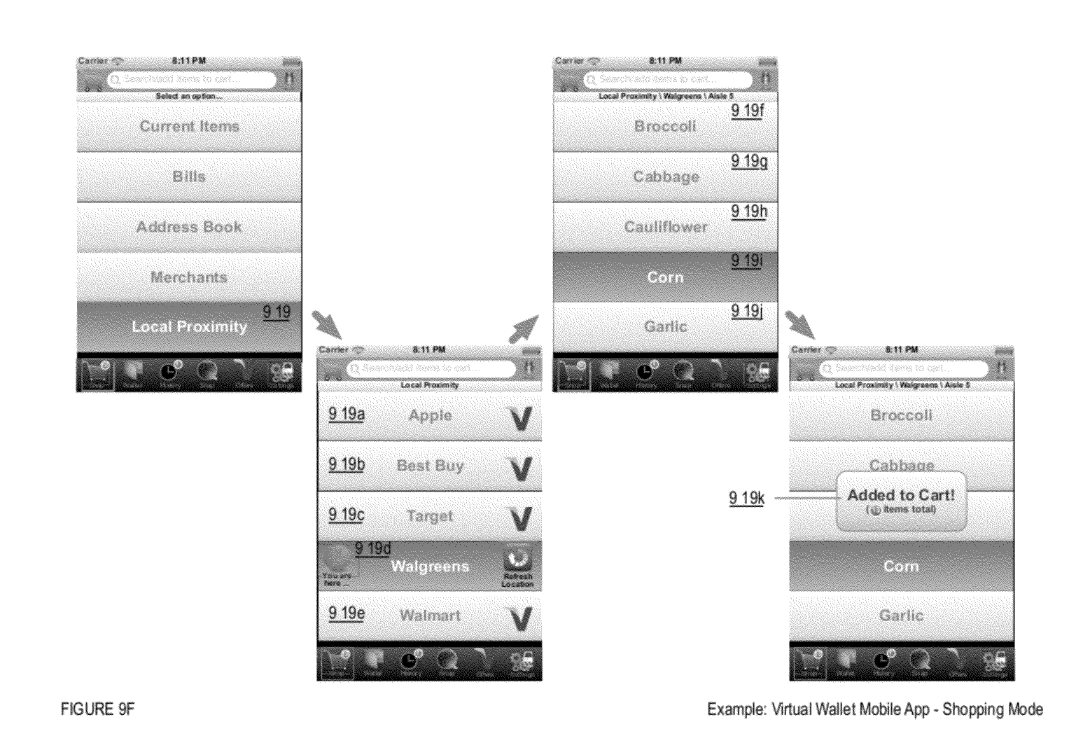

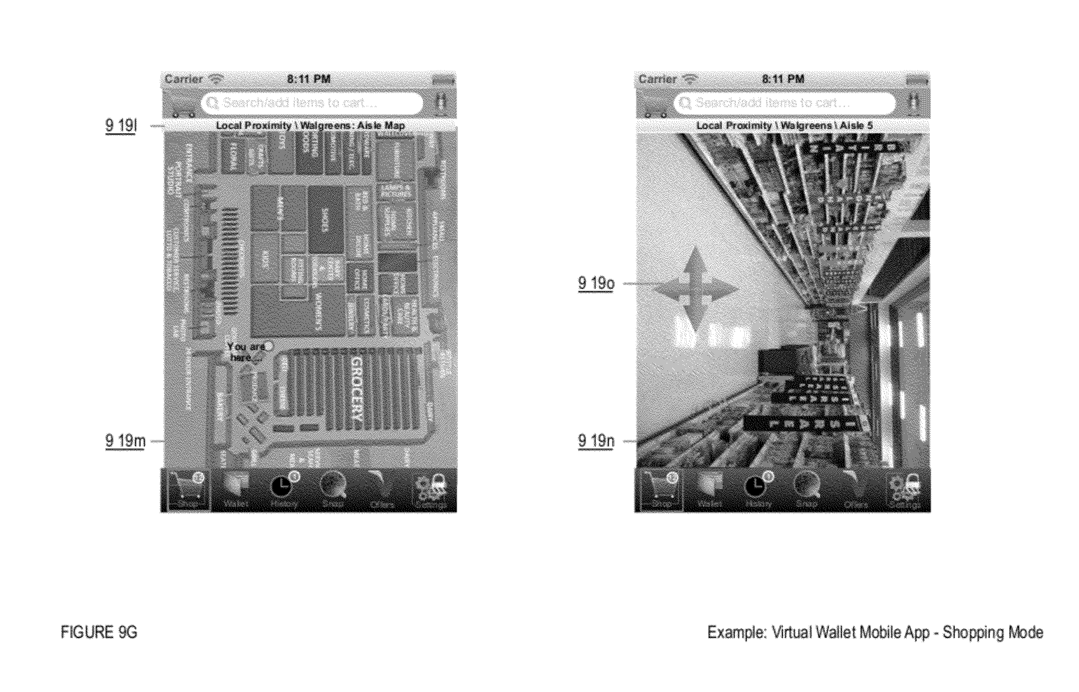

With reference to FIG. 1B, in some implementations, a user may desire to purchase a product, service and/or other offering (“product”) from a merchant, e.g., 106. The user may desire to utilize a card (e.g., debit, credit, prepaid, etc.), e.g., 101a, cash (or its equivalent), e.g., iota, securities, e.g., 103a, virtual currency, rewards, points, miles, etc., e.g., 104a, and/or other payment options. However, the user may wish to maintain anonymity to prevent personal information of the user from being collected by the merchant. As another example, the user may be wary of the user's card data being misused to conduct fraudulent transactions. In some implementations, the user may be able to utilize aliases, or tokens in lieu of payment information. For example, the user may be able to pass a token, e.g., 101b, 102b, 103b, 104b, to a merchant instead of complete card information, cash or account information. FIGS. 9A-14B illustrate various non-limiting advantageous aspects of a user utilizing a virtual wallet application to initiate purchase transaction, which includes options to “cloak” a transaction using a payment token in lieu of payment information. A secure token arbitrator may operate in conjunction with the merchant to process the transaction. For example, upon receiving a payment token from the user, the merchant may pass the token to a transaction arbitrator. The secure transaction arbitrator may have the ability to parse the incoming token, and determine the identity of the user for that token. The transaction arbitrator may also determine financial payment information to use to process the transaction. In some implementations, the transaction arbitrator may also only have another token stored as payment information. In such implementations, the issuer of the token may be the only entity other than the user to know the actual personal and/or financial information of the user. Thus, in some implementations, a token may comprise a combination of other token. For example, a token held by the transaction arbitrator may point to other token held by the transaction arbitrator and/or the issuer. Thus, in some implementations, multiple layers of security of personal and financial information may be generated by structuring the payment tokens accordingly. In some implementations, a token may specify a composition, including a mix of other payment tokens. For example, a payment token 105 may indicate that the transaction may be processed by assigning a percentage (e.g., 55%) of the transaction cost to a token 101b (e.g., linked to credit card information iota ultimately), and a different percentage (e.g., 45%) to a different token 102b (e.g., linked to a stored cash account 102a ultimately). In some implementations, the percentages may be determined in real-time or near real-time. For example, the token arbitrators may operate in conjunction with the issuers having user accounts linked to the payment token to determine which of the user accounts should be charged, and how much should be charged to each user account (e.g., in accordance with a predetermined algorithm). As another example, the percentages may be determined only at the time of processing the transaction, see, e.g., 103b, 104b, for example by requesting the user to provide payment options at the time of processing the purchase transaction.

In some implementations, additional security may be layered by using authentication methods. As an example, a user may be required to provide a user name and password to activate a payment token. As another example, a user may be required to provide a digital certificate to verify the user's identity prior to utilization of a payment token for a purchase transaction. As another example, device fingerprinting may be utilized. For example, a client device of a user may be a device that is used exclusively by the user, such as a smartphone, tablet computer, laptop computer, and/or the like. In some implementations, a custom hardware authentication chip, e.g., 103, may be disposed in communication with the client. In various implementations, the chip may be embedded into the client, come pre-installed in the client, attached as a periphery to the client, and/or the like. In some implementations, the user may perform an authentication procedure with the client and a user's card linked to the user's payment token. For example, the authentication chip may be configured to recognize the user's payment token physical card when the card is in the vicinity of the authentication chip. For example, the authentication chip and the card may communicate signals via Bluetooth™, Wi-Fi™, RFID tags, cellular connectivity (e.g., 3G, 4G), and/or the like. Thus, in order to make purchase with the payment token, in some implementations, the user may be required to present the payment token physical card to the authentication chip disposed in communication with the client before the user can make a purchase order using the token. Thus, the system provides an authenticity shield preventing others who may know of the user's payment token from utilizing the user's payment token in a fraudulent transaction.

FIGS. 2A-B shows application user interface diagrams illustrating example features of application interfaces for controlling tokenized payments for purchase transactions in some embodiments of the PPT. In some implementations, an app executing on the device of the user may include an app interface providing various features for the user. In some implementations, the app may include an indication of the location (e.g., name of the merchant store, geographical location, information about the aisle within the merchant store, etc.) of the user, e.g., 201. The app may provide an indication of a pay amount due for the purchase of the product, e.g., 202. In some implementations, the app may provide various options for the user to pay the amount for purchasing the product(s). For example, the app may utilize the GPS coordinates to determine the merchant store within the user is present, and direct the user to a website of the merchant. In some implementations, the PPT may provide an API for participating merchants directly to facilitate transaction processing. In some implementations, a merchant-branded PPT application may be developed with the PPT functionality, which may directly connect the user into the merchant's transaction processing system. For example, the user may choose from a number of cards (e.g., credit cards, debit cards, prepaid cards, etc.) from various card providers, e.g., 203. In some implementations, the app may provide the user the option to pay the purchase amount using funds included in a bank account of the user, e.g., a checking, savings, money market, current account, etc., e.g., 204. In some implementations, the user may have set default options for which card, bank account, etc. to use for the purchase transactions via the app. In some implementations, such setting of default options may allow the user to initiate the purchase transaction via a single click, tap, swipe, and/or other remedial user input action, e.g., 205. In some implementations, when the user utilizes such an option, the app may utilize the default settings of the user to initiate the purchase transaction. In some implementations, the app may allow the user to utilize other accounts (e.g., Google™ Checkout, Paypal™ account, etc.) to pay for the purchase transaction, e.g., 206. In some implementations, the app may allow the user to utilize rewards points, airline miles, hotel points, electronic coupons, printed coupons (e.g., by capturing the printed coupons similar to the product identifier) etc., to pay for the purchase transaction, e.g., 207-208. In some implementations, the app may provide an option to provide express authorization before initiating the purchase transaction, e.g., 209. In some implementations, the app may provide a progress indicator provide indication on the progress of the transaction after the user has selected an option to initiate the purchase transaction, e.g., 210. In some implementations, the app may provide the user with historical information on the user's prior purchases via the app, e.g., 211. In some implementations, the app may provide the user with an option to share information about the purchase (e.g., via email, SMS, wall posting on Facebook®, tweet on Twitter™, etc.) with other users, e.g., 212. In some implementations the app may provide the user an option to display the product identification information captured by the client device (e.g., in order to show a customer service representative at the exit of a store the product information), e.g., 214. In some implementations, the user, app, device and or PPT may encounter an error in the processing. In such scenarios, the user may be able to chat with a customer service representative (e.g., VerifyChat 213) to resolve the difficulties in the purchase transaction procedure.

In some implementations, the user may select to conduct the transaction using a one-time token, e.g., an anonymized credit card number, see e.g., 205b. For example, the PPT may utilize a tokenized and anonymized set of card details (see, e.g., “AnonCard1,” “AnonCard2”). As another example, the PPT may generate, e.g., in real-time, a one-time anonymous set of card details to securely complete the purchase transaction (e.g., “Anon It 1X”). In such implementations, the app may automatically set the user profile settings such that the any personal identifying information of the user will not be provided to the merchant and/or other entities. For example, the app may automatically send only a token or alias in lieu of payment information. The payment system may process the token to obtain its associated payment information for processing the purchase transaction. In some implementations, the user may be required to enter a user name and password to enable the anonymization features.

In some implementations, a user may be able to control the attributes of each token associated with the user via a web interface, e.g., 220. For example, the user may be able to login to the web interface, e.g., 221, and visualize payment tokens associated with the user, e.g., 223. The user may also be provided with user interface elements to generate new tokens. For example, the user interface may provide elements for creating a new token, e.g., 224. For example, the user interface may allow the user to select financial details 225 such as, but not limited to: a funding source from whom to obtain a token, an account type for the token, an initial token value (e.g., for pre-funding, and/or pore-authorization), a value decay option (e.g., to assist with time-controlled spending controls for the user), billing address information, shipping address information, contact settings, a security protocol, token administrator, user anonymization (for security) option and/or the like. In some implementations, the web interface may allow the user to select personal details 226 such as, but not limited to: token holders, contact frequency (e.g., for token offers), token offer preferences, parental controls, activated devices, and/or the like. In some implementations, the web interface may allow the user to specify activation 227 and expiry 228 dates for the tokens.

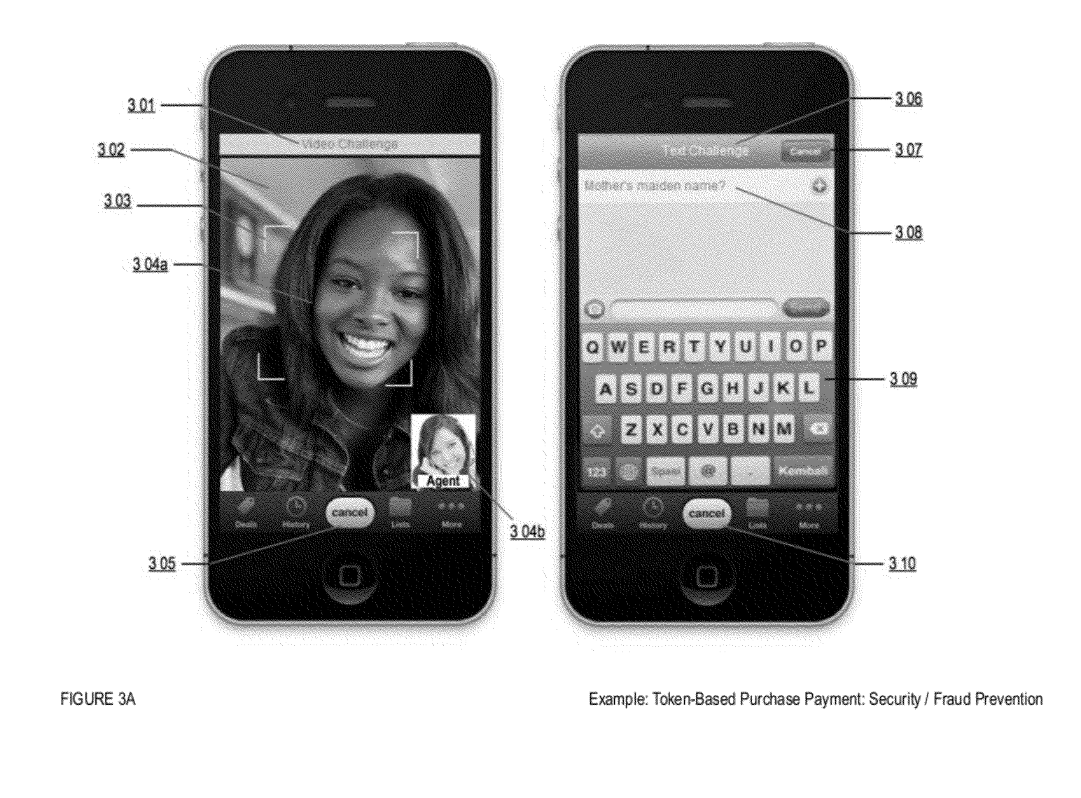

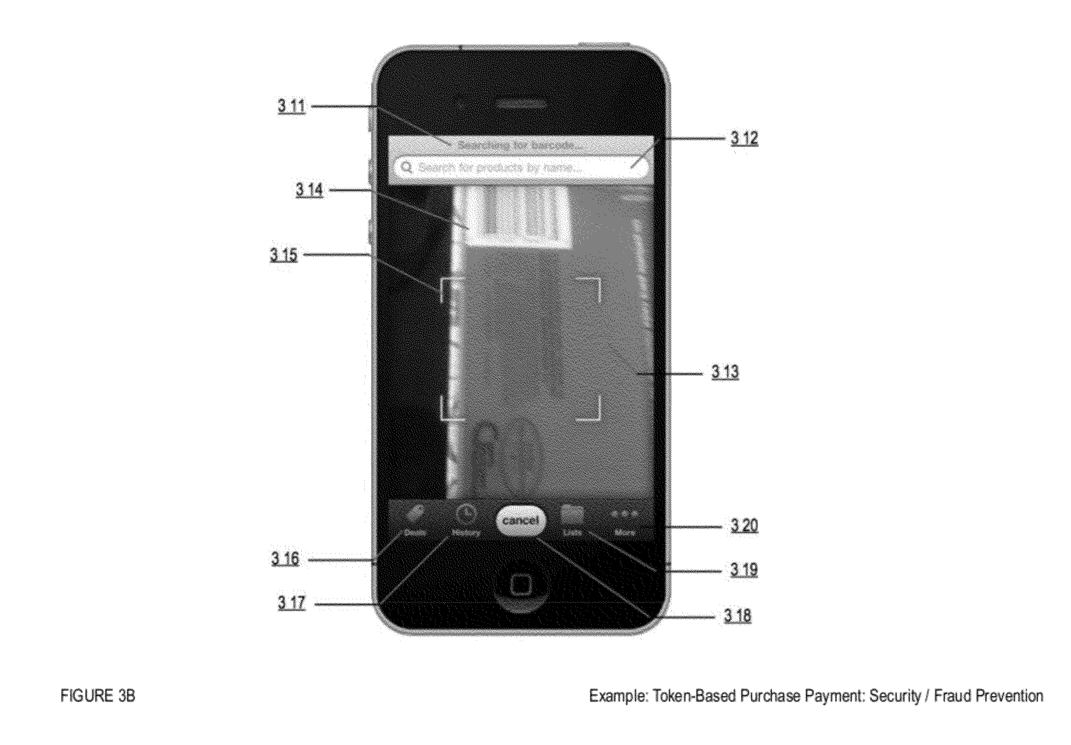

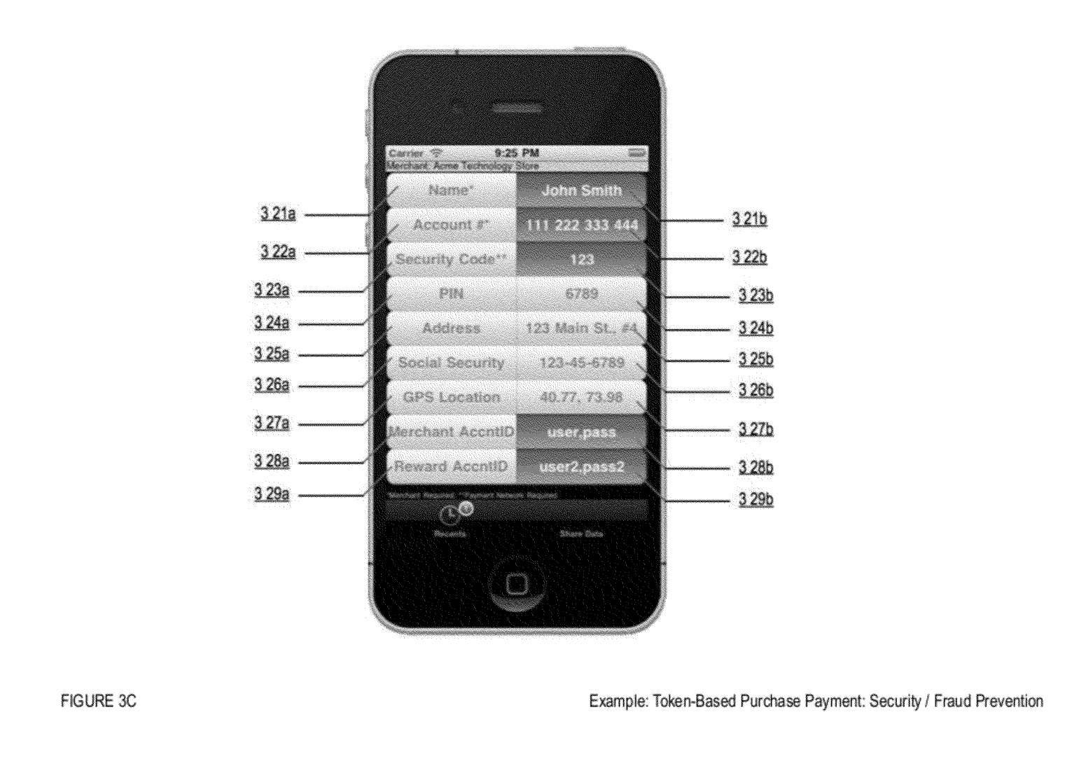

FIGS. 3A-C show application user interface diagrams illustrating example features of a payment tokenization mobile app for securing user data and preventing fraud in some embodiments of the PPT. In some implementations, the app executing on the user's device may provide a “VerifyChat” feature for fraud prevention (e.g., by activating UI element 213 in FIG. 2). For example, the PPT may detect an unusual and/or suspicious transaction. The PPT may utilize the VerifyChat feature to communicate with the user, and verify the authenticity of the originator of the purchase transaction. In various implementations, the PPT may send electronic mail message, text (SMS) messages, Facebook® messages, Twitter™ tweets, text chat, voice chat, video chat (e.g., Apple FaceTime), and/or the like to communicate with the user. For example, the PPT may initiate a video challenge for the user, e.g., 301. For example, the user may need to present him/her-self via a video chat, e.g., 302. In some implementations, a customer service representative, e.g., agent 304b, may manually determine the authenticity of the user using the video of the user. In some implementations, the PPT may utilize face, biometric and/or like recognition (e.g., using pattern classification techniques) to determine the identity of the user, e.g., 304a. In some implementations, the app may provide reference marker (e.g., cross-hairs, target box, etc.), e.g., 303, so that the user may the video to facilitate the PPT′ automated recognition of the user. In some implementations, the user may not have initiated the transaction, e.g., the transaction is fraudulent. In such implementations, the user may cancel, e.g., 305, the challenge. The PPT may then cancel the transaction, and/or initiate fraud investigation procedures on behalf of the user.

In some implementations, the PPT may utilize a text challenge procedure to verify the authenticity of the user, e.g., 306. For example, the PPT may communicate with the user via text chat, SMS messages, electronic mail, Facebook® messages, Twitter™ tweets, and/or the like. The PPT may pose a challenge question, e.g., 308, for the user. The app may provide a user input interface element(s) (e.g., virtual keyboard 309) to answer the challenge question posed by the PPT. In some implementations, the challenge question may randomly selected by the PPT automatically; in some implementations, a customer service representative may manually communicate with the user. In some implementations, the user may not have initiated the transaction, e.g., the transaction is fraudulent. In such implementations, the user may cancel, e.g., 307, 310, the text challenge. The PPT may then cancel the transaction, and/or initiate fraud investigation procedures on behalf of the user.

In some implementations, the app may be configured to recognize product identifiers (e.g., barcodes, QR codes, etc.). For example, for fraud prevention, the app may require the user to utilize the user's device to obtain snapshot of the items being purchased, thus ensuring that the person who swiped the card is also in possession of the user's device as well as the purchase items. In some implementations, the user may be required to sign in to the app to enable its features. Once enabled, the camera may provide in-person one tap purchasing features for the user. For example, the client device may have a camera via which the app may acquire images, video data, streaming live video, and/or the like, e.g., 313. The app may be configured to analyze the incoming data, and search, e.g., 311, for a product identifier, e.g., 314. In some implementations, the app may overlay cross-hairs, target box, and/or like alignment reference markers, e.g., 315, so that a user may align the product identifier using the reference markers so facilitate product identifier recognition and interpretation. In some implementations, the app may include interface elements to allow the user to switch back and forth between the product identification mode and the product offer interface display screens (see, e.g., 316), so that a user may accurately study the deals available to the user before capturing a product identifier. In some implementations, the app may provide the user with the ability to view prior product identifier captures (see, e.g., 317) so that the user may be able to better decide which product identifier the user desires to capture. In some implementations, the user may desire to cancel product purchasing; the app may provide the user with a user interface element (e.g., 318) to cancel the product identifier recognition procedure and return to the prior interface screen the user was utilizing. In some implementations, the user may be provided with information about products, user settings, merchants, offers, etc. in list form (see, e.g., 319) so that the user may better understand the user's purchasing options. Various other features may be provided for in the app (see, e.g., 320).

In some implementations, the user may be able to view and/or modify the user profile and/or settings of the user, e.g., by activating user interface element 309 (see FIG. 3A). For example, the user may be able to view/modify a user name (e.g., 321a-b), account number (e.g., 322a-b), user security access code (e.g., 323a-b), user pin (e.g., 324a-b), user address (e.g., 325a-b), social security number associated with the user (e.g., 326a-b), current device GPS location (e.g., 327a-b), user account of the merchant in whose store the user currently is (e.g., 328a-b), the user's rewards accounts (e.g., 329a-b), and/or the like. In some implementations, the user may be able to select which of the data fields and their associated values should be transmitted to facilitate the purchase transaction, thus providing enhanced data security for the user. For example, in the example illustration in FIG. 3C, the user has selected the name 312a, account number 322a, security code 323a, merchant account ID 328a and rewards account ID 329a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the PPT with the GPS location of the user. Based on the GPS location of the user, the PPT may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

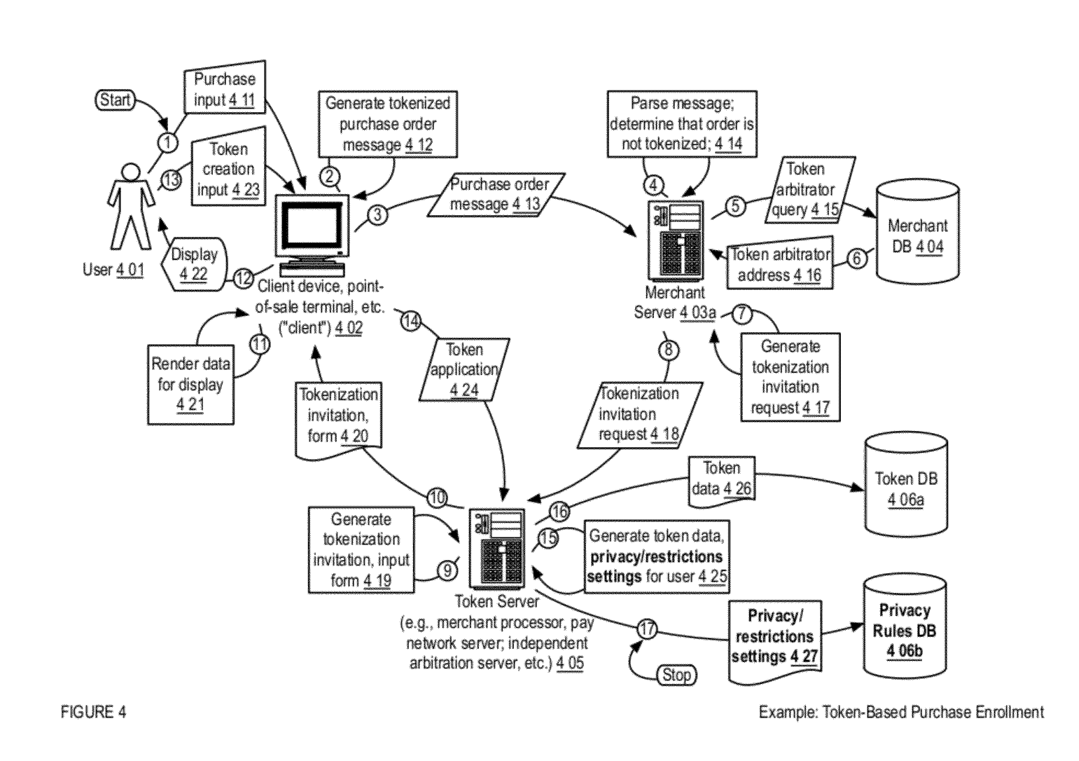

FIG. 4 shows a data flow diagram illustrating an example procedure to enroll in a token-based purchase payment program in some embodiments of the PPT. In some implementations, a user, e.g., 401, may desire to purchase a product, service, offering, and/or the like (“product”), from a merchant. The user may communicate with a merchant server, e.g., 403a, via a client such as, but not limited to: a personal computer, mobile device, television, point-of-sale terminal, kiosk, ATM, and/or the like (e.g., 402). For example, the user may provide user input, e.g., purchase input 411, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, the client may generate a purchase order message, e.g., 412, and provide, e.g., 413, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. Based on the parsing, the merchant server may determine that the purchase order message is not tokenized, e.g., 414. Upon determining that the purchase order message is not tokenized, the merchant server may determine that the user needs to be provided with an option to sign up for payment tokenization services. The merchant server may attempt to identify a token arbitrator to provide the payment tokenization services for the user. For example, the merchant server may query, e.g., 415, a merchant database, e.g., 404, for an address of a token arbitrator. For example, the merchant server may utilize a hypertext preprocessor (“PHP”) script including Structured Query Language (“SQL”) commands to query a relational database for an address of a token arbitator. An example PHP/SQL listing for querying a database for a token arbitrator address is provided below:

<?PHP
header(′Content-Type: text/plain′);
mysql_connect(“254.93.179.112”,$DBserver,$password); // access
database server
mysql_select_db(“ARBITRATORS.SQL”); // select database table to
search
//create query for token arbitrators
$query = “SELECT arbitrator_id, arbitators_name arbitrator_address

arbitrator_URL FROM TokenizationTable WHERE user_card_num
LIKE ′%′ $userpaymentcardnumber”;

$result = mysql_query($query); // perform the search query
mysql_close(“ARBITRATORS.SQL”); // close database access
?>

In response, the merchant database may provide the token arbitrator address, e.g., 416. The merchant server may generate a tokenization invitation request on behalf of the user, e.g., 417, and provide the tokenization invitation request to a token server, e.g., 405. For example, the merchant server may provide a HTTP(S) POST message including the tokenization invitation request similar to the example below:

POST /inviterequest.php HTTP/1.1
Host: www.tokenizer.com
Content-Type: Application/XML
Content-Length: 579
<?XML version = “1.0” encoding = “UTF-8”?>
<invitation_request>

<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</invitation_request>

In some implementations, the token server may parse the invitation request message, and extract details of the user and client from the message. The token server may generate, e.g., 419, a tokenization invitation and an application form for the user to complete to sign up for tokenization services. The token server may provide, e.g., 420, the tokenization invitation and the application form to the client (either directly to the client or via the merchant server). For example, the token server may provide a HTTP(S) POST message including XML data representative of the tokenization input form 420, such as the example HTTP(S) POST message below:

POST /purchase.php HTTP/1.1
Host: www.merchant.com
Content-Type: Application/XML
Content-Length: 1306
<?XML version = “1.0” encoding = “UTF-8”?>
<token_application_form>

<provisional_token_ID>4NFU4RG94</provisional_token_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<account_params>

<account_name> COMPLETE </account_name>
<account_type> COMPLETE </account_type>
<account_num> COMPLETE </account_num>
<billing_address> COMPLETE </billing_address>
<phone> COMPLETE </phone>
<sign> COMPLETE </sign>
<confirm_type> COMPLETE </confirm_type>
<contact_info> COMPLETE </contact_info>
<country> COMPLETE </country>
<privacy_restriction_type> COMPLETE
</privacy_restriction_type>

</account_params>
<shipping_info>

<shipping_adress> COMPLETE </shipping_address>
<ship_type> COMPLETE </ship_type>
<ship_carrier> COMPLETE </ship_carrier>
<ship_account> COMPLETE </ship_account>
<tracking_flag> COMPLETE </tracking_flag>
<sign_flag> COMPLETE </sign_flag>

</shipping_info>

</token_application_form>

The client may render, e.g., 421, the tokenization invitation and application form, and display, e.g., 422, the invitation and application form for the user, e.g., 423. In some implementations, the user may desire to enroll for payment tokenization services, and may provide token creation input to complete the application form, e.g., 423. The client may generate a competed application form, and provide, e.g., 424, the token application to the token server (either directly or via the merchant server). For example, the client may provide a HTTP(S) POST message for the token application 424 similar to the example below:

POST /purchase.php HTTP/1.1
Host: www.merchant.com
Content-Type: Application/XML
Content-Length: 1306
<?XML version = “1.0” encoding = “UTF-8”?>
<token_application_form>

<provisional_token_ID>4NFU4RG94</provisional_token_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<account_params>

<account_name> John Q. Public </account_name>
<account_type> credit </account_type>
<account_num>123456789012345</account_num>
<billing_address> 123 Green St., City, ST 12345
</billing_address>
<phone> 123-456-7890 </phone>
<sign> /jqp/ </sign>
<confirm_type> CVV2 456 </confirm_type>
<contact_info> SAME AS BILLING </contact_info>
<country> UK </country>
<privacy_restriction_type> EU DEFAULT
</privacy_restriction_type>

</account_params>
<shipping_info>

<shipping_adress> 123 Green St., City, ST 12345
</shipping_address>
<ship_type> Express </ship_type>
<ship_carrier> FedEx </ship_carrier>
<ship_account> 0908765432 </ship_account>
<tracking_flag> ON </tracking_flag>
<sign_flag> ON </sign_flag>

</shipping_info>

</token_application_form>

The token server may obtain the application form, and parse the form to extract data fields and values from the form to generate a token data record, e.g., 425. The token server may also determine a set of privacy rules, restrictions, transaction processing rules (e.g., in which country should the servers involved in transaction processing reside), etc. applicable to the token created for the user. For example, such restrictions may specify that all transaction involving the token may only be processed at (e.g., payment) servers located within a particular country. As another example, the restriction may be updated (e.g., periodically, automatically, on demand) based on privacy and/or other laws governing processing of transactions in that country. As another example, the restriction may accord weights to various factors (e.g., transaction processing server load balancing, network congestion, privacy constraints, security constraints, etc.), and may require weighing the factors (e.g., by calculating a weighted-average score based on the factors) to determine a country in which to process a transaction utilizing the token. As another example, the token may specify a set of countries in which the transaction may (not) be processed. For non-limiting illustrative purposes only, the XML data structure below illustrates example rules 427 that may be created in connection with a token, and stored in a database table (see, e.g., FIG. 16, Privacy Rules 1519n table) within a privacy rules database 406b:

<?XML version = “1.0” encoding = “UTF-8”?>
<token_rules>

<token_ID>4NFU4RG94</token_ID>
<timestamp>2011-02-22 15:22:43</timestamp>
<expiry>2011-02-28 23:59:59</expiry>
<rule> IF INIT IN: USA, EU; THEN PROCESS IN: EU;
END</rule>
<rule> IF INIT IN: BR; THEN KILL PROCESS; END</rule>
<rule>ELSE WEIGHT SERVER LOAD BALANCE: 65%;
NETWORK CONGESTION: 35%</rule>
<rule></rule>
</rule>

</token_rules>

For example, the rules may specify where payment transactions should take place to prevent a consumer's private payment information from behind used outside the territories prescribed by privacy regulations. For example, some countries with strict privacy controls will require that payment processing only occur in the country where a consumer has an account (see rule 1 below); other countries may have privacy controls that will require that payment processing only occur in a region (e.g., any country in the EU, see rule 2 below); other countries may have no privacy restrictions and as such, payment processing may occur anywhere (e.g., see rule 3 below) and as such may allow rules that enhance load balancing and improve network efficiency by delegating processing to lesser used servers (e.g., see rule 4 below).

<rule1> IF INIT IN: FR; THEN PROCESS ONLY IN: FR; END</rule1>
<rule2> IF INIT IN: GB; THEN PROCESS IN: EU; END</rule2>
<rule3> IF INIT IN: USA; THEN PROCESS IN: ALL; END</rule3>
<rule4> IF INIT IN: USA, THEN PROCESS IN:
LEAST_USED_SERVER; END</rule4>

In some embodiments, the user may specify custom settings that override default settings that may be provided by the token server based on the location of the issuer(s) of the funding sources underlying the token. In some embodiments, if the user provides custom settings to override default settings provided by the token server, the token server may perform an error-check of the custom settings to ensure that they are internally consistent, in compliance with applicable laws and regulations, and/or comport with default network congestion and server load balancing rules for transaction processing within payment networks invoked by the funding sources underlying the token. Also, in some embodiments, the token may not include privacy rules within, but may provide a unique identifier which may be used by the PPT to query a privacy country code database to identify a home country and privacy restrictions thereof based on the token's owner; for example, the token hash may be generated from a consumer's uniquely identifying information (e.g., an account identifier, unique name/address/age/etc. pairings, social security number, and/or the like) and as such, the resulting hash would be unique to that consumer and be the basis of a query which can be used to identify the consumer's home country, and subsequently, privacy rules relevant to that home country may be applied in routing payment resolution of the token.

The token server may store the data extracted from the application form to a token database, e.g., 406a, and the privacy/restrictions settings 427 in a privacy rules database 406b. For example, the token server may issue PHP/SQL commands similar to the example below:

<?PHP
header(′Content-Type: text/plain′);
mysql_connect(″254.92.185.103”,$DBserver,$password); // access
database server
mysql_select(″TOKENS.SQL″); // select database to append
mysql_query(“INSERT INTO PaymentTokensTable (timestamp,

token_id, user_id, user_name, client_id, client_type,
client_model, client_OS, app_installed_flag,
account_params_list, account_name, account_type, account_num,
billing_addres, zipcode, phone, sign, merchant_params_list,
merchant_id, merchant_name, merchant_auth_key)

VALUES (time( ), $userid, $username, $clientid, $clienttype,

$clientmodel, $clientOS, $appflag, $purchase_summary_list,
$num_products, $product_summary, $product_quantity,
$transaction_cost, $account_params_list, $account_name,
$account_type, $account_num, $billing_addres, $zipcode, $phone,
$sign, $merchant_params_list, $merchant_id, $merchant_name,
$merchant_auth_key)”); // add data to table in database

mysql_close(″TOKENS.SQL″); // close connection to database
?>

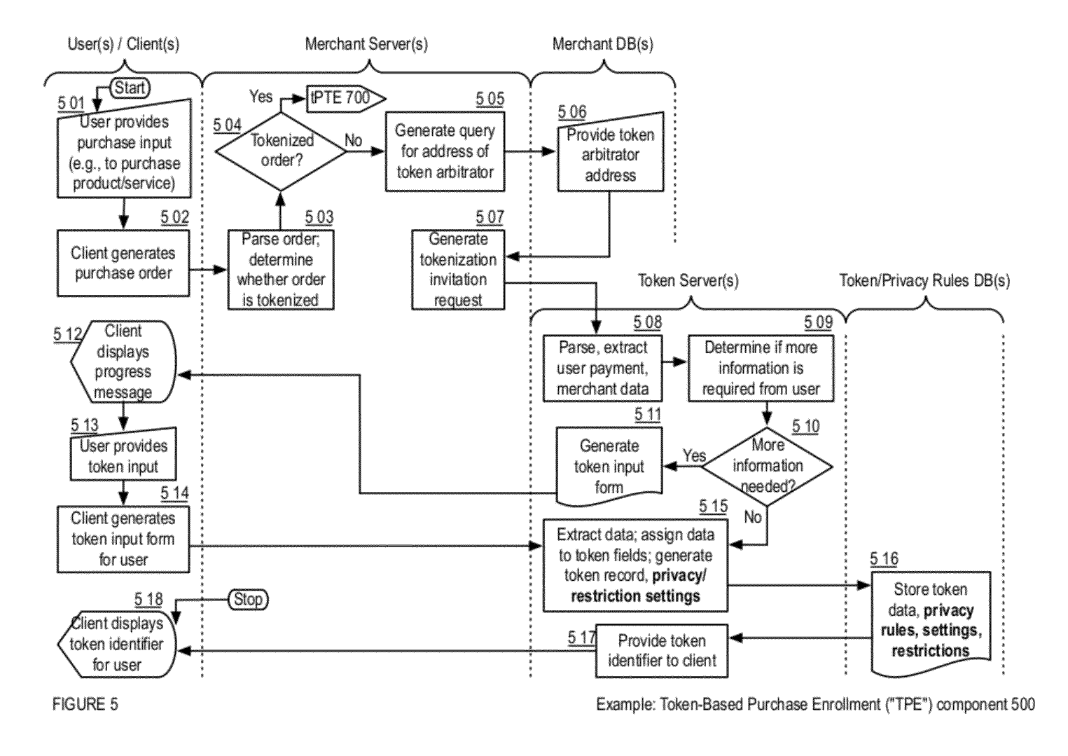

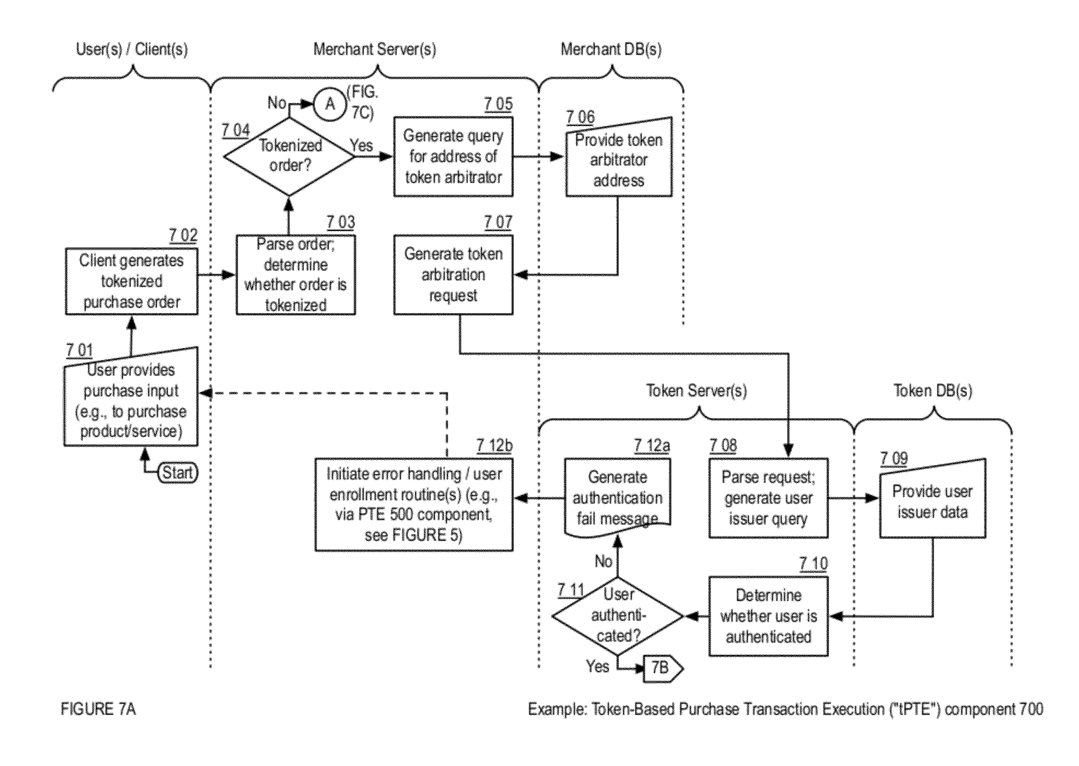

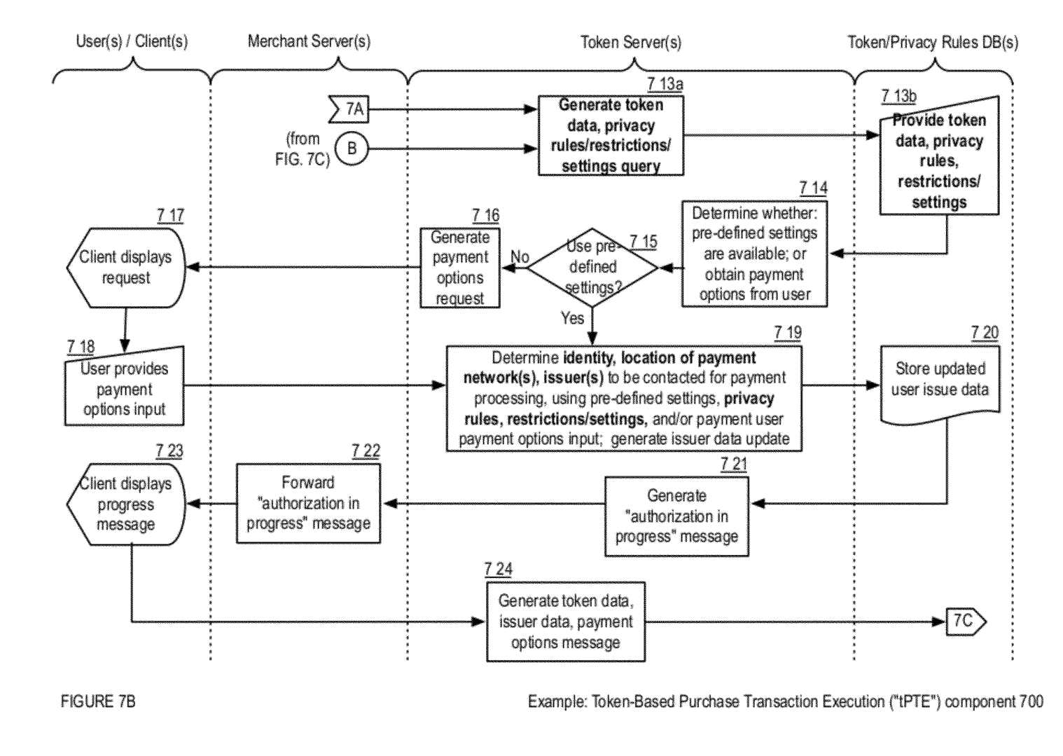

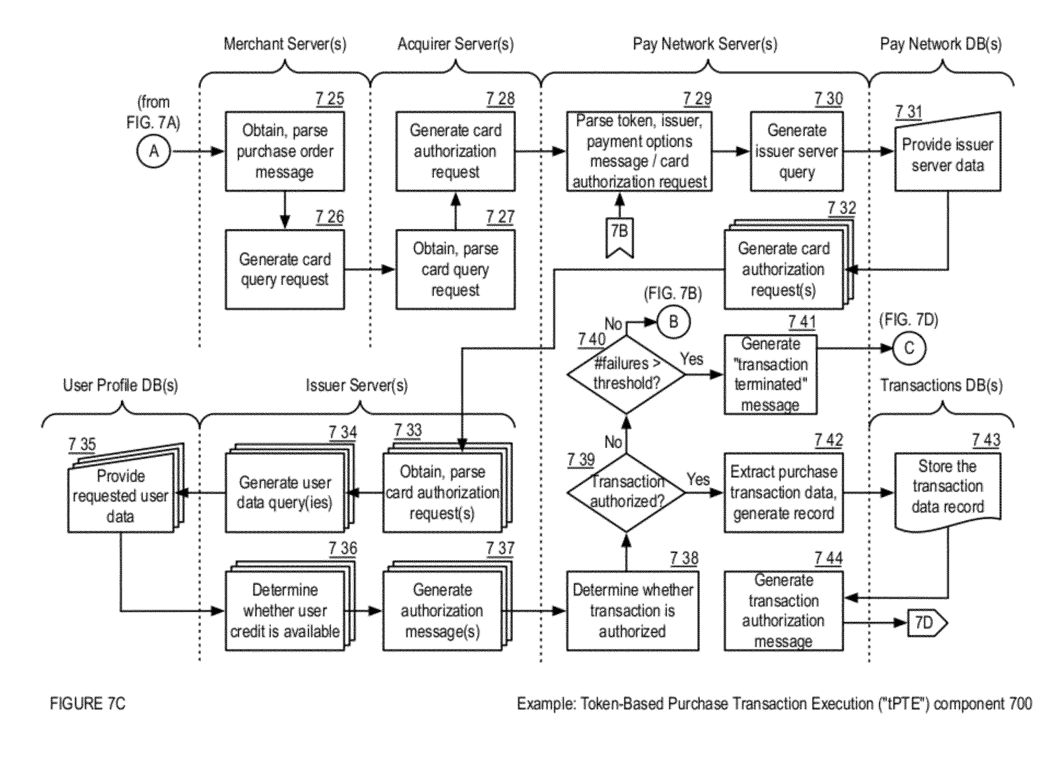

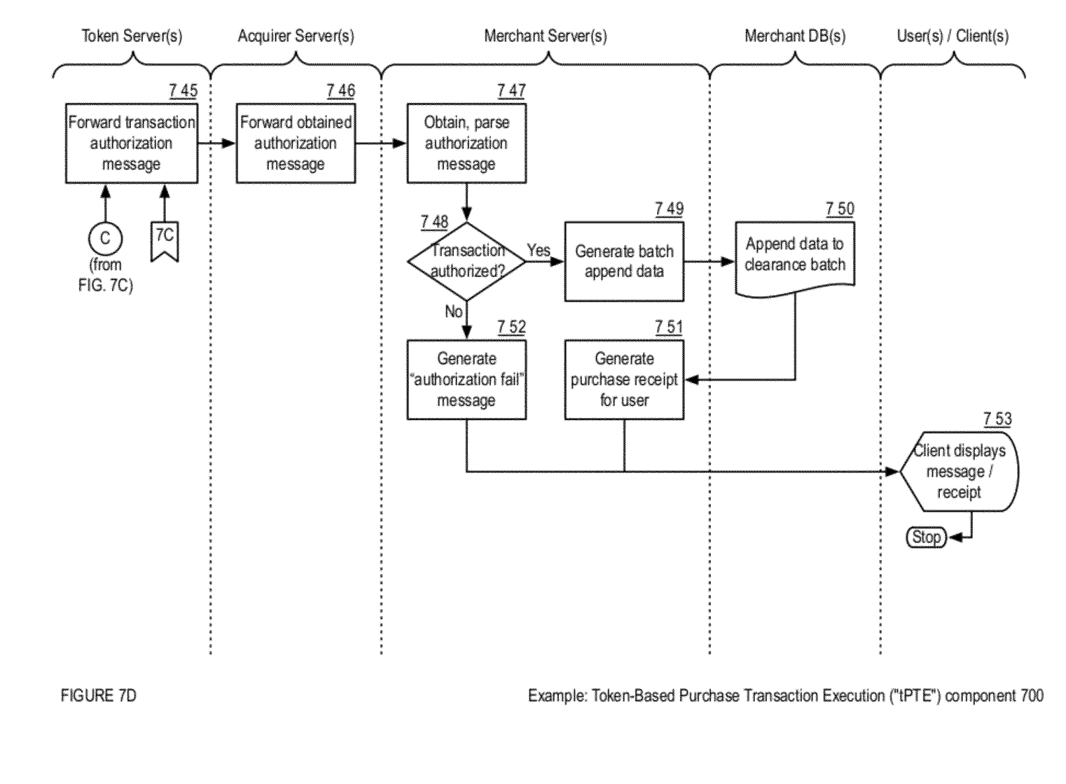

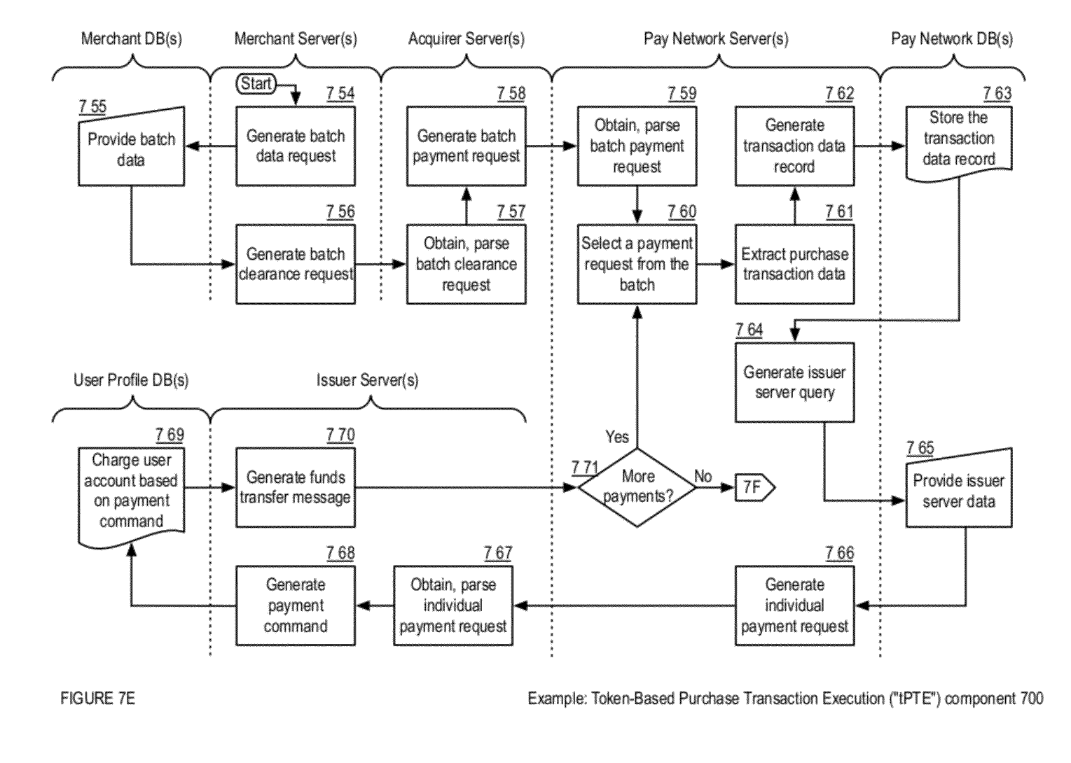

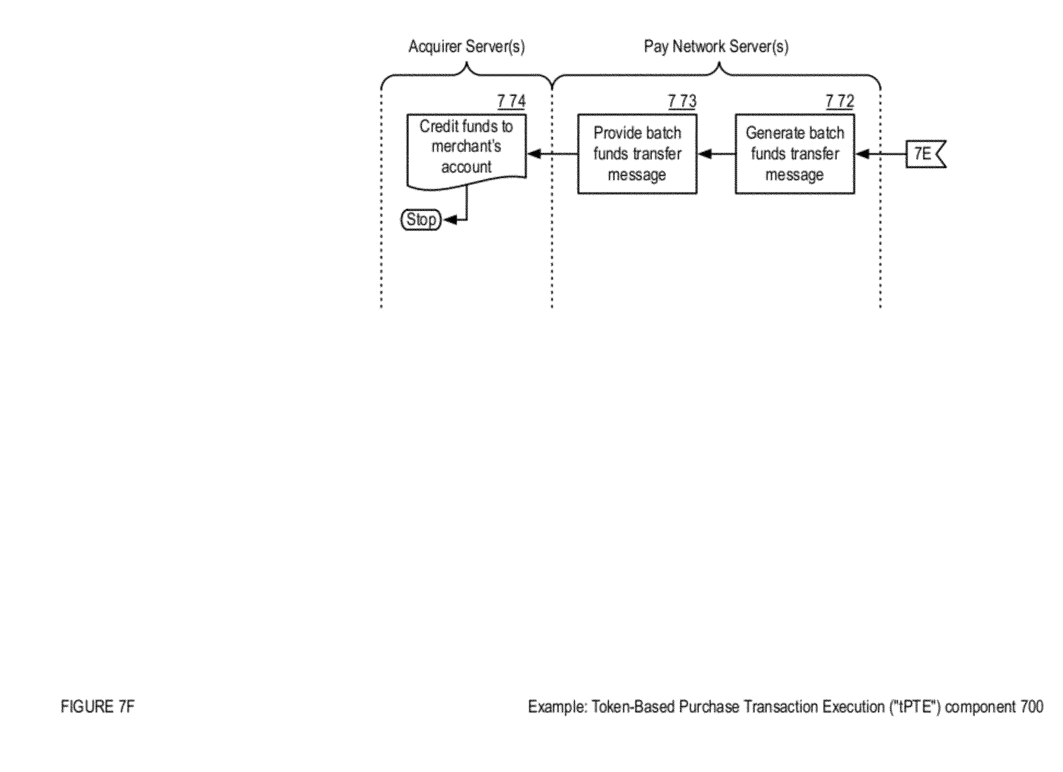

FIG. 5 shows a logic flow diagram illustrating example aspects of enrolling in a token-based purchase payment program in some embodiments of the PPT, e.g., a Token-Based Purchase Enrollment (“TPE”) component 500. In some implementations, a user may desire to purchase a product, service, offering, and/or the like (“product”), from a merchant. The user may provide user input, e.g., purchase input 501, into the client indicating the user's desire to purchase the product. In some implementations, the client may generate a purchase order message, e.g., 502, and provide the generated purchase order message to the merchant server. The merchant server may obtain the purchase order message from the client, and may parse the purchase order message to extract details of the purchase order from the user, e.g., 503. For example, the merchant server may utilize parsers similar to the example parsers discussed below in the description with reference to FIG. 16. Based on the parsing, the merchant server may determine that the purchase order message is not tokenized, e.g., 504, option “No”. If the merchant server determines that the purchase order message is tokenization, the merchant server may invoke a procedure to process the transaction such as tPTE 700 component described further below in the discussion with reference to FIG. 7. Upon determining that the purchase order message is not tokenized, the merchant server may determine that the user needs to be provided with an option to sign up for payment tokenization services. The merchant server may attempt to identify a token arbitrator to provide the payment tokenization services for the user. For example, the merchant server may query, e.g., 505, a merchant database for an address of a token arbitrator. In response, the merchant database may provide the token arbitrator address, e.g., 506. The merchant server may generate a tokenization invitation request on behalf of the user, e.g., 507, and provide the tokenization invitation request to a token server.

In some implementations, the token server may parse the invitation request message, and extract details of the user and client from the message, e.g., 508. The token server may determine if additional information is required from the user to generate a token data structure and/or token data record, e.g., 509. If additional information is needed (e.g., not all fields of the token data record can be completed with the available information), the token server may generate a token input form, e.g., 511, and provide the token input form for the user. The token server may provide the token input form to the client (either directly to the client or via the merchant server). The client may render the form, and display, e.g., 512, the form for the user. In some implementations, the user may obtain a form such as the example user interface illustration depicted in FIG. 2B.

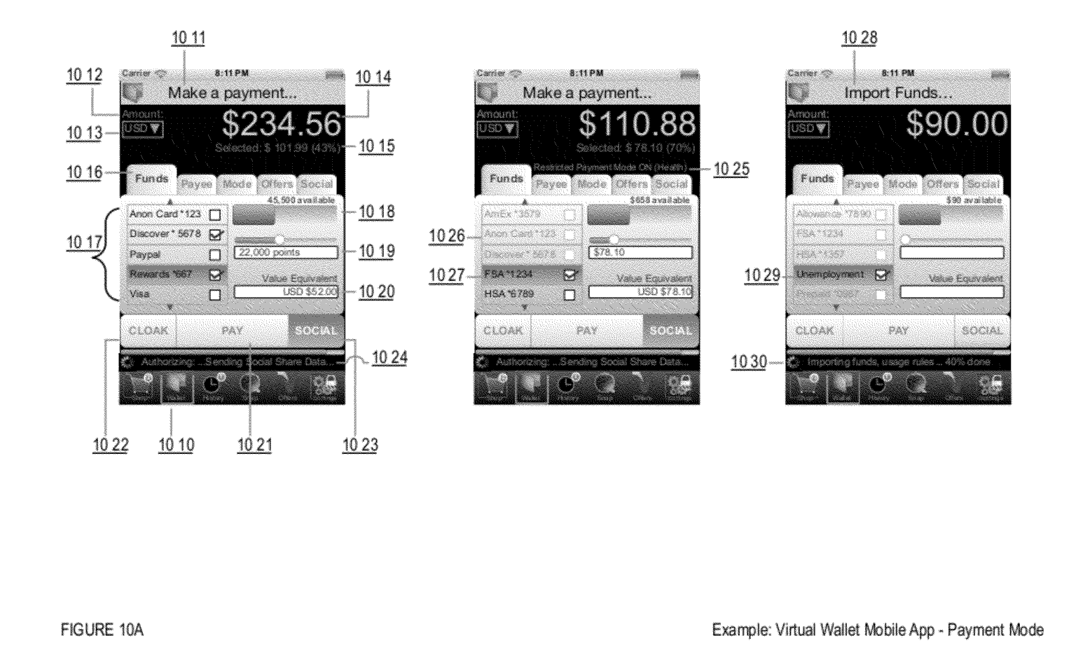

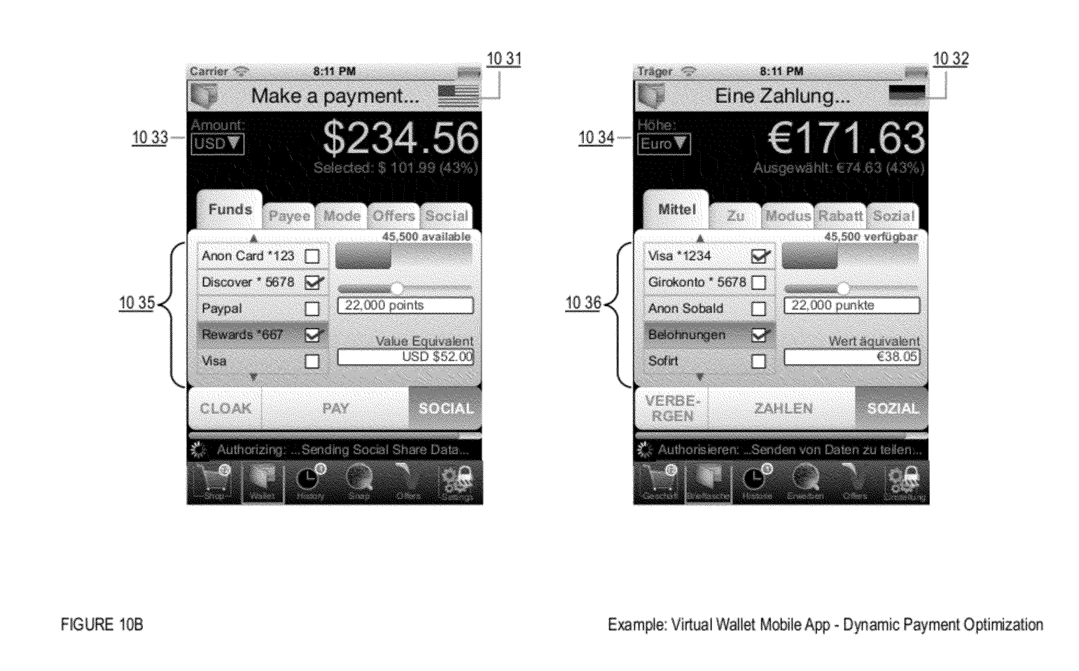

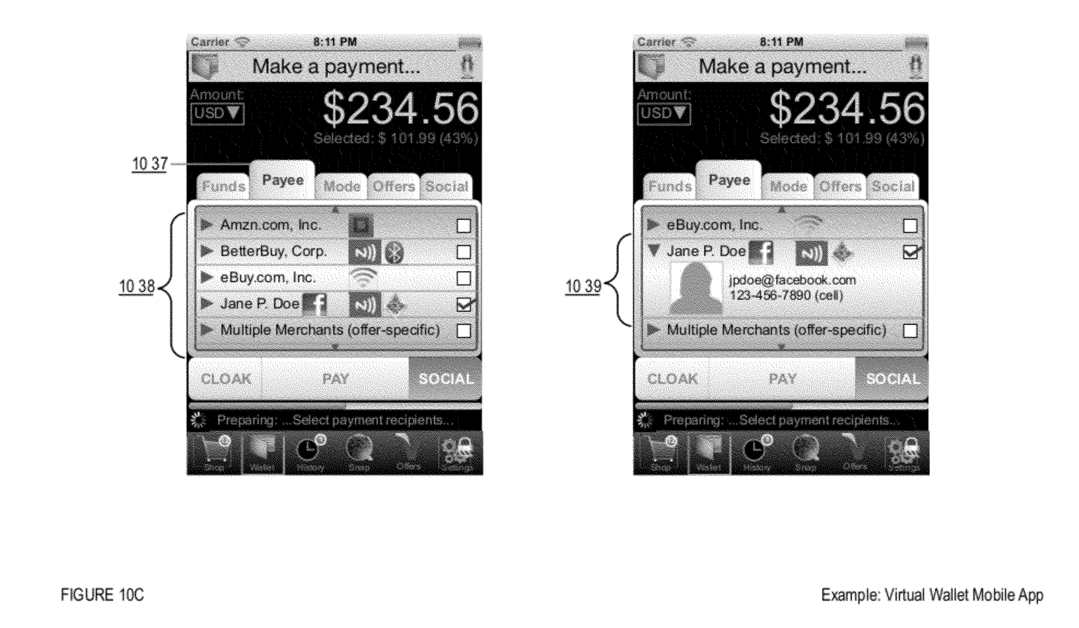

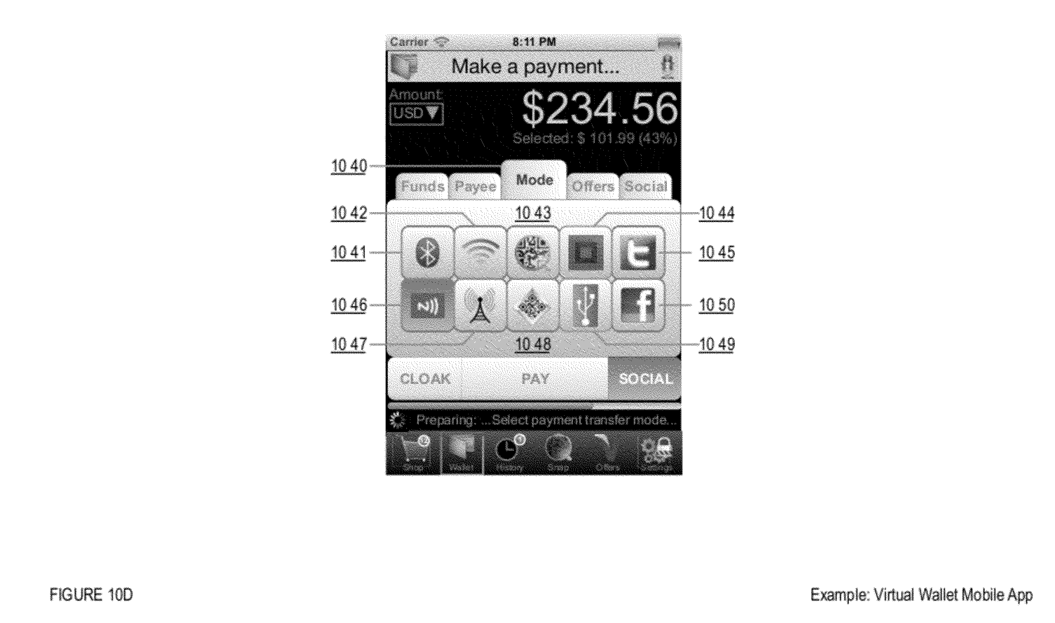

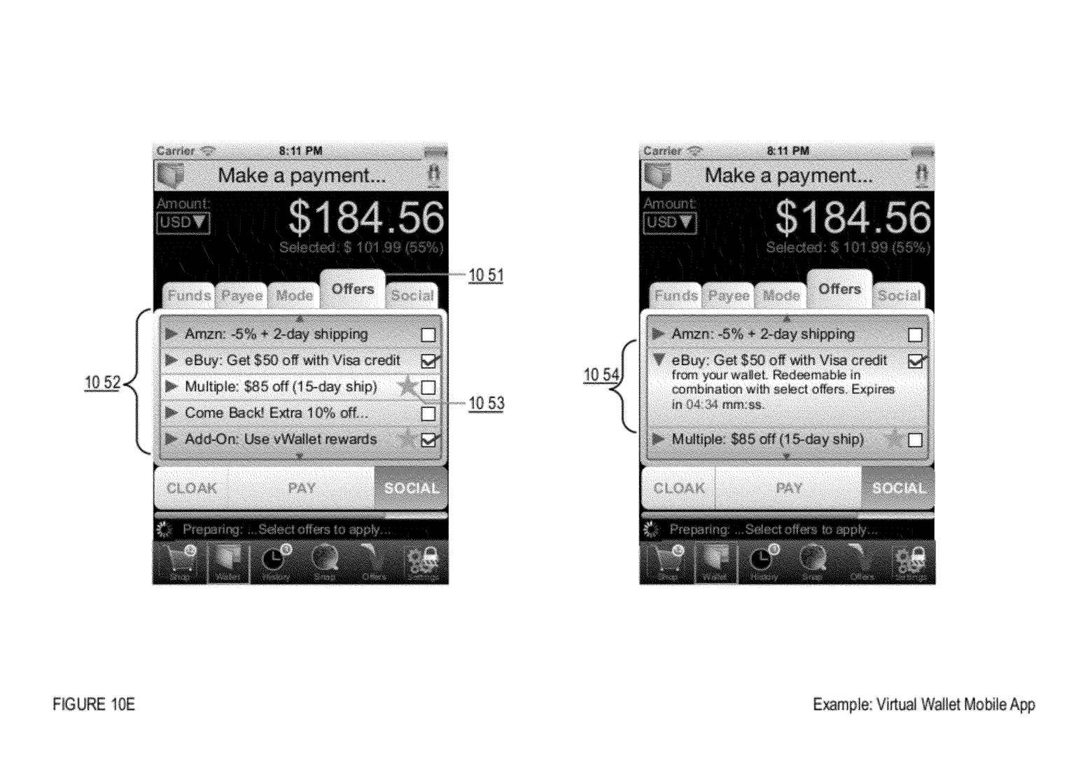

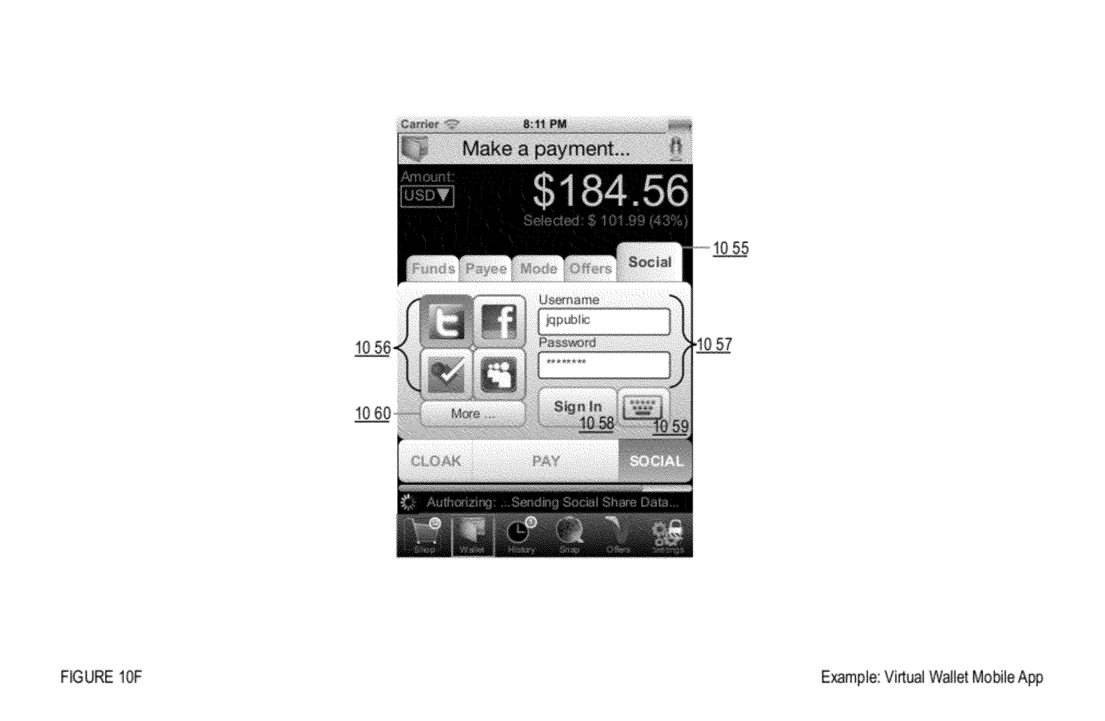

In some implementations, the user may desire to enroll for payment tokenization services, and may provide token creation input to complete the form, e.g., 513 (e.g., in one example, the user may engage a “cloak,” see FIG. 10A, 1022, or otherwise may provide an indication that they wish to enhance their privacy in a transaction) (in an alternative example, the user may provide such indication by requesting and/or otherwise purchasing a prepaid card, smart card, one-time use card, credit card, debit card, smartphone, PDA, having token information included therein). The client may generate a competed form, and provide, e.g., 514, the form to the token server (either directly or via the merchant server). The token server may obtain the form, and parse the form to extract data fields and values from the form to generate a token data record, e.g., 515. For example, the token server may generate a unique and resolvable token identifier irrespective of the token requesting channel (e.g., merchant, issuer, acquirer, payment network, user, etc.). In some implementations, the token server keeps track of all generated tokens via token identifiers, and as each is created, subsequent requests for creation of a token with the same token identifier will be denied. In some implementations, token record creation may be performed done serially. For example, a serial series of token identifiers may be created for each issuer, merchant, acquirer and/or payment network. For example, each series may involve a numeric range that is unique to each source. In other implementations, rather than serial application, token identifiers may be assigned by random allocation. In some implementations, each token may be pre-funded. For example, the source of the token (e.g., issuer, acquirer, independent token arbitrator) may first obtain assurance that funds have been uniquely and exclusively allocated for the token from the source to which the token points. Thus, in some implementations, the token may be pre-funded and pre-authorized for up to (or in the alternative, for exactly) a predefined amount of a purchase transaction. For example, the token server may generate a token data structure similar to the example XML-encoded data structure below:

<?XML version = “1.0” encoding = “UTF-8”?>
<token>

<unique_ID>4NFU4RG94</unique_ID>
<!-- user_ID may optionally be used in some embodiments-->
<user_ID>john.q.public@gmail.com</user_ID>
<timestamp>2011-02-22 15:22:43</timestamp>
<expiry>2011-02-28 23:59:59</expiry>
<auth_flag>true</auth_flag>
<auth_protocol>verifychat</auth_protocol>
<security_protocol>digital certificate, digital_cer_link
</security_protocol>
<digital_cert>52486ghb0bn_encrypted_hash_information_89032y4gh<digital_cert>
<digital_cert_link>http://www.acmedigitalcertification.com/auth.php?var=0t1h
v43059876</digital_cert_link>
<!-- In some embodiments, client_details are optional and the token may be
tied to a specific client-->
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>
<client_fingerprint>font list, MAC address, memory size, hardware

chip, screen resolution</client_fingerprint>
</client_details>
<funding>

<value_decay>10%/mo</value_decay>
<token_admin>issuer 123.65.78.129 123456789012345</token_admin>
<!--alternatively, token administrator may be different from funding

source and may also include merchant, pay network, third party-->

<funding_source>issuer</funding_source>
<!--merchant, pay networks, third parties pay also be funding

sources-->

<accounts>

<1>

<issuer_name>BankA</issuer_name>
<account_num>123456789012345</account_num>
<account_type>checking</account_type>
<confirm_type>email</confirm_type>
<!-- fields below optional in some embodiments-->
<account_name>John Q. Public</account_name>
<billing_addres>123 Green Street Apt 1</billing_address>
<phone>909-333-2345</phone>
<sign>/jqp/</sign>
<contact_info>jqp@gmail.com</contact_info>
<default_cost_share>65%</default_cost_share>

</1>
<2>

<issuer_name>TokenArbit</issuer_name>
<account_type>prefunded</account_type>
<unique_id>2325678654322345</unique_id>
<individual_decay>1.5%</individual_decay>
<default_cost_share>10%</default_cost_share>

</2>
<3>

<issuer_name>BankC</issuer_name>
<account_type>stored value account</account_type>
<account_num>123456789012345</account_num>
<max_value>$500</max_value>
<!-- fields below optional in some embodiments-->
<account_name>John Q. Public</account_name>
<billing_addres>123 Green Street Apt 1</billing_address>
<phone>909-333-2345</phone>
<sign>/jqp/</sign>
<confirm_type>email</confirm_type>
<contact_info>jqp@gmail.com</contact_info>
<default_cost_share>25%</default_cost_share>

</3>

</accounts>

</funding>
<shipping_info>

<unique_shipping_transaction_ID>A89349HH

</unique_shipping_transaction_ID>

<!-- use of shipping unique allows anonymous shipping to user in some

embodiments -->

<!-- fields below optional in some embodiments -->
<shipping_address>123 Green Street</shipping_address>
<ship_type>Overnight</ship_type>
<ship_carrier>FedEx</ship_carrier>
<ship_account>231453564392</ship_account>
<tracking_flag>true</tracking_flag>
<sign_flag>true</sign_flag>

</shipping_info>

</token>

The token server may also determine a set of privacy rules, restrictions, transaction processing rules (e.g., in which country should the servers involved in transaction processing reside), etc. applicable to the token created for the user. The token server may store the token data structure to a token database, and the privacy rules/restrictions/settings to a privacy rules database, e.g., 516. The token server may also provide a token identifier, e.g., 517 to the client. The token may be provided as a data structure via HTTP(S) POST, as a file (via file transport protocols), as an attachment (e.g., via email), and/or otherwise provided to the client device for later use. The client may store the token identifier and/or display the token identifier for the user, e.g., 518.

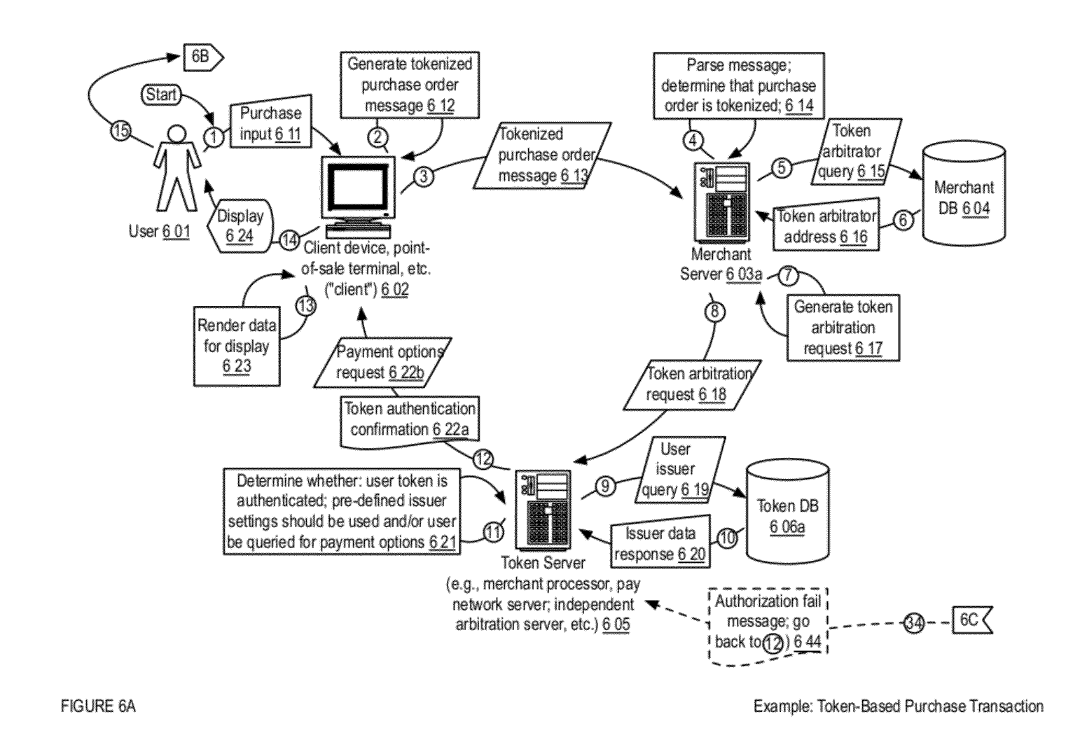

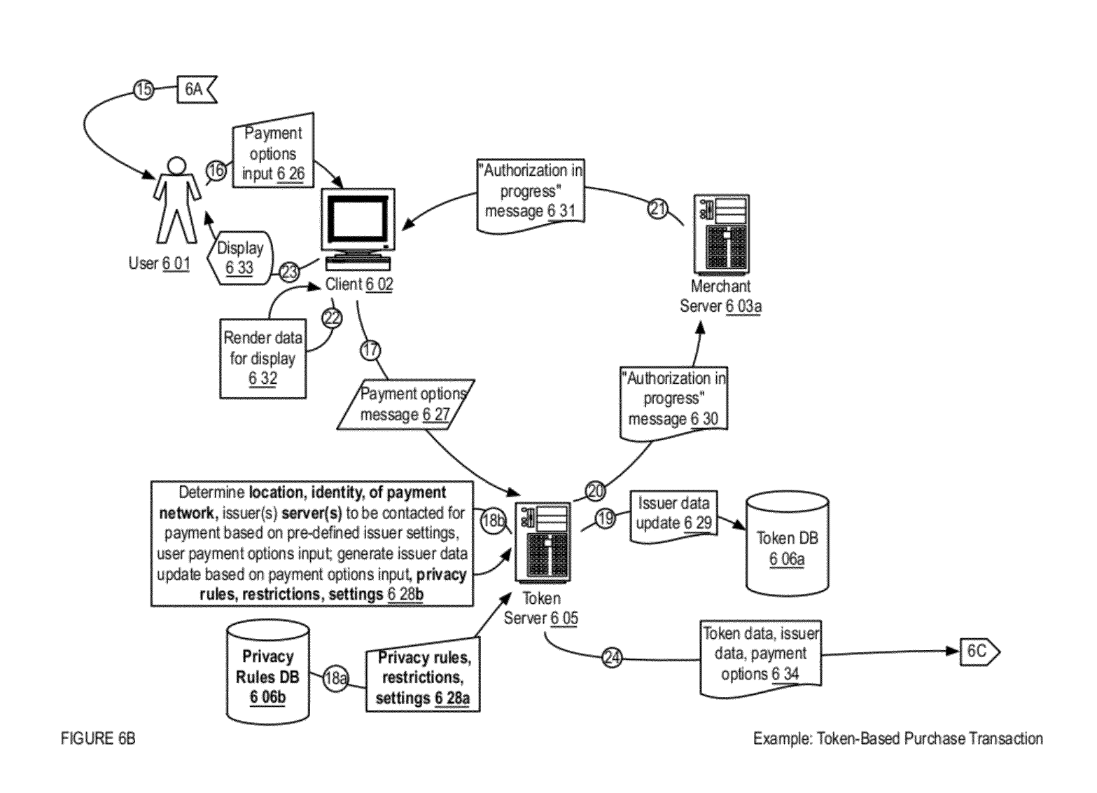

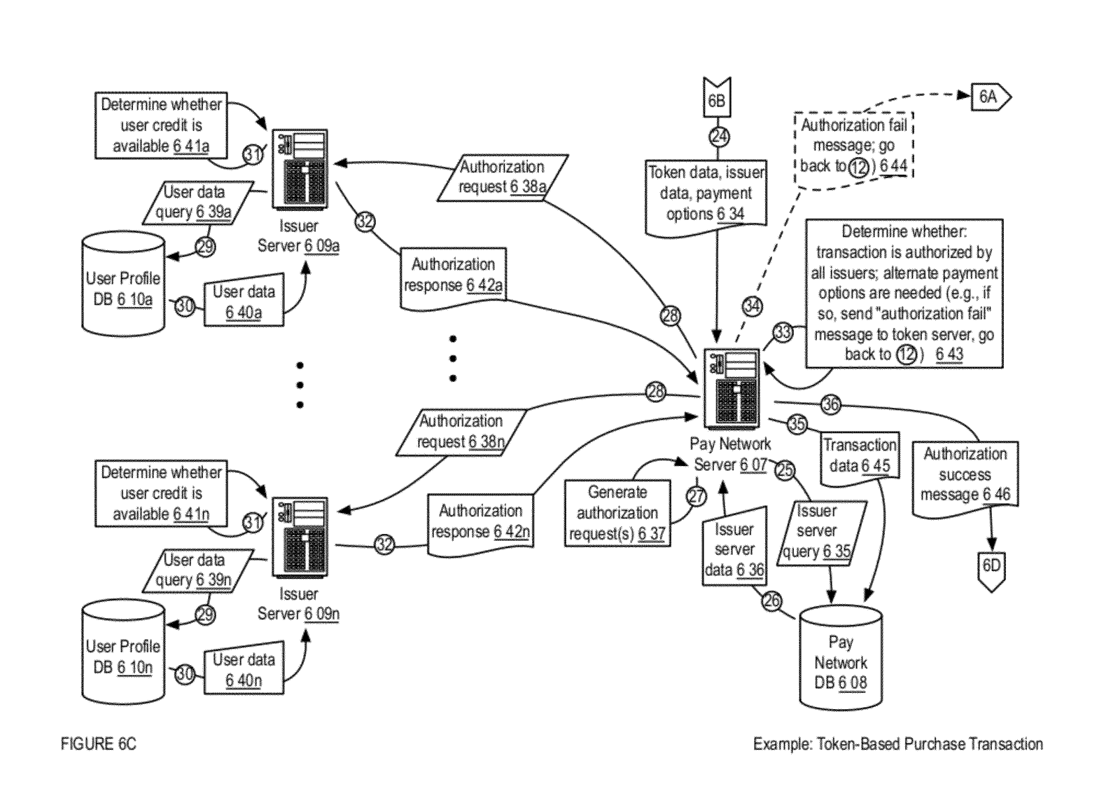

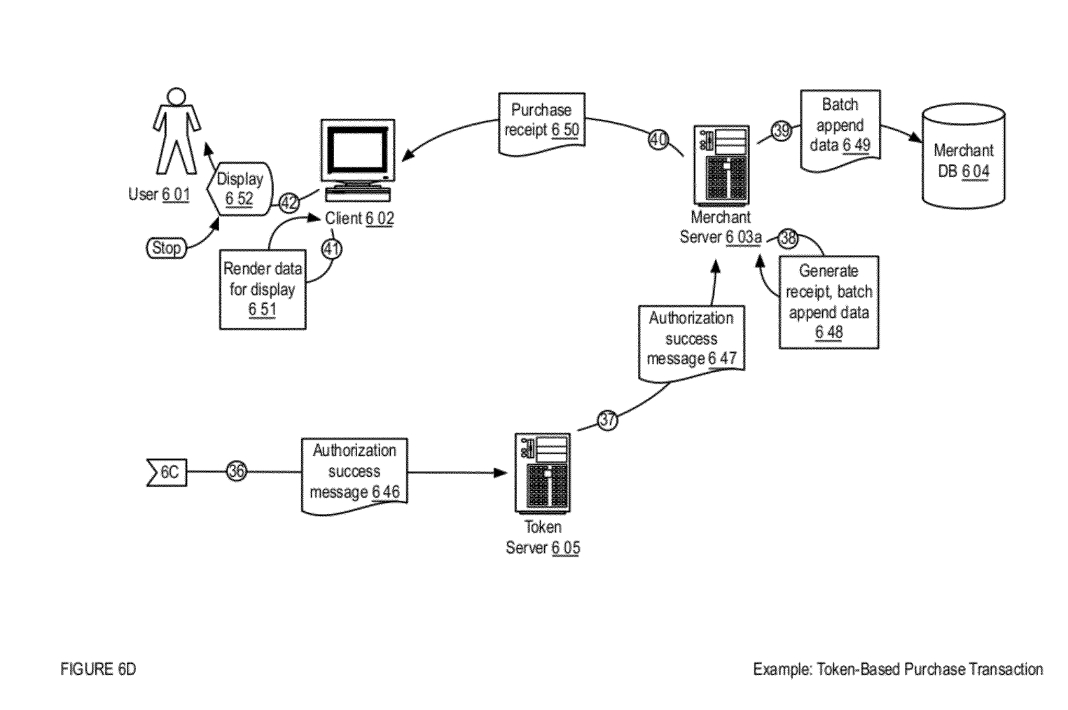

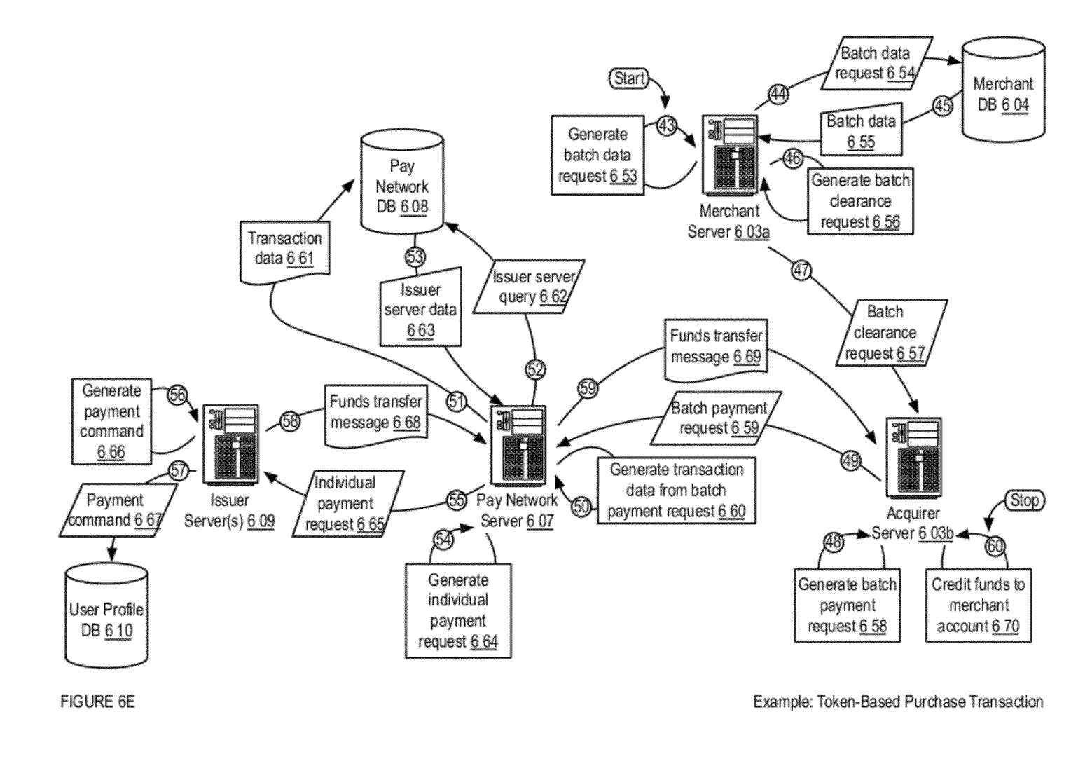

FIGS. 6A-E show data flow diagrams illustrating an example procedure to execute a token-based purchase transaction in some embodiments of the PPT. In some implementations, a user, e.g., 601, may desire to purchase a product, service, offering, and/or the like (“product”), from a merchant. The user may communicate with a merchant server, e.g., 603a, via a client such as, but not limited to: a personal computer, mobile device, television, point-of-sale terminal, kiosk, ATM, and/or the like (e.g., 602). For example, the user may provide user input, e.g., purchase input 611, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, the client may generate a tokenized purchase order message, e.g., 612, and provide, e.g., 613, the tokenized purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<token_id>1234567890123456</token_id>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. Based on parsing the message, the merchant may determine that the purchase order is tokenized. The merchant server may issue a query to a database, e.g., 615, to a merchant database, e.g., 604, to determine an arbitrator to process the tokenized purchase order. For example, the merchant server may utilize a hypertext preprocessor (“PHP”) script including Structured Query Language (“SQL”) commands to query a relational database for an address of a token arbitator. An example PHP/SQL listing for querying a database for a token arbitrator address is provided below:

<?PHP
header(′Content-Type: text/plain′);
mysql_connect(“254.93.179.112”,$DBserver,$password); // access
database server
mysql_select_db(“ARBITRATORS.SQL”); // select database table to
search
//create query for token arbitrators
$query = “SELECT arbitrator_id, arbitators_name arbitrator_address

arbitrator_URL FROM TokenizationTable WHERE user_card_num
LIKE ′%′ $userpaymentcardnumber”;

$result = mysql_query($query); // perform the search query
mysql_close(“ARBITRATORS.SQL”); // close database access
?>

In response, the merchant database may provide the token arbitrator address, e.g., 616. The merchant server may generate a token arbitration request, e.g., 617, and provide the token arbitration request, e.g., 618, to a token server, e.g., 605. For example, the merchant server may provide a HTTP(S) POST message including the token arbitration request similar to the example below:

POST /arbitrate.php HTTP/1.1
Host: www.tokenizer.com
Content-Type: Application/XML
Content-Length: 579
<?XML version = “1.0” encoding = “UTF-8”?>
GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<token_id>1234567890123456</token_id>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In various implementations, the token server may be part of the merchant system (e.g., a merchant process), or part of the payment network (e.g., a pay network server), or an independent server operating in conjunction with the merchant, issuer, acquirer and payment network. In general, it is to be understood that any entity and/or component included in the PPT may serve as a token arbitrator. In some implementations, the token server may parse the token arbitration request message, and extract the payment token from the message. The token server may determine the payment options to utilize (or determine whether to request the user to provide payment options details) for processing the transaction, using the payment token. For example, the token server may issue, e.g., 619, a user issuer query to a database, e.g., token database 606, using the payment token as search term in the query. For example, the token server may utilize PHP/SQL commands similar to the examples described above. In response, the token database may provide an issuer data response, e.g., 62o, including data on issuers to contact for payment. For example, the issuer data response may include an XML-encoded data file including instructions for the token server on how to proceed with payment processing for the transaction. An example XML-encoded issuer data file is provided below:

<?XML version = “1.0” encoding = “UTF-8”?>
<issuer_data>

<auto_default>false</auto_default>
<user_contact>in-app</user_contact>
<device_id>B17BP927</device_id>
<default>

<issuer>

<issuer_id>A12345</issuer_id>
<issuer_name>Bank de Tolkien</issuer_name>
<issuer_IP>123.45.67.891</issuer_IP>
<account_type>token</account_type>
<account_number>1234567890123456</account_number>
<percentage>65</percentage>

</issuer>
<issuer>

<issuer_id>B12345</issuer_id>
<issuer_name>ABC Credit Union</issuer_name>
<issuer_IP>223.25.67.091</issuer_IP>
<account_type>token</account_type>
<account_number>6543210987654321</account_number>
<percentage>25</percentage>

</issuer>
<issuer>

<issuer_id>C67890</issuer_id>
<issuer_name>BNR Bank</issuer_name>
<issuer_IP>153.65.87.231</issuer_IP>
<account_type>token</account_type>
<account_number>1234567890123456</account_number>
<percentage>10</percentage>

</issuer>

</default>

</issuer_data>

In some implementations, the token server may determine whether the user token is authenticated, e.g., 621. For example, if no XML data is available associated with the payment token, the token server may determine that the user has not signed up for payment tokenization services. As another example, if the XML data indicates that the user must be queried for authentication (e.g., login and password), then the token server may determine that verification of authentication is necessary. The token server may initiate a user verification session. For example, an app executing on the user's device may provide a “VerifyChat” feature for fraud prevention (e.g., by activating UI element 213 in FIG. 2). The token server may utilize the VerifyChat feature to communicate with the user, and verify the authenticity of the originator of the purchase transaction. In various implementations, the token server may send electronic mail message, text (SMS) messages, Facebook® messages, Twitter™ tweets, text chat, voice chat, video chat (e.g., Apple FaceTime), and/or the like to communicate with the user. For example, the token server may initiate a video challenge for the user. For example, the user may need to present him/her-self via a video chat. In some implementations, a customer service representative may manually determine the authenticity of the user using the video of the user. In some implementations, the PPT may utilize face, biometric and/or like recognition (e.g., using pattern classification techniques) to determine the identity of the user. In some implementations, the app may provide reference marker (e.g., cross-hairs, target box, etc.), so that the user may the video to facilitate the PPT′ automated recognition of the user. As another example, token server may request the user for a digital certificate to verify authenticity. As another example, the token server may request a user name and password to enable the token for payment processing.

If the token server determines that the user is authenticated, the token server may provide a token authentication confirmation, e.g., 622a. Also, if the token server determines that the user should be queried for payment options (e.g., instead of using only the pre-defined settings in the issuer data response 62o), the token server may request payment options from the user. For example, the token server may provide a HTTP(S) POST message similar to the examples above to the client 602. The client may render, e.g., 623, the token authentication confirmation and/or payment options request, and display the message(s) for the user, e.g., 624.

In some implementations, the user may desire to enter custom payment options to process the current purchase transaction. In such implementations, the user may provide a payment options input 626, for example, such as discussed above in the description with reference to FIG. 2. The client may generate a payment options message using the user's input, and provide the payment options message, e.g., 627, to the token server. In some embodiments, the token server may obtain privacy rules/restrictions/settings from a privacy rules database, e.g., 628a, based on which the token server may determine the location and identity of a server to which the token server should send the token data, issuer data, payment options, etc. for transaction processing. In some implementations, the token server may determine the issuers to contact for payment processing using the pre-defined issuer settings, privacy rules/restrictions/settings, and/or the payment options input provided by the user, e.g., 6628b. In some implementations, the token server may update the issuer data stored in the token database using the payment options input provided by the user, e.g., 629.

In some implementations, the token server may provide the token data, issuer data, and/or user payment options input, e.g., 634, to a pay network server (e.g., if the token server is separate from the pay network system). For example, the token server may provide a HTTP(S) POST message to the pay network server similar to the examples above. The pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some implementations, the pay network server may generate a query, e.g., 635, for issuer server(s) corresponding to the payment token and user-selected payment options. For example, the user's payment token may be linked to one or more issuer financial institutions (“issuers”), such as banking institutions, which issued the account(s) for the user linked to the payment token. For example, such accounts may include, but not be limited to: credit card, debit card, prepaid card, checking, savings, money market, certificates of deposit, stored (cash) value accounts and/or the like. Issuer server(s), e.g., 609a-n, of the issuer(s) may maintain details of the user's account linked to the payment token. In some implementations, a database, e.g., pay network database 608, may store details of the issuer server(s) associated with the issuer(s). For example, the database may be a relational database responsive to Structured Query Language (“SQL”) commands. The pay network server may query the pay network database for issuer server(s) details. For example, the pay network server may execute a hypertext preprocessor (“PHP”) script including SQL commands to query the database for details of the issuer server(s). An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address

mac_address auth_key port_num security_settings_list FROM
IssuerTable WHERE account_num LIKE ′%′ $accountnum”;

$result = mysql_query($query); // perform the search query
mysql_close(“ISSUERS.SQL”); // close database access
?>

In response to obtaining the issuer server query, e.g., 635, the pay network database may provide, e.g., 636, the requested issuer server data to the pay network server. In some implementations, the pay network server may utilize the issuer server data to generate authorization request(s), e.g., 637, for each of the issuer server(s) selected based on the pre-defined payment settings associated with the token, and/or the user's payment options input, and provide the card authorization request(s), e.g., 638a-n, to the issuer server(s), e.g., 609a-n. In some implementations, the authorization request(s) may include details such as, but not limited to: the costs to the user involved in the transaction, card account details of the user, user billing and/or shipping information, and/or the like. For example, the pay network server may provide a HTTP(S) POST message including an XML-formatted authorization request similar to the example listing provided below:

POST /authorization.php HTTP/1.1
Host: www.issuer.com
Content-Type: Application/XML
Content-Length: 624
<?XML version = “1.0” encoding = “UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for dummies</product_summary>
<product_quantity>1</product_quantity?

</product>

</purchase_summary>
<transaction_cost>$22.61</transaction_cost>
<account_params>

<account_type>token</account_type>
<account_num>1234567890123456</account_num>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</card_query_request>

In some implementations, an issuer server may parse the authorization request(s), and based on the request details may query a database, e.g., user profile database 610a-n, for data associated with an account linked to the user's payment token. For example, the issuer server may issue PHP/SQL commands similar to the example provided below:

<?PHP
header(′Content-Type: text/plain′);
mysql_connect(“254.93.179.112”,$DBserver,$password); // access
database server
mysql_select_db(“USERS.SQL”); // select database table to search
//create query for user data
$query = “SELECT user_id user_name user_balance account_type

FROM UserTable WHERE account_num LIKE ′%′ $accountnum”;

$result = mysql_query($query); // perform the search query
mysql_close(“USERS.SQL“); // close database access
?>

In some implementations, on obtaining the user data, e.g., 640a-n, the issuer server may determine whether the user can pay for the transaction using funds available in the account, e.g., 641a-n. For example, the issuer server may determine whether the user has a sufficient balance remaining in the account, sufficient credit associated with the account, and/or the like. Based on the determination, the issuer server(s) may provide an authorization response, e.g., 642a-n, to the pay network server. For example, the issuer server(s) may provide a HTTP(S) POST message similar to the examples above. In some implementations, if at least one issuer server determines that the user cannot pay for the transaction using the funds available in the account, see e.g., 643-644, the pay network server may request payment options again from the user (e.g., by providing an authorization fail message 644 to the token server and requesting the token server to obtain payment options input again from the user), and re-attempt authorization for the purchase transaction. In some implementations, if the number of failed authorization attempts exceeds a threshold, the pay network server may abort the authorization process, and provide an “authorization fail” message to the merchant server, token server and/or client.

In some implementations, the pay network server may obtain the authorization message including a notification of successful authorization, see e.g., 643, 646, and parse the message to extract authorization details. Upon determining that the user possesses sufficient funds for the transaction, the pay network server may generate a transaction data record, e.g., 645, from the authorization request and/or authorization response, and store the details of the transaction and authorization relating to the transaction in a transactions database. For example, the pay network server may issue PHP/SQL commands similar to the example listing below to store the transaction data in a database:

<?PHP
header(′Content-Type: text/plain′);
mysql_connect(″254.92.185.103”,$DBserver,$password); // access
database server
mysql_select(″TRANSACTIONS.SQL″); // select database to append
mysql_query(“INSERT INTO PurchasesTable (timestamp,

purchase_summary_list, num_products, product_summary,
product_quantity, transaction_cost, account_params_list,
account_name, account_type, account_num, billing_addres,
zipcode, phone, sign, merchant_params_list, merchant_id,
merchant_name, merchant_auth_key)

VALUES (time( ), $purchase_summary_list, $num_products,

$product_summary, $product_quantity, $transaction_cost,
$account_params_list, $account_name, $account_type,
$account_num, $billing_addres, $zipcode, $phone, $sign,
$merchant_params_list, $merchant_id, $merchant_name,
$merchant_auth_key)”);
// add data to table in database

mysql_close(″TRANSACTIONS.SQL″); // close connection to database
?>

In some implementations, the pay network server may forward an authorization success message, e.g., 646, to the token server, which may in turn forward the authorization success message, e.g., 647, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 648, and store the XML data file, e.g., 649, in a database, e.g., merchant database 604. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_key>
<account_number>123456789</account_number>

</merchant_data>
<transaction_data>

<transaction 1>

. . .

</transaction 1>
<transaction 2>

. . .

</transaction 2>

.
.
.

<transaction n>

. . .

</transaction n>

</transaction_data>

In some implementations, the server may also generate a purchase receipt, e.g., 648, and provide the purchase receipt to the client, e.g., 650. The client may render and display, e.g., 651-652, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 6E, in some implementations, the merchant server may initiate clearance of a batch of authorized transactions. For example, the merchant server may generate a batch data request, e.g., 653, and provide the request, e.g., 654, to a database, e.g., merchant database 604. For example, the merchant server may utilize PHP/SQL commands similar to the examples provided above to query a relational database. In response to the batch data request, the database may provide the requested batch data, e.g., 655. The server may generate a batch clearance request, e.g., 656, using the batch data obtained from the database, and provide, e.g., 657, the batch clearance request to an acquirer server, e.g., 603b. For example, the merchant server may provide a HTTP(S) POST message including XML-formatted batch data in the message body for the acquirer server. The acquirer server may generate, e.g., 658, a batch payment request using the obtained batch clearance request, and provide the batch payment request to the pay network server, e.g., 659. The pay network server may parse the batch payment request, and extract the transaction data for each transaction stored in the batch payment request, e.g., 66o. The pay network server may store the transaction data, e.g., 661, for each transaction in a database, e.g., pay network database 608. For each extracted transaction, the pay network server may query, e.g., 662-663, a database, e.g., pay network database 608, for an address of an issuer server. For example, the pay network server may utilize PHP/SQL commands similar to the examples provided above. The pay network server may generate an individual payment request, e.g., 664, for each transaction for which it has extracted transaction data, and provide the individual payment request, e.g., 665, to the issuer server, e.g., 609. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_summary>

<num_products>1</num_products>
<product>

<product_summary>Book - XML for dummies</product_summary>
<product_quantity>1</product_quantity?

</product>

</purchase_summary>

</pay_request>

In some implementations, the issuer server may generate a payment command, e.g., 666. For example, the issuer server may issue a command to deduct funds from the user's account (or add a charge to the user's credit card account). The issuer server may issue a payment command, e.g., 667, to a database storing the user's account information, e.g., user profile database 610. The issuer server may provide a funds transfer message, e.g., 668, to the pay network server, which may forward, e.g., 669, the funds transfer message to the acquirer server. An example HTTP(S) POST funds transfer message is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 670.

FIGS. 7A-F show logic flow diagrams illustrating example aspects of executing a token-based purchase transaction in some embodiments of the PPT, e.g., a Token-Based Purchase Transaction Execution (“tPTE”) component 700. In some implementations, a user may desire to purchase a product, service, offering, and/or the like (“product”), from a merchant. The user may communicate with a merchant server, via a client. For example, the user may provide purchase input, e.g., 701, into the client indicating the user's desire to purchase the product. In some implementations, the client may generate a tokenized purchase order message, e.g., 702, and provide the tokenized purchase order message to the merchant server. The merchant server may obtain the purchase order message from the client, and may parse the purchase order message to extract details of the purchase order from the user. Based on parsing the message, the merchant may determine that the purchase order is tokenized, e.g., 703. If the merchant server determines that the purchase order is not tokenized, e.g., 704, option “No,” then the merchant server may process the transaction as a normal card-based transaction, and bypass the token interpretation process. If the merchant server determines that the purchase order is tokenized, e.g., 704, option “Yes,” then the merchant server may issue a query, e.g., 705, to a merchant database to determine an arbitrator to process the tokenized purchase order. In response, the merchant database may provide the token arbitrator address, e.g., 707. The merchant server may generate a token arbitration request, e.g., 708, and provide the token arbitration request to a token server.

In some implementations, the token server may parse the token arbitration request message, and extract the payment token from the message. The token server may determine the payment options to utilize (or determine whether to request the user to provide payment options details) for processing the transaction, using the payment token. For example, the token server may issue, e.g., 708, a user issuer query to a token database using the payment token as search term in the query. In response, the token database may provide an issuer data response, e.g., 709, including data on issuers to contact for payment. In some implementations, the token server may determine whether the user token is authenticated, e.g., 710. If the token server determines that the user is not authenticated, e.g., 711, option “No,” the token server may generate an “authentication fail message,” e.g., 712a, and initiate an error-handling routine and/or a user enrollment routine, e.g., 712b, such as the PTE 500 component discussed above in the description with reference to FIG. 5. If the token server determines that the user is authenticated, e.g., 711, option “Yes,” the token server may continue processing at 713a. The token server may generate a query 713a for token data from a token database, as well as privacy rules, restrictions, settings, etc., associated with the token, from a privacy rules database. For example, such restrictions may specify that all transaction involving the token may only be processed at servers located within a particular country. As another example, the restriction may be updated (e.g., periodically, automatically, on demand) based on privacy and/or other laws governing processing of transactions in that country. As another example, the restriction may accord weights to various factors (e.g., transaction processing server load balancing, network congestion, privacy constraints, security constraints, etc.), and may require weighing the factors (e.g., by calculating a weighted-average score based on the factors) to determine a country in which to process a transaction utilizing the token. As another example, the token may specify a set of countries in which the transaction may (not) be processed. The privacy rules database may provide 713b the requested data to the token server. As already discussed above, in an embodiment where the token does not include the country code itself, a privacy database table, e.g., 15190, may be used to resolve the consumer's home country, country code, and/or restrictions thereto, by using the token as a basis for querying such a database table. The token server may utilize the token data and/or privacy rules, restrictions, settings, etc. to determine whether the user should be queried for payment options (e.g., instead of using only the pre-defined settings in the issuer data response), e.g., 714. If the token server determines that the user should be queries for payment options settings, e.g., 715, option “No,” the token server may request payment options from the user, e.g., 716. The client may render the payment options request and display the request, e.g., 717.

In some implementations, the user may desire to enter custom payment options to process the current purchase transaction. In such implementations, the user may provide a payment options input 718. The client may generate a payment options message using the user's input, and provide the payment options message to the token server. In some implementations, the token server may determine the identity (e.g., IP address, MAC address, URL, etc.) of server(s) of payment network(s), issuer(s) to contact for payment processing using the pre-defined issuer settings, privacy rules, transaction processing restrictions, settings, etc. (obtained from the privacy rules database), and/or the payment options input provided by the user, e.g., 719. In some implementations, the token server may update the issuer data stored in the token database using the payment options input provided by the user, e.g., 720. In some implementations, the token server may generate an “authorization in progress” message, e.g., 721, and provide the message to the merchant server, which may in turn forward, e.g., 722, the message to the client. The client may render and display, e.g., 723, the “authorization in progress” message for the user.

In some implementations, the token server may generate a message including the token data, issuer data, and/or user payment options input, e.g., 724, and provide the message to a pay network server (e.g., if the token server is separate from the pay network system) selected using the privacy rules, transaction processing restrictions, settings, etc. The pay network server may process the transaction so as to transfer funds for the purchase into an account stored on an acquirer of the merchant. If the merchant server initially received a non-tokenized purchase order message for the client, e.g., 725, the merchant server may generate a card query request, e.g., 726, and provide the card query request to an acquirer server. The acquirer server may parse the merchant server's request, e.g., 727, generate a card authorization request, e.g., 728, and provide the card authorization request to a pay network server. However, if the initial purchase order from the client is tokenized, the token server may deconstruct the payment details to be utilized, as discussed above, and may provide the token, issue and payment options to a pay network server, e.g., 729.

In some implementations, the pay network server may generate a query, e.g., 729, for issuer server(s) corresponding to the payment token and user-selected payment options. In some implementations, the pay network server may query the pay network database for issuer server(s) details, e.g., 730. In response to obtaining the issuer server query, the pay network database may provide, e.g., 731, the requested issuer server data to the pay network server. In some implementations, the pay network server may utilize the issuer server data to generate authorization request(s), e.g., 732, for each of the issuer server(s) selected based on the pre-defined payment settings associated with the token, and/or the user's payment options input, and provide the card authorization request(s) to the issuer server(s). In some implementations, an issuer server may parse the authorization request(s), e.g., 733, and based on the request details may query a user profile database for data associated with an account linked to the user's payment token, e.g., 734. In some implementations, on obtaining the user data, e.g., 735, the issuer server may determine whether the user can pay for the transaction using funds available in the account, e.g., 736. For example, the issuer server may determine whether the user has a sufficient balance remaining in the account, sufficient credit associated with the account, and/or the like. Based on the determination, the issuer server(s) may generate and provide an authorization response, e.g., 737, to the pay network server. In some implementations, if at least one issuer server determines that the user cannot pay for the transaction using the funds available in the account, see e.g., 738, 739, option “No,” the pay network server may request payment options again from the user (e.g., by providing an authorization fail message 644 to the token server and requesting the token server to obtain payment options input again from the user), and re-attempt authorization for the purchase transaction. In some implementations, if the number of failed authorization attempts exceeds a threshold, e.g., 740, option “Yes,” the pay network server may abort the authorization process, and provide an “transaction terminated” message, e.g., 741, to the merchant server, token server and/or client.

In some implementations, the pay network server may obtain the authorization message including a notification of successful authorization and parse the message to extract authorization details. Upon determining that the user possesses sufficient funds for the transaction, e.g., 739, option “Yes,” the pay network server may generate a transaction data record, e.g., 742, from the authorization request and/or authorization response, and store, e.g., 743, the details of the transaction and authorization relating to the transaction in a transactions database. In some implementations, the pay network server may generate an authorization success message, e.g., 744, and forward the message to the token server, which may in turn forward the authorization success message, e.g., 745-746, to the acquirer server and/or the merchant server. In some embodiments, the authorization success message may include no personally identifying information, and may, in some embodiments, include only the payment token identifier. The merchant may obtain the authorization message, and determine from it whether the transaction was authorized, e.g., 747-748. If the transaction was authorized, e.g., 748, option “Yes,” the merchant server may add a record of the transaction for the user to a batch of transaction data relating to authorized transactions, e.g., 749-750. In some implementations, the server may also generate a purchase receipt, e.g., 751, and provide the purchase receipt to the client. The client may render and display, e.g., 753, the purchase receipt for the user.

With reference to FIGS. 7E-F, in some implementations, the merchant server may initiate clearance of a batch of authorized transactions. For example, the merchant server may generate a batch data request, e.g., 754, and provide the request to a merchant database. In response to the batch data request, the merchant database may provide the requested batch data, e.g., 755. The server may generate a batch clearance request, e.g., 756, using the batch data obtained from the database, and provide the batch clearance request to an acquirer server. The acquirer server may parse the batch clearance request, e.g., 657, and generate, e.g., 758, a batch payment request using the obtained batch clearance request, and provide the batch payment request to the pay network server. The pay network server may parse the batch payment request, e.g., 759, and extract the transaction data for each transaction stored in the batch payment request. For each payment request in the batch, the pay network server may extract purchase transaction data, e.g., 761, and generate a transaction data record, e.g., 762. The pay network server may store the transaction data, e.g., 763, for each transaction in a pay network database. For each extracted transaction, the pay network server may query, e.g., 764-765, the pay network database for an address of an issuer server. The pay network server may generate an individual payment request, e.g., 766, for each transaction for which it has extracted transaction data, and provide the individual payment request to the issuer server.

In some implementations, the issuer server may parse the individual payment request, e.g., 767, and generate a payment command, e.g., 768. For example, the issuer server may issue a command to deduct funds from the user's account (or add a charge to the user's credit card account). The issuer server may issue a payment command to a user profile database. The issuer server may generate a funds transfer message, e.g., 770, and provide the message to the pay network server. As described above, the system may process each individual payment request in the batch, until all requests in the batch have been processed, see e.g., 771. The pay network server may then generate a batch funds transfer message, e.g., 772, and provide the batch funds transfer message to the acquirer server, e.g., 773. In some implementations, the acquirer server may parse the funds transfer message, and correlate the transaction to the merchant. The acquirer server may then transfer the funds specified in the funds transfer message to an account of the merchant, e.g., 774.

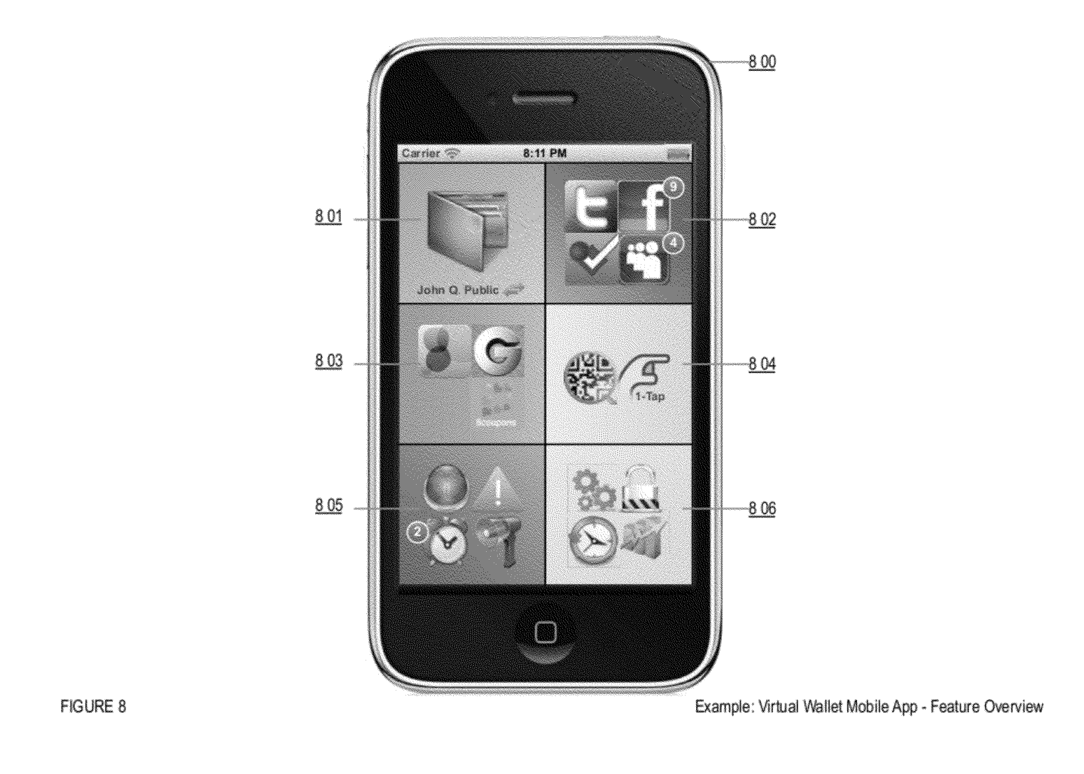

FIG. 8 shows a user interface diagram illustrating an overview of example features of virtual wallet applications in some embodiments of the PPT. FIG. 8 shows an illustration of various exemplary features of a virtual wallet mobile application 800. Some of the features displayed include a wallet 801, social integration via TWITTER, FACEBOOK, etc., offers and loyalty 803, snap mobile purchase 804, alerts 805 and security, setting and analytics 896. These features are explored in further detail below.

FIGS. 9A-G show user interface diagrams illustrating example features of virtual wallet applications in a shopping mode, in some embodiments of the PPT. With reference to FIG. 9A, some embodiments of the virtual wallet mobile app facilitate and greatly enhance the shopping experience of consumers. A variety of shopping modes, as shown in FIG. 9A, may be available for a consumer to peruse. In one implementation, for example, a user may launch the shopping mode by selecting the shop icon 910 at the bottom of the user interface. A user may type in an item in the search field 912 to search and/or add an item to a cart 911. A user may also use a voice activated shopping mode by saying the name or description of an item to be searched and/or added to the cart into a microphone 913. In a further implementation, a user may also select other shopping options 914 such as current items 915, bills 916, address book 917, merchants 918 and local proximity 919.

In one embodiment, for example, a user may select the option current items 915, as shown in the left most user interface of FIG. 9A. When the current items 915 option is selected, the middle user interface may be displayed. As shown, the middle user interface may provide a current list of items 915a-h in a user's shopping cart 911. A user may select an item, for example item 915a, to view product description 915j of the selected item and/or other items from the same merchant. The price and total payable information may also be displayed, along with a QR code 915k that captures the information necessary to effect a snap mobile purchase transaction.

With reference to FIG. 9B, in another embodiment, a user may select the bills 916 option. Upon selecting the bills 916 option, the user interface may display a list of bills and/or receipts 916a-h from one or more merchants. Next to each of the bills, additional information such as date of visit, whether items from multiple stores are present, last bill payment date, auto-payment, number of items, and/or the like may be displayed. In one example, the wallet shop bill 916a dated Jan. 20, 2011 may be selected. The wallet shop bill selection may display a user interface that provides a variety of information regarding the selected bill. For example, the user interface may display a list of items 916k purchased, <<916i>>>, a total number of items and the corresponding value. For example, 7 items worth $102.54 were in the selected wallet shop bill. A user may now select any of the items and select buy again to add purchase the items. The user may also refresh offers 916j to clear any invalid offers from last time and/or search for new offers that may be applicable for the current purchase. As shown in FIG. 9B, a user may select two items for repeat purchase. Upon addition, a message 916l may be displayed to confirm the addition of the two items, which makes the total number of items in the cart 14.

With reference to FIG. 9C, in yet another embodiment, a user may select the address book option 917 to view the address book 917a which includes a list of contacts 917b and make any money transfers or payments. In one embodiment, the address book may identify each contact using their names and available and/or preferred modes of payment. For example, a contact Amanda G. may be paid via social pay (e.g., via FACEBOOK) as indicated by the icon 917c. In another example, money may be transferred to Brian S. via QR code as indicated by the QR code icon 917d. In yet another example, Charles B. may accept payment via near field communication 917e, Bluetooth 917f and email 917g. Payment may also be made via USB 917h (e.g., by physically connecting two mobile devices) as well as other social channels such as TWITTER.

In one implementation, a user may select Joe P. for payment. Joe P., as shown in the user interface, has an email icon 917g next to his name indicating that Joe P. accepts payment via email. When his name is selected, the user interface may display his contact information such as email, phone, etc. If a user wishes to make a payment to Joe P. by a method other than email, the user may add another transfer mode 917j to his contact information and make a payment transfer. With reference to FIG. 9D, the user may be provided with a screen 917k where the user can enter an amount to send Joe, as well as add other text to provide Joe with context for the payment transaction 917l. The user can choose modes (e.g., SMS, email, social networking) via which Joe may be contacted via graphical user interface elements, 917m. As the user types, the text entered may be provided for review within a GUI element 917n. When the user has completed entering in the necessary information, the user can press the send button 9170 to send the social message to Joe. If Joe also has a virtual wallet application, Joe may be able to review 917p social pay message within the app, or directly at the website of the social network (e.g., for Twitter™, Facebook®, etc.). Messages may be aggregated from the various social networks and other sources (e.g., SMS, email). The method of redemption appropriate for each messaging mode may be indicated along with the social pay message. In the illustration in FIG. 9D, the SMS 917q Joe received indicates that Joe can redeem the $5 obtained via SMS by replying to the SMS and entering the hash tag value ‘#1234’. In the same illustration, Joe has also received a message 917r via Facebook®, which includes a URL link that Joe can activate to initiate redemption of the $25 payment.

With reference to FIG. 9E, in some other embodiments, a user may select merchants 918 from the list of options in the shopping mode to view a select list of merchants 918a-e. In one implementation, the merchants in the list may be affiliated to the wallet, or have affinity relationship with the wallet. In another implementation, the merchants may include a list of merchants meeting a user-defined or other criteria. For example, the list may be one that is curated by the user, merchants where the user most frequently shops or spends more than an x amount of sum or shopped for three consecutive months, and/or the like. In one implementation, the user may further select one of the merchants, Amazon 918a for example. The user may then navigate through the merchant's listings to find items of interest such as 918f-j. Directly through the wallet and without visiting the merchant site from a separate page, the user may make a selection of an item 918j from the catalog of Amazon 918a. As shown in the right most user interface of FIG. 9D, the selected item may then be added to cart. The message 918k indicates that the selected item has been added to the cart, and updated number of items in the cart is now 13.

With reference to FIG. 9F, in one embodiment, there may be a local proximity option 919 which may be selected by a user to view a list of merchants that are geographically in close proximity to the user. For example, the list of merchants 919a-e may be the merchants that are located close to the user. In one implementation, the mobile application may further identify when the user in a store based on the user's location. For example, position icon 919d may be displayed next to a store (e.g., Walgreens) when the user is in close proximity to the store. In one implementation, the mobile application may refresh its location periodically in case the user moved away from the store (e.g., Walgreens). In a further implementation, the user may navigate the offerings of the selected Walgreens store through the mobile application. For example, the user may navigate, using the mobile application, to items 919f-j available on aisle 5 of Walgreens. In one implementation, the user may select corn 919i from his or her mobile application to add to cart 919k.

With reference to FIG. 9G, in another embodiment, the local proximity option 919 may include a store map and a real time map features among others. For example, upon selecting the Walgreens store, the user may launch an aisle map 919l which displays a map 919m showing the organization of the store and the position of the user (indicated by a yellow circle). In one implementation, the user may easily configure the map to add one or more other users (e.g., user's kids) to share each other's location within the store. In another implementation, the user may have the option to launch a “store view” similar to street views in maps. The store view 919n may display images/video of the user's surrounding. For example, if the user is about to enter aisle 5, the store view map may show the view of aisle 5. Further the user may manipulate the orientation of the map using the navigation tool 9190 to move the store view forwards, backwards, right, left as well clockwise and counterclockwise rotation

FIGS. 10A-F show user interface diagrams illustrating example features of virtual wallet applications in a payment mode, in some embodiments of the PPT. With reference to FIG. 10A, in one embodiment, the wallet mobile application may provide a user with a number of options for paying for a transaction via the wallet mode 1010. In one implementation, an example user interface 1011 for making a payment is shown. The user interface may clearly identify the amount 1012 and the currency 1013 for the transaction. The amount may be the amount payable and the currency may include real currencies such as dollars and euros, as well as virtual currencies such as reward points. The amount of the transaction 1014 may also be prominently displayed on the user interface. The user may select the funds tab 1016 to select one or more forms of payment 1017, which may include various credit, debit, gift, rewards and/or prepaid cards. The user may also have the option of paying, wholly or in part, with reward points. For example, the graphical indicator 1018 on the user interface shows the number of points available, the graphical indicator 1019 shows the number of points to be used towards the amount due 234.56 and the equivalent 1020 of the number of points in a selected currency (USD, for example).

In one implementation, the user may combine funds from multiple sources to pay for the transaction. The amount 1015 displayed on the user interface may provide an indication of the amount of total funds covered so far by the selected forms of payment (e.g., Discover card and rewards points). The user may choose another form of payment or adjust the amount to be debited from one or more forms of payment until the amount 1015 matches the amount payable 1014. Once the amounts to be debited from one or more forms of payment are finalized by the user, payment authorization may begin.

In one implementation, the user may select a secure authorization of the transaction by selecting the cloak button 1022 to effectively cloak or anonymize some (e.g., pre-configured) or all identifying information such that when the user selects pay button 1021, the transaction authorization is conducted in a secure and anonymous manner. In another implementation, the user may select the pay button 1021 which may use standard authorization techniques for transaction processing. In yet another implementation, when the user selects the social button 1023, a message regarding the transaction may be communicated to one of more social networks (set up by the user) which may post or announce the purchase transaction in a social forum such as a wall post or a tweet. In one implementation, the user may select a social payment processing option 1023. The indicator 1024 may show the authorizing and sending social share data in progress.

In another implementation, a restricted payment mode 1025 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 1026 under the funds tab to select specialized accounts such as a flexible spending account (FSA) 1027, health savings account (HAS), and/or the like and amounts to be debited to the selected accounts. In one implementation, such restricted payment mode 1025 processing may disable social sharing of purchase information.

In one embodiment, the wallet mobile application may facilitate importing of funds via the import funds user interface 1028. For example, a user who is unemployed may obtain unemployment benefit fund 1029 via the wallet mobile application. In one implementation, the entity providing the funds may also configure rules for using the fund as shown by the processing indicator message 1030. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

With reference to FIG. 10B, in one embodiment, the wallet mobile application may facilitate dynamic payment optimization based on factors such as user location, preferences and currency value preferences among others. For example, when a user is in the United States, the country indicator 1031 may display a flag of the United States and may set the currency 1033 to the United States. In a further implementation, the wallet mobile application may automatically rearrange the order in which the forms of payments 1035 are listed to reflect the popularity or acceptability of various forms of payment. In one implementation, the arrangement may reflect the user's preference, which may not be changed by the wallet mobile application.

Similarly, when a German user operates a wallet in Germany, the mobile wallet application user interface may be dynamically updated to reflect the country of operation 1032 and the currency 1034. In a further implementation, the wallet application may rearrange the order in which different forms of payment 1036 are listed based on their acceptance level in that country. Of course, the order of these forms of payments may be modified by the user to suit his or her own preferences.

With reference to FIG. 10C, in one embodiment, the payee tab 1037 in the wallet mobile application user interface may facilitate user selection of one or more payees receiving the funds selected in the funds tab. In one implementation, the user interface may show a list of all payees 1038 with whom the user has previously transacted or available to transact. The user may then select one or more payees. The payees 1038 may include larger merchants such as Amazon.com Inc., and individuals such as Jane P. Doe. Next to each payee name, a list of accepted payment modes for the payee may be displayed. In one implementation, the user may select the payee Jane P. Doe 1039 for receiving payment. Upon selection, the user interface may display additional identifying information relating to the payee.

With reference to FIG. 10D, in one embodiment, the mode tab 1040 may facilitate selection of a payment mode accepted by the payee. A number of payment modes may be available for selection. Example modes include, blue tooth 1041, wireless 1042, snap mobile by user-obtained QR code 1043, secure chip 1044, TWITTER 1045, 13 near-field communication (NFC) 1046, cellular 1047, snap mobile by user-provided QR code 1048, USB 1049 and FACEBOOK 1050, among others. In one implementation, only the payment modes that are accepted by the payee may be selectable by the user. Other non-accepted payment modes may be disabled.

With reference to FIG. 10E, in one embodiment, the offers tab 1051 may provide real-time offers that are relevant to items in a user's cart for selection by the user. The user may select one or more offers from the list of applicable offers 1052 for redemption. In one implementation, some offers may be combined, while others may not. When the user selects an offer that may not be combined with another offer, the unselected offers may be disabled. In a further implementation, offers that are recommended by the wallet application's recommendation engine may be identified by an indicator, such as the one shown by 1053. In a further implementation, the user may read the details of the offer by expanding the offer row as shown by 1054 in the user interface.

With reference to FIG. 10F, in one embodiment, the social tab 1055 may facilitate integration of the wallet application with social channels 1056. In one implementation, a user may select one or more social channels 1056 and may sign in to the selected social channel from the wallet application by providing to the wallet application the social channel user name and password 1057 and signing in 1058. The user may then use the social button 1059 to send or receive money through the integrated social channels. In a further implementation, the user may send social share data such as purchase information or links through integrated social channels. In another embodiment, the user supplied login credentials may allow PPT to engage in interception parsing.

FIG. 11 shows a user interface diagram illustrating example features of virtual wallet applications, in a history mode, in some embodiments of the PPT. In one embodiment, a user may select the history mode 1110 to view a history of prior purchases and perform various actions on those prior purchases. For example, a user may enter a merchant identifying information such as name, product, MCC, and/or the like in the search bar 1111. In another implementation, the user may use voice activated search feature by clicking on the microphone icon 1114. The wallet application may query the storage areas in the mobile device or elsewhere (e.g., one or more databases and/or tables remote from the mobile device) for transactions matching the search keywords. The user interface may then display the results of the query such as transaction 1115. The user interface may also identify the date 1112 of the transaction, the merchants and items 1113 relating to the transaction, a barcode of the receipt confirming that a transaction was made, the amount of the transaction and any other relevant information.

In one implementation, the user may select a transaction, for example transaction 1115, to view the details of the transaction. For example, the user may view the details of the items associated with the transaction and the amounts 1116 of each item. In a further implementation, the user may select the show option 1117 to view actions 1118 that the user may take in regards to the transaction or the items in the transaction. For example, the user may add a photo to the transaction (e.g., a picture of the user and the iPad the user bought). In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 1119 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 1120 shows FACEBOOK message exchanges between two users. In one implementation, a user may share a link via a message 1121. Selection of such a message having embedded link to a product may allow the user to view a description of the product and/or purchase the product directly from the history mode.

In one embodiment, the history mode may also include facilities for exporting receipts. The export receipts pop up 1122 may provide a number of options for exporting the receipts of transactions in the history. For example, a user may use one or more of the options 1125, which include save (to local mobile memory, to server, to a cloud account, and/or the like), print to a printer, fax, email, and/or the like. The user may utilize his or her address book 1123 to look up email or fax number for exporting. The user may also specify format options 1124 for exporting receipts. Example format options may include, without limitation, text files (.doc, .txt, .rtf, iif, etc.), spreadsheet (.csv, .xls, etc.), image files (.jpg, .tff, .png, etc.), portable document format (.pdf), postscript (.ps), and/or the like. The user may then click or tap the export button 1127 to initiate export of receipts.

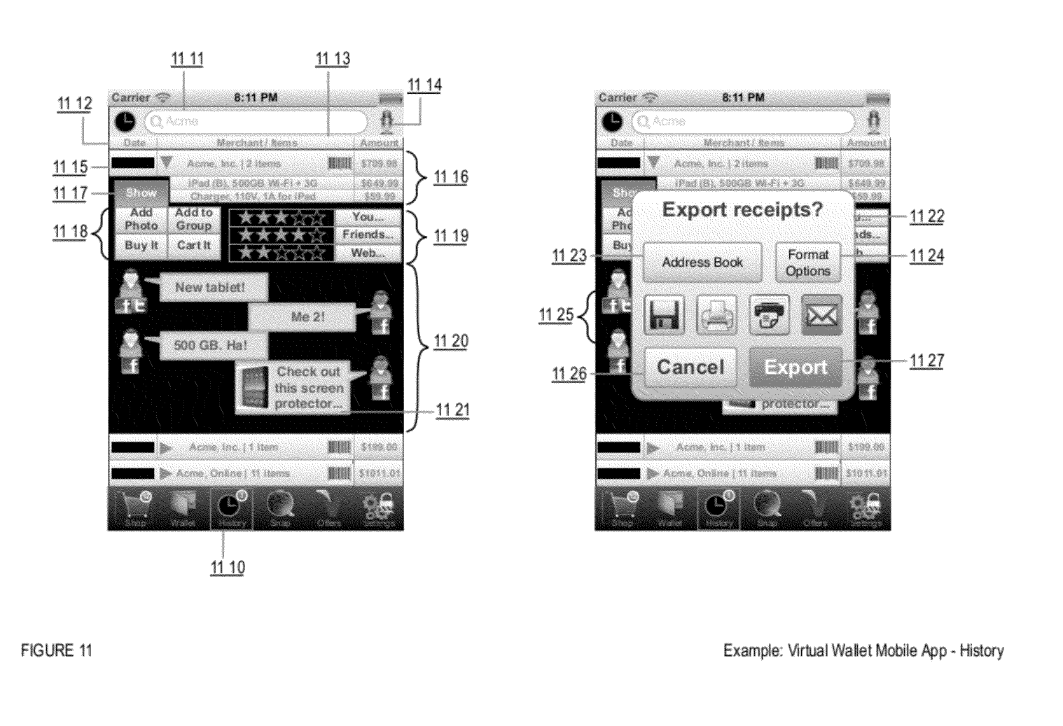

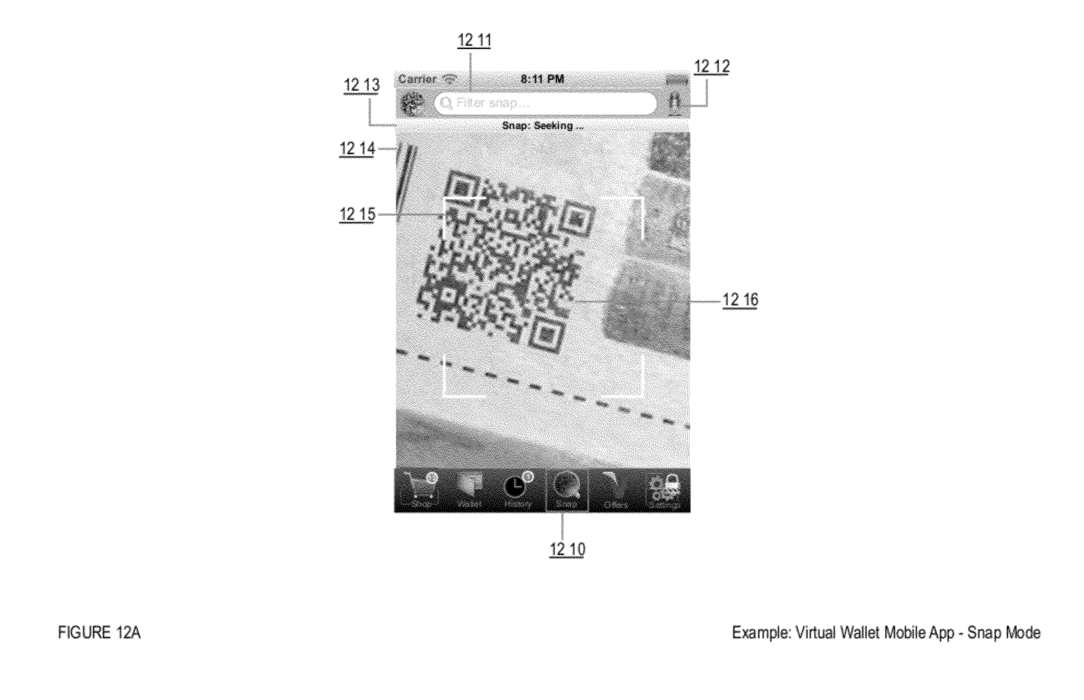

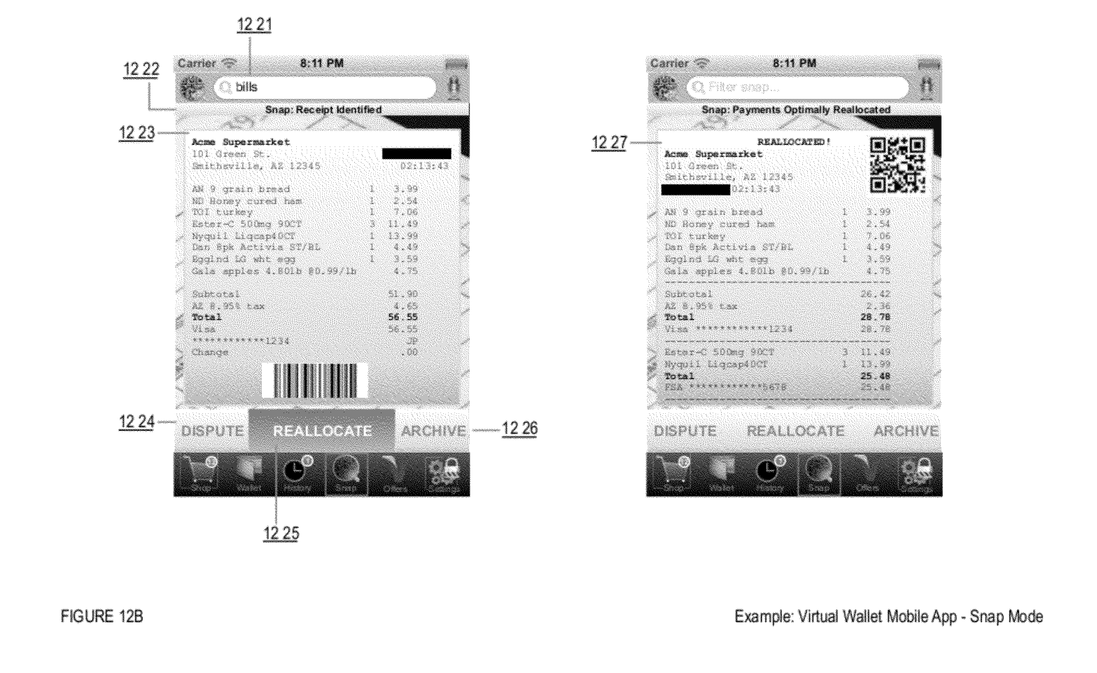

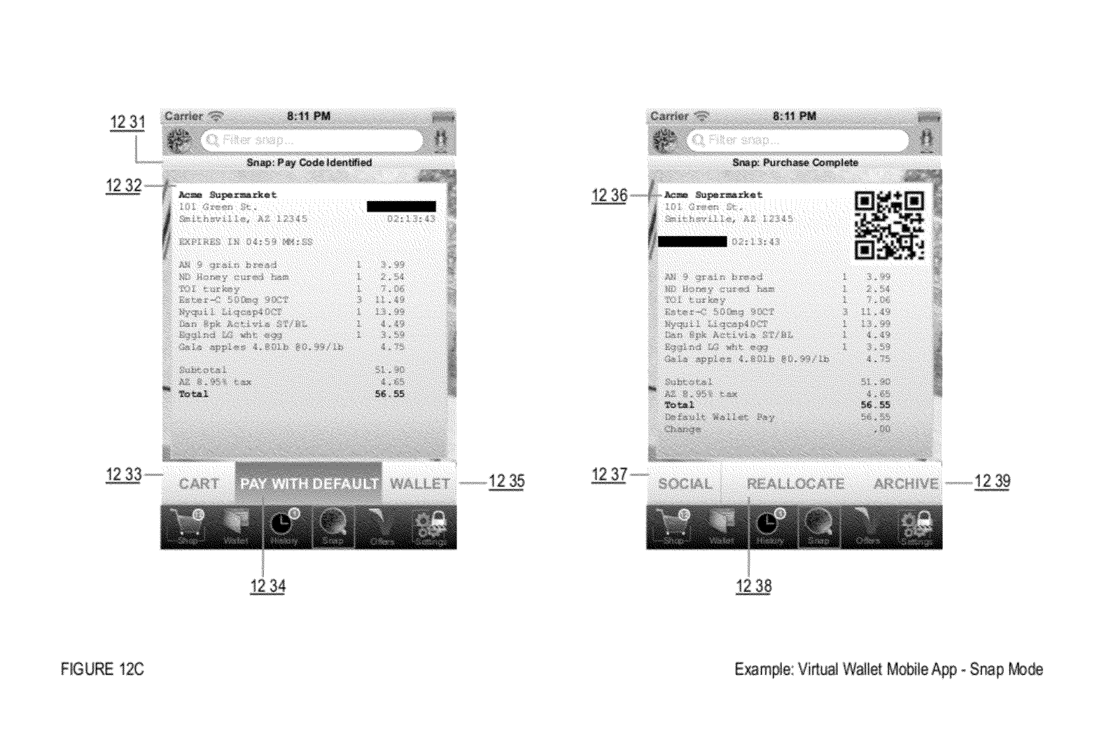

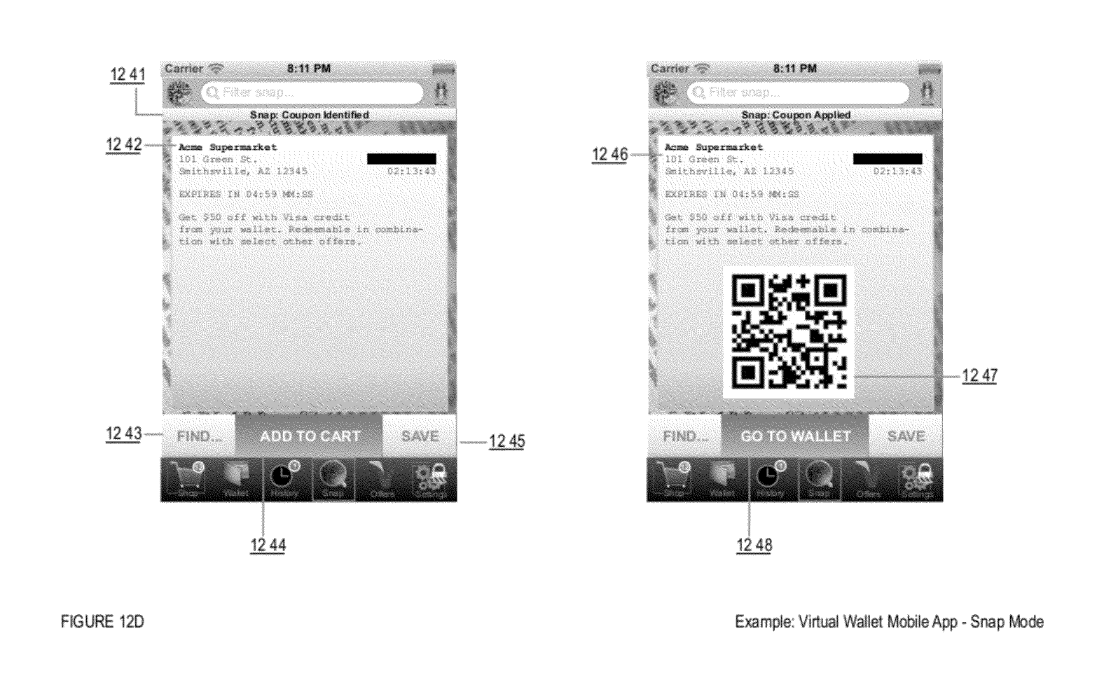

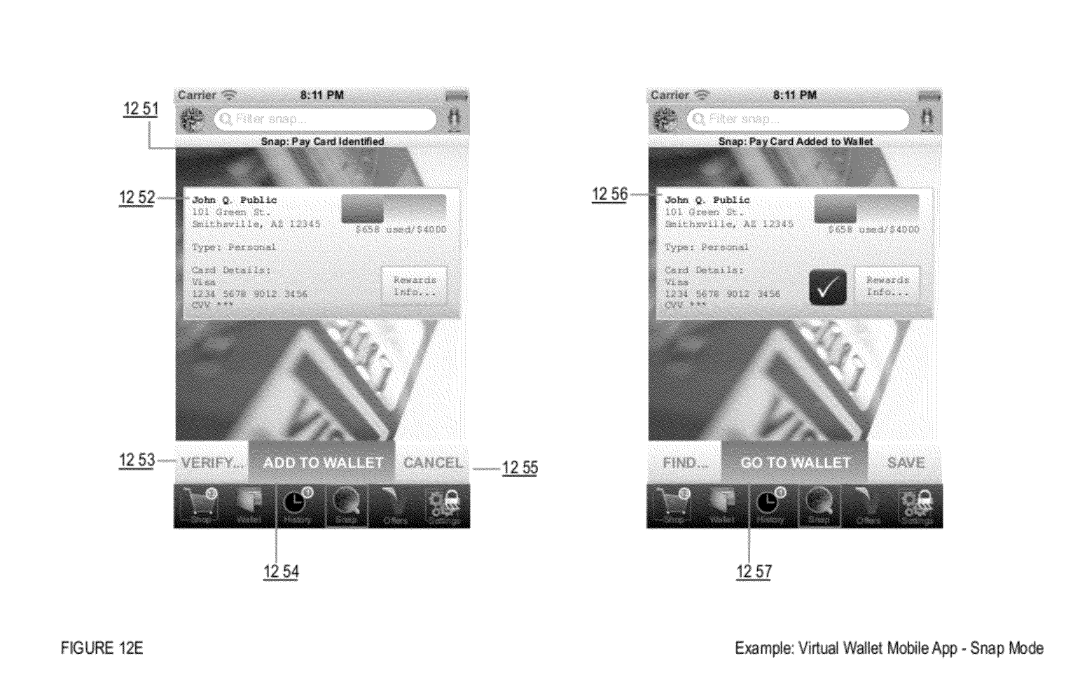

FIGS. 12A-E show user interface diagrams illustrating example features of virtual wallet applications in a snap mode, in some embodiments of the PPT. With reference to FIG. 12A, in one embodiment, a user may select the snap mode 2110 to access its snap features. The snap mode may handle any machine-readable representation of data. Examples of such data may include linear and 2D bar codes such as UPC code and QR codes. These codes may be found on receipts, product packaging, and/or the like. The snap mode may also process and handle pictures of receipts, products, offers, credit cards or other payment devices, and/or the like. An example user interface in snap mode is shown in FIG. 12A. A user may use his or her mobile phone to take a picture of a QR code 1215 and/or a barcode 1214. In one implementation, the bar 1213 and snap frame 1215 may assist the user in snapping codes properly. For example, the snap frame 1215, as shown, does not capture the entirety of the code 1216. As such, the code captured in this view may not be resolvable as information in the code may be incomplete. This is indicated by the message on the bar 1213 that indicates that the snap mode is still seeking the code. When the code 1216 is completely framed by the snap frame 1215, the bar message may be updated to, for example, “snap found.” Upon finding the code, in one implementation, the user may initiate code capture using the mobile device camera. In another implementation, the snap mode may automatically snap the code using the mobile device camera.

With reference to FIG. 12B, in one embodiment, the snap mode may facilitate payment reallocation post transaction. For example, a user may buy grocery and prescription items from a retailer Acme Supermarket. The user may, inadvertently or for ease of checkout for example, use his or her Visa card to pay for both grocery and prescription items. However, the user may have an FSA account that could be used to pay for prescription items, and which would provide the user tax benefits. In such a situation, the user may use the snap mode to initiate transaction reallocation.

As shown, the user may enter a search term (e.g., bills) in the search bar 2121. The user may then identify in the tab 1222 the receipt 1223 the user wants to reallocate. Alternatively, the user may directly snap a picture of a barcode on a receipt, and the snap mode may generate and display a receipt 1223 using information from the barcode. The user may now reallocate 1225. In some implementations, the user may also dispute the transaction 1224 or archive the receipt 1226.

In one implementation, when the reallocate button 1225 is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt 1227 may be generated after the completion of the reallocation process. As discussed, the receipt shows that some charges have been moved from the Visa account to the FSA.

With reference to FIG. 12C, in one embodiment, the snap mode may facilitate payment via pay code such as barcodes or QR codes. For example, a user may snap a QR code of a transaction that is not yet complete. The QR code may be displayed at a merchant POS terminal, a web site, or a web application and may be encoded with information identifying items for purchase, merchant details and other relevant information. When the user snaps such as a QR code, the snap mode may decode the information in the QR code and may use the decoded information to generate a receipt 1232. Once the QR code is identified, the navigation bar 1231 may indicate that the pay code is identified. The user may now have an option to add to cart 1233, pay with a default payment account 1234 or pay with wallet 1235.

In one implementation, the user may decide to pay with default 1234. The wallet application may then use the user's default method of payment, in this example the wallet, to complete the purchase transaction. Upon completion of the transaction, a receipt may be automatically generated for proof of purchase. The user interface may also be updated to provide other options for handling a completed transaction. Example options include social 1237 to share purchase information with others, reallocate 1238 as discussed with regard to FIG. 12B, and archive 1239 to store the receipt.

With reference to FIG. 12D, in one embodiment, the snap mode may also facilitate offer identification, application and storage for future use. For example, in one implementation, a user may snap an offer code 1241 (e.g., a bar code, a QR code, and/or the like). The wallet application may then generate an offer text 1242 from the information encoded in the offer code. The user may perform a number of actions on the offer code. For example, the user use the find button 1243 to find all merchants who accept the offer code, merchants in the proximity who accept the offer code, products from merchants that qualify for the offer code, and/or the like. The user may also apply the offer code to items that are currently in the cart using the add to cart button 1244. Furthermore, the user may also save the offer for future use by selecting the save button 1245.

In one implementation, after the offer or coupon 1246 is applied, the user may have the option to find qualifying merchants and/or products using find, the user may go to the wallet using 1248, and the user may also save the offer or coupon 1246 for later use.

With reference to FIG. 12E, in one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card 1251 and may display the textual information 1252 encoded in the pay card. The user may then perform verification of the information 1252 by selecting the verify button 1253. In one implementation, the verification may include contacting the issuer of the pay card for confirmation of the decoded information 1252 and any other relevant information. In one implementation, the user may add the pay card to the wallet by selecting the ‘add to wallet’ button 1254. The instruction to add the pay card to the wallet may cause the pay card to appear as one of the forms of payment under the funds tab 1016 discussed in FIG. 10A. The user may also cancel importing of the pay card as a funding source by selecting the cancel button 1255. When the pay card has been added to the wallet, the user interface may be updated to indicate that the importing is complete via the notification display 1256. The user may then access the wallet 1257 to begin using the added pay card as a funding source.

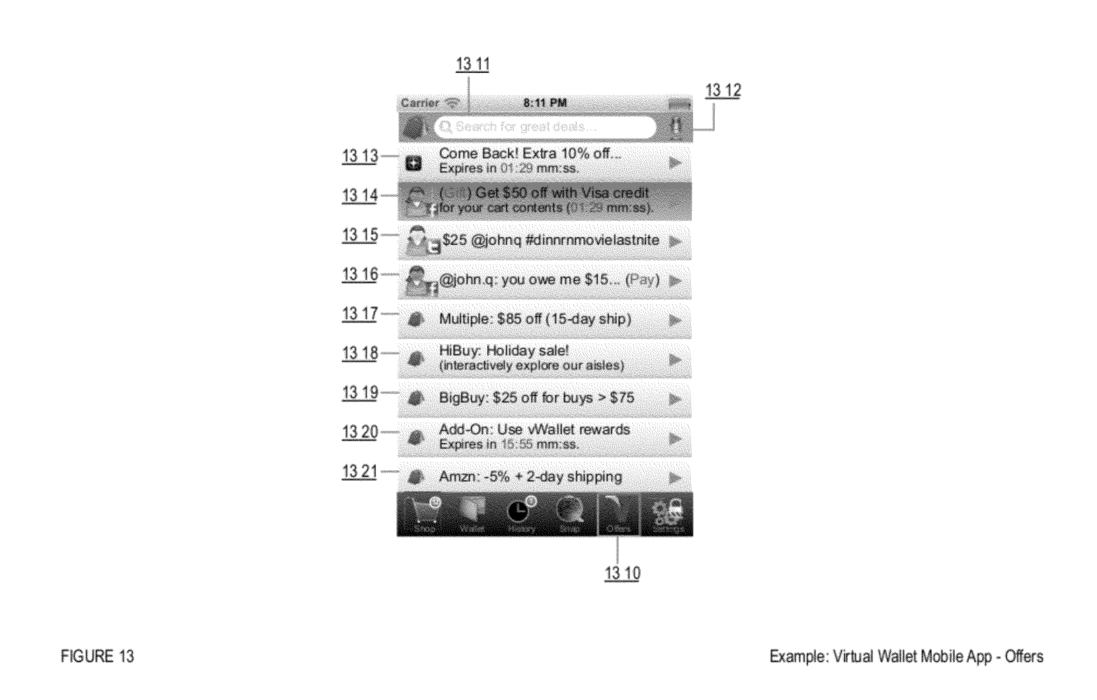

FIG. 13 shows a user interface diagram illustrating example features of virtual wallet applications, in an offers mode, in some embodiments of the PPT. In some implementations, the PPT may allow a user to search for offers for products and/or services from within the virtual wallet mobile application. For example, the user may enter text into a graphical user interface (“GUI”) element 1311, or issue voice commands by activating GUI element 1312 and speaking commands into the device. In some implementations, the PPT may provide offers based on the user's prior behavior, demographics, current location, current cart selection or purchase items, and/or the like. For example, if a user is in a brick-and-mortar store, or an online shopping website, and leaves the (virtual) store, then the merchant associated with the store may desire to provide a sweetener deal to entice the consumer back into the (virtual) store. The merchant may provide such an offer 1313. For example, the offer may provide a discount, and may include an expiry time. In some implementations, other users may provide gifts (e.g., 1314) to the user, which the user may redeem. In some implementations, the offers section may include alerts as to payment of funds outstanding to other users (e.g., 1315). In some implementations, the offers section may include alerts as to requesting receipt of funds from other users (e.g., 1316). For example, such a feature may identify funds receivable from other applications (e.g., mail, calendar, tasks, notes, reminder programs, alarm, etc.), or by a manual entry by the user into the virtual wallet application. In some implementations, the offers section may provide offers from participating merchants in the PPT, e.g., 1317-1319, 1320. These offers may sometimes be assembled using a combination of participating merchants, e.g., 1317. In some implementations, the PPT itself may provide offers for users contingent on the user utilizing particular payment forms from within the virtual wallet application, e.g., 1320.

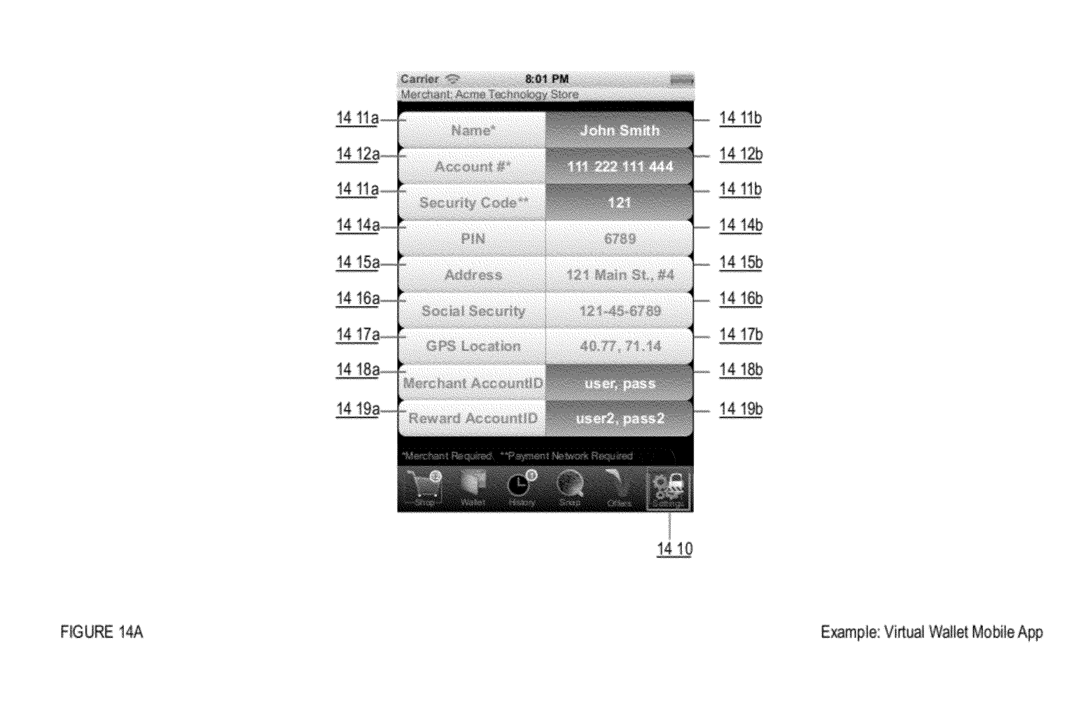

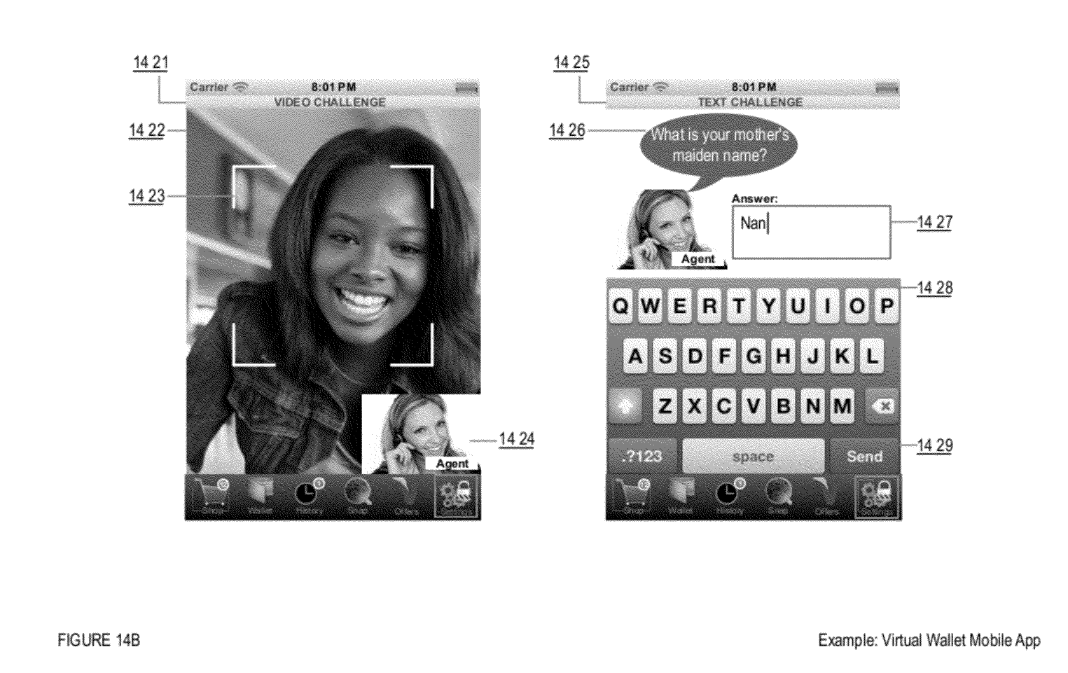

FIGS. 14A-B show user interface diagrams illustrating example features of virtual wallet applications, in a security and privacy mode, in some embodiments of the PPT. With reference to FIG. 14A, in some implementations, the user may be able to view and/or modify the user profile and/or settings of the user, e.g., by activating a user interface element. For example, the user may be able to view/modify a user name (e.g., 1411a-b), account number (e.g., 1412a-b), user security access code (e.g., 1413-b), user pin (e.g., 1414-b), user address (e.g., 1415-b), social security number associated with the user (e.g., 1416-b), current device GPS location (e.g., 1417-b), user account of the merchant in whose store the user currently is (e.g., 1418-b), the user's rewards accounts (e.g., 1419-b), and/or the like. In some implementations, the user may be able to select which of the data fields and their associated values should be transmitted to facilitate the purchase transaction, thus providing enhanced data security for the user. For example, in the example illustration in FIG. 14A, the user has selected the name 1411a, account number 1412a, security code 1413a, merchant account ID 1418a and rewards account ID 1419a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the PPT with the GPS location of the user. Based on the GPS location of the user, the PPT may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 14B, in some implementations, the app executing on the user's device may provide a “VerifyChat” feature for fraud prevention. For example, the PPT may detect an unusual and/or suspicious transaction. The PPT may utilize the VerifyChat feature to communicate with the user, and verify the authenticity of the originator of the purchase transaction. In various implementations, the PPT may send electronic mail message, text (SMS) messages, Facebook® messages, Twitter™ tweets, text chat, voice chat, video chat (e.g., Apple FaceTime), and/or the like to communicate with the user. For example, the PPT may initiate a video challenge for the user, e.g., 1421. For example, the user may need to present him/her-self via a video chat, e.g., 1422. In some implementations, a customer service representative, e.g., agent 1424, may manually determine the authenticity of the user using the video of the user. In some implementations, the PPT may utilize face, biometric and/or like recognition (e.g., using pattern classification techniques) to determine the identity of the user. In some implementations, the app may provide reference marker (e.g., cross-hairs, target box, etc.), e.g., 1423, so that the user may the video to facilitate the PPT's automated recognition of the user. In some implementations, the user may not have initiated the transaction, e.g., the transaction is fraudulent. In such implementations, the user may cancel the challenge. The PPT may then cancel the transaction, and/or initiate fraud investigation procedures on behalf of the user.

In some implementations, the PPT may utilize a text challenge procedure to verify the authenticity of the user, e.g., 1425. For example, the PPT may communicate with the user via text chat, SMS messages, electronic mail, Facebook® messages, Twitter™ tweets, and/or the like. The PPT may pose a challenge question, e.g., 1426, for the user. The app may provide a user input interface element(s) (e.g., virtual keyboard 1428) to answer the challenge question posed by the PPT. In some implementations, the challenge question may be randomly selected by the PPT automatically; in some implementations, a customer service representative may manually communicate with the user. In some implementations, the user may not have initiated the transaction, e.g., the transaction is fraudulent. In such implementations, the user may cancel the text challenge. The PPT may cancel the transaction, and/or initiate fraud investigation on behalf of the user.

### PPT Controller

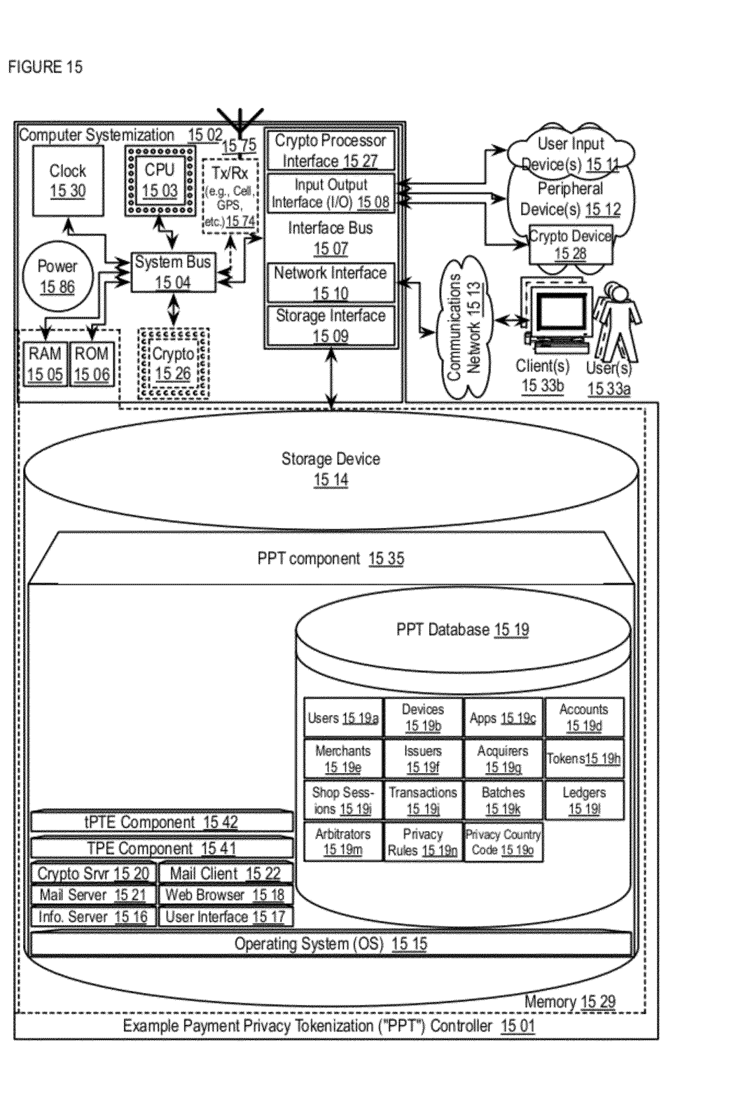

FIG. 15 illustrates inventive aspects of a PPT controller 1501 in a block diagram. In this embodiment, the PPT controller 1501 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 1503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PPT controller 1501 may be connected to and/or communicate with entities such as, but not limited to: one or more users from user input devices 1511; peripheral devices 1512; an optional cryptographic processor device 1528; and/or a communications network 1513. For example, the PPT controller 1501 may be connected to and/or communicate with users operating client device(s) including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PPT controller 1501 may be based on computer systems that may comprise, but are not limited to, components such as: a computer systemization 1502 connected to memory 1529.

### Computer Systemization

A computer systemization 1502 may comprise a clock 1530, central processing unit (“CPU(s)” and/or “processor(s)” (these terms are used interchangeable throughout the disclosure unless noted to the contrary)) 1503, a memory 1529 (e.g., a read only memory (ROM) 1506, a random access memory (RAM) 1505, etc.), and/or an interface bus 1507, and most frequently, although not necessarily, are all interconnected and/or communicating through a system bus 1504 on one or more (mother)board(s) 1502 having conductive and/or otherwise transportive circuit pathways through which instructions (e.g., binary encoded signals) may travel to effect communications, operations, storage, etc. Optionally, the computer systemization may be connected to an internal power source 1586; e.g., optionally the power source may be internal. Optionally, a cryptographic processor 1526 and/or transceivers (e.g., ICs) 1574 may be connected to the system bus. In another embodiment, the cryptographic processor and/or transceivers may be connected as either internal and/or external peripheral devices 1512 via the interface bus I/O. In turn, the transceivers may be connected to antenna(s) 1575, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing PPT controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PPT controller and beyond through various interfaces. Should processing requirements dictate a greater amount speed and/or capacity, distributed processors (e.g., Distributed PPT), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the PPT may be achieved by implementing a microcontroller such as CAST's R8051XC2 microcontroller; Intel's MCS 51 (i.e., 8051 microcontroller); and/or the like. Also, to implement certain features of the PPT, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PPT component collection (distributed or otherwise) and/or features may be implemented via the microprocessor and/or via embedded components; e.g., via ASIC, coprocessor, DSP, FPGA, and/or the like. Alternately, some implementations of the PPT may be implemented with embedded components that are configured and used to achieve a variety of features or signal processing.

Depending on the particular implementation, the embedded components may include software solutions, hardware solutions, and/or some combination of both hardware/software solutions. For example, PPT features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PPT features. A hierarchy of programmable interconnects allow logic blocks to be interconnected as needed by the PPT system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the PPT may be developed on regular FPGAs and then migrated into a fixed version that more resembles ASIC implementations. Alternate or coordinating implementations may migrate PPT controller features to a final ASIC instead of or in addition to FPGAs. Depending on the implementation all of the aforementioned embedded components and microprocessors may be considered the “CPU” and/or “processor” for the PPT.

### Power Source

The power source 1586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1586 is connected to at least one of the interconnected subsequent components of the PPT thereby providing an electric current to all subsequent components. In one example, the power source 1586 is connected to the system bus component 1504. In an alternative embodiment, an outside power source 1586 is provided through a connection across the I/O 1508 interface. For example, a USB and/or IEEE 1394 connection carries both data and power across the connection and is therefore a suitable source of power.

### Interface Adapters

Interface bus(ses) 1507 may accept, connect, and/or communicate to a number of interface adapters, conventionally although not necessarily in the form of adapter cards, such as but not limited to: input output interfaces (I/O) 1508, storage interfaces 1509, network interfaces 1510, and/or the like. Optionally, cryptographic processor interfaces 1527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1509 may accept, communicate, and/or connect to a number of storage devices such as, but not limited to: storage devices 1514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1510 may accept, communicate, and/or connect to a communications network 1513. Through a communications network 1513, the PPT controller is accessible through remote clients 1533b (e.g., computers with web browsers) by users 1533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed PPT), architectures may similarly be employed to pool, load balance, and/or otherwise increase the communicative bandwidth required by the PPT controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1510 may be used to engage with various communications network types 1513. For example, multiple network interfaces may be employed to allow for the communication over broadcast, multicast, and/or unicast networks.

Input Output interfaces (I/O) 1508 may accept, communicate, and/or connect to user input devices 1511, peripheral devices 1512, cryptographic processor devices 1528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.na/b/g/n/x, Bluetooth, cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1511 often are a type of peripheral device 1512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1512 may be connected and/or communicate to I/O and/or other facilities of the like such as network interfaces, storage interfaces, directly to the interface bus, system bus, the CPU, and/or the like. Peripheral devices may be external, internal and/or part of the PPT controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 1528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the PPT controller may be embodied as an embedded, dedicated, and/or monitor-less (i.e., headless) device, wherein access would be provided over a network interface connection.

Cryptographic units such as, but not limited to, microcontrollers, processors 1526, interfaces 1527, and/or devices 1528 may be attached, and/or communicate with the PPT controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1529. However, memory is a fungible technology and resource, thus, any number of memory embodiments may be employed in lieu of or in concert with one another. It is to be understood that the PPT controller and/or a computer systemization may employ various forms of memory 1529. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1529 will include ROM 1506, RAM 1505, and a storage device 1514. A storage device 1514 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1529 may contain a collection of program and/or database components and/or data such as, but not limited to: operating system component(s) 1515 (operating system); information server component(s) 1516 (information server); user interface component(s) 1517 (user interface); Web browser component(s) 1518 (Web browser); database(s) 1519; mail server component(s) 1521; mail client component(s) 1522; cryptographic server component(s) 1520 (cryptographic server); the PPT component(s) 1535; and/or the like (i.e., collectively a component collection). These components may be stored and accessed from the storage devices and/or from storage devices accessible through an interface bus. Although non-conventional program components such as those in the component collection, typically, are stored in a local storage device 1514, they may also be loaded and/or stored in memory such as: peripheral devices, RAM, remote storage facilities through a communications network, ROM, various forms of memory, and/or the like.

### Operating System

The operating system component 1515 is an executable program component facilitating the operation of the PPT controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the PPT controller to communicate with other entities through a communications network 1513. Various communication protocols may be used by the PPT controller as a subcarrier transport mechanism for interaction, such as, but not limited to: multicast, TCP/IP, UDP, unicast, and/or the like.

### Information Server

An information server component 1516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PPT controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the 14 “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PPT database 1519, operating systems, other program components, user interfaces, Web browsers, and/or the like.

Access to the PPT database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PPT. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PPT as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows 6 (e.g., which may include additional Unix graphic interface libraries and layers such as K Desktop Environment (KDE), mythTV and GNU Network Object Model Environment 8 (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the PPT enabled nodes. The combined application may be nugatory on systems employing standard Web browsers.

### Mail Server

A mail server component 1521 is a stored program component that is executed by a CPU 1503. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP₃), simple mail transfer protocol (SMTP), and/or the like. The mail server can route, forward, and process incoming and outgoing mail messages that have been sent, relayed and/or otherwise traversing through and/or to the PPT.

Access to the PPT mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1522 is a stored program component that is executed by a CPU 1503. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP₃, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1520 is a stored program component that is executed by a CPU 1503, cryptographic processor 1526, cryptographic processor interface 1527, cryptographic processor device 1528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the PPT may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the PPT component to engage in secure transactions if so desired. The cryptographic component facilitates the secure accessing of resources on the PPT and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The PPT Database

The PPT database component 1519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the PPT database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the PPT database is implemented as a data-structure, the use of the PPT database 1519 may be integrated into another component such as the PPT component 1535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1519 includes several tables 1519a-n. A Users table 1519a may include fields such as, but not limited to: user_id, token_id, ssn, dob, first_name, last_name, age, state, address_firstline, address_secondline, zipcode, devices_list, contact_info, contact_type, alt contact_info, alt contact_type, and/or the like. The Users table may support and/or track multiple entity accounts on a PPT. A Devices table 1519b may include fields such as, but not limited to: device_ID, device_name, device_IP, device_GPS, device_MAC, device_serial, device_ECID, device_UDID, device_browser, device_type, device_model, device_version, device_OS, device_apps_list, device_securekey, wallet_app_installed_flag, and/or the like. An Apps table 1519c may include fields such as, but not limited to: app_ID, app_name, app_type, app dependencies, app_access_code, user_pin, and/or the like. An Accounts table 1519d may include fields such as, but not limited to: account_number, account_security_code, account_name, issuer_acquirer_flag, issuer_name, acquirer_name, account_address, routing_number, access_API call, linked_wallets_list, and/or the like. A Merchants table 1519e may include fields such as, but not limited to: merchant_id, merchant_name, merchant address, store_id, ip_address, mac_address, auth_key, port_num, security_settings_list, and/or the like. An Issuers table 1519f may include fields such as, but not limited to: issuer_id, issuer_name, issuer address, ip_address_, mac_address, auth_key, port_num, security_settings_list, and/or the like. An Acquirers table 1519g may include fields such as, but not limited to: account_firstname, account_lastname, account_type, account_num_, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Tokens table 1519h may include fields such as, but not limited to: token_id, token_phrase, token_issuer, token_md5, token security, user_id, password, token_composition_list, account_link, and/or the like. A Shop Sessions table 1519i may include fields such as, but not limited to: user_id, session_id, alerts_URL, timestamp, expiry lapse, merchant_id, store_id, device_type, device_ID, device_IP, device_MAC, device_browser, device_serial, device_ECID, device_model, device_OS, wallet_app_installed, total_cost, cart_ID_list, product_params_list, social_flag, social_message, social_networks_list, coupon_lists, accounts_list, CVV2_lists, charge_ratio_list, charge_priority_list, value exchange symbols_list, bill_address, ship_address, cloak_flag, pay_mode, alerts_rules_list, and/or the like. A Transactions table 1519j may include fields such as, but not limited to: order_id, user_id, timestamp, transaction_cost, purchase details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account_priority account_ratio, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 1519k may include fields such as, but not limited to: batch_id, transaction_id_list, timestamp_list, cleared_flag_list, clearance_trigger_settings, and/or the like. A Ledgers table 15191 may include fields such as, but not limited to: request_id, timestamp, deposit_amount, batch_id, transaction_id, clear_flag, deposit_account, transaction_summary, payor_name, payor_account, and/or the like. An Arbitrators table 1519m may include fields such as, but not limited to: arbitrator_id, arbitrator_name, arbitrator_geo, arbitrator_IP, arbitrator_URL, merchant_service_list, and/or the like. A Privacy Rules table 1519n may include fields such as, but not limited to: user_id, token_id, home_location, home_country, default_privacy_flag, privacy_rule_set_id, country, privacy_rule_data, privacy_rule_triggers_list, process_restriction_flag, process_restrictions_list, home_token_server_ip, and/or the like. A Privacy Country Code table 15190 may include fields such as, but not limited to: token_hash_ID, country_code, privacy_rule_set_id, and/or the like.

In one embodiment, the PPT database may interact with other database systems. For example, employing a distributed database system, queries and data access by search PPT component may treat the combination of the PPT database, an integrated data security layer database as a single database entity.

In one embodiment, user programs may contain various user interface primitives, which may serve to update the PPT. Also, various accounts may require custom database tables depending upon the environments and the types of clients the PPT may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1519a-n. The PPT may be configured to keep track of various settings, inputs, and parameters via database controllers.

The PPT database may communicate to and/or with other components in a component collection, including itself, and/or facilities of the like. Most frequently, the PPT database communicates with the PPT component, other program components, and/or the like. The database may contain, retain, and provide information regarding other nodes and data.

### The PPTs

The PPT component 1535 is a stored program component that is executed by a CPU. In one embodiment, the PPT component incorporates any and/or all combinations of the aspects of the PPT discussed in the previous figures. As such, the PPT affects accessing, obtaining and the provision of information, services, transactions, and/or the like across various communications networks.

The PPT component may transform payment token-based purchase orders via PPT components into multi-issuer purchase payment funds transfers, and/or the like and use of the PPT. In one embodiment, the PPT component 1535 takes inputs (e.g., purchase input 411, token arbitrator address 416, token creation input 423, purchase input 611, token arbitrator address 616, issuer data response 62o, payment option input 626, issuer server data 636, user data 640a-n, batch data 655, issuer server data 663, and/or the like) etc., and transforms the inputs via various components (e.g., TPE 1541, tPTE 1542, and/or the like), into outputs (e.g., tokenization invitation 420, token data 426, token authentication confirmation 622a, issuer data update 629, “authorization in progress” message 630-31, token data 634, authorization fail message 644, transaction data 645, authorization response 642a-n, authorization success message 646-47, batch append data 649, purchase receipt 65o, transaction data 661, funds transfer message 668-69, and/or the like).

The PPT component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PPT server employs a cryptographic server to encrypt and decrypt communications. The PPT component may communicate to and/or with other components in a component collection, including itself, and/or facilities of the like. Most frequently, the PPT component communicates with the PPT database, operating systems, other program components, and/or the like. The PPT may contain, communicate, generate, obtain, and/or provide program component, system, user, and/or data communications, requests, and/or responses.

### Distributed PPTs

The structure and/or operation of any of the PPT node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PPT controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c -post http://... Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PPT controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock) ;
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm

.IBMDI.doc/referenceguide295.htm

and other parser implementations:

http://publib.boulder.ibm.com/infocenter/tivihelp/v2r1/index.jsp?topic=/com.ibm

.IBMDI.doc/referenceguide259.htm

all of which are hereby expressly incorporated by reference.

Non-limiting exemplary embodiments highlighting numerous further advantageous aspects include:

1. A payment privacy tokenization apparatus embodiment, comprising:

a processor;

a network communication device operatively connected to the processor; and

a memory operatively connected to the processor and storing processor-executable instructions to:
obtain in the memory, via the network communication device, a purchase transaction request including a payment token in lieu of payment information, and an originating location identifier for a geographical origin of the purchase transaction request;
extract, via the processor, the payment token included in the purchase transaction request;
query a database, using the extracted payment token, for a transaction processing privacy rule set associated with the payment token;
obtain in the memory, from the database, the transaction processing privacy rule set associated with the payment token;
extract, via the processor, a privacy rule from the obtained transaction processing privacy rule set;
determine, via the processor, whether the privacy rule prohibits submitting the purchase transaction request for processing in a country associated with the originating location identifier; and
provide, via the network communication device, the purchase transaction request to a payment network server according to the determination of whether the privacy rule prohibits submitting the purchase transaction for processing in the country associated with the originating location identifier.

2. The apparatus of embodiment 1, the memory further storing instructions to:
identify, via the processor, an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

3. The apparatus of embodiment 1, the memory further storing instructions to:
identify, via the processor, an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

4. The apparatus of embodiment 1, the memory further storing instructions to:
identify, via the processor, an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

5. The apparatus of embodiment 1, the memory further storing instructions to:
query a database for a set of factors for selecting a payment network server to which to provide the purchase transaction request, upon determining that the privacy rule permits submitting the purchase transaction for processing in one of a plurality of countries; and
obtain, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

6. The apparatus of embodiment 5, wherein network congestion is included in the set of factors for selecting the payment network server to which to provide the purchase transaction request.

7. The apparatus of embodiment 5, wherein server load balancing is included in the set of factors for selecting the payment network server to which to provide the purchase transaction request.

8. A payment privacy tokenization medium embodiment storing processor-issuable instructions to:
obtain in the memory, via the network communication device, a purchase transaction request including a payment token in lieu of payment information, and an originating location identifier for a geographical origin of the purchase transaction request;
extract, via the processor, the payment token included in the purchase transaction request;
query a database, using the extracted payment token, for a transaction processing privacy rule set associated with the payment token;
obtain in the memory, from the database, the transaction processing privacy rule set associated with the payment token;
extract, via the processor, a privacy rule from the obtained transaction processing privacy rule set;
determine, via the processor, whether the privacy rule prohibits submitting the purchase transaction request for processing in a country associated with the originating location identifier; and
provide, via the network communication device, the purchase transaction request to a payment network server according to the determination of whether the privacy rule prohibits submitting the purchase transaction for processing in the country associated with the originating location identifier.

9. The medium of embodiment 8, further storing instructions to:
identify, via the processor, an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

10. The medium of embodiment 8, further storing instructions to:
identify, via the processor, an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

11. The medium of embodiment 8, further storing instructions to:
identify, via the processor, an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

12. The medium of embodiment 8, further storing instructions to:
query a database for a set of factors for selecting a payment network server to which to provide the purchase transaction request, upon determining that the privacy rule permits submitting the purchase transaction for processing in one of a plurality of countries; and
obtain, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

13. The medium of embodiment 12, wherein network congestion is included in the set of factors for selecting the payment network server to which to provide the purchase transaction request.

14. The medium of embodiment 12, wherein server load balancing is included in the set of factors for selecting the payment network server to which to provide the purchase transaction request.

15. A payment privacy tokenization means embodiment, comprising means for:
obtaining a purchase transaction request including a payment token in lieu of payment information, and an originating location identifier for a geographical origin of the purchase transaction request;
extracting the payment token included in the purchase transaction request;
querying a database, using the extracted payment token, for a transaction processing privacy rule set associated with the payment token;
obtaining the transaction processing privacy rule set associated with the payment token;
extracting a privacy rule from the obtained transaction processing privacy rule set;
determining whether the privacy rule prohibits submitting the purchase transaction request for processing in a country associated with the originating location identifier; and
providing the purchase transaction request to a payment network server according to the determination of whether the privacy rule prohibits submitting the purchase transaction for processing in the country associated with the originating location identifier.

16. The means of embodiment 15, further comprising means for:
identifying an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

17. The means of embodiment 15, further comprising means for:
identifying an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

18. The means of embodiment 15, further comprising means for:
identifying an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

19. The means of embodiment 15, further comprising means for:
querying a database for a set of factors for selecting a payment network server to which to provide the purchase transaction request, upon determining that the privacy rule permits submitting the purchase transaction for processing in one of a plurality of countries;
obtaining, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

20. The means of embodiment 19, wherein network congestion is included in the set of factors for selecting the payment network server to which to provide the purchase transaction request.

21. The means of embodiment 19, wherein server load balancing is included in the set of factors for selecting the payment network server to which to provide the purchase transaction request.

22. A payment privacy tokenization processor-implemented method embodiment, comprising:
obtaining in a memory, via a network communication device, a purchase transaction request including a payment token in lieu of payment information, and an originating location identifier for a geographical origin of the purchase transaction request;
extracting, via a processor, the payment token included in the purchase transaction request;
querying a database, using the extracted payment token, for a transaction processing privacy rule set associated with the payment token;
obtaining in the memory, from the database, the transaction processing privacy rule set associated with the payment token;
extracting, via the processor, a privacy rule from the obtained transaction processing privacy rule set;
determining, via the processor, whether the privacy rule prohibits submitting the purchase transaction request for processing in a country associated with the originating location identifier; and
providing, via the network communication device, the purchase transaction request to a payment network server according to the determination of whether the privacy rule prohibits submitting the purchase transaction for processing in the country associated with the originating location identifier.

23. The method of embodiment 22, further comprising:
identifying, via the processor, an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

24. The method of embodiment 22, further comprising:
identifying, via the processor, an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

25. The method of embodiment 22, further comprising:
identifying, via the processor, an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

26. The method of embodiment 22, further comprising:
querying a database for a set of factors for selecting a payment network server to which to provide the purchase transaction request, upon determining that the privacy rule permits submitting the purchase transaction for processing in one of a plurality of countries; and
obtaining, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

27. The method of embodiment 26, wherein network congestion is included in the set of factors for selecting the payment network server to which to provide the purchase transaction request.

28. The method of embodiment 26, wherein server load balancing is included in the set of factors for selecting the payment network server to which to provide the purchase transaction request.

29. A payment privacy token arbitration processor-implemented method embodiment, comprising:
receiving, from a user mobile device in a first country location, a purchase request;
responding to the purchase request with a request for payment containing at least an amount of payment requested;
receiving from the user mobile device, a one-way cryptographically hashed purchase token, wherein the one-way cryptographically hashed purchase token was created using at least a user account identifier;
querying a data privacy country code user database using the one-way cryptographically hashed purchase token to determine a home country code for the user;
querying a country code privacy rules database with the home country code for the user to determine a privacy maintenance requirement rule set;
generating, using the privacy maintenance requirement rule set, at least one acceptable processing location identifier;
selecting a target country location for processing the purchase request that is one of:
   the first country location, when the first country location is contained within the at least one acceptable processing location, and
   another country from the at least one acceptable processing location, when the first country is not contained within the at least one acceptable processing location;
communicating the one-way cryptographically hashed purchase token to a server in the target country location for processing the purchase request;
receiving confirmation from the server in the target country location that the payment request has been successfully processed; and
transmitting to the user mobile device a confirmation that the purchase request has been authorized in the amount of payment requested.

30. A payment privacy token arbitration processor-implemented method embodiment, comprising:
receiving, from a user device in a first country location, a purchase request and a privacy enhanced purchase token;
determining a privacy maintenance requirement rule set using the privacy enhanced purchase token;
selecting a target country location for processing the purchase request based on the privacy maintenance requirement rule set; and
processing the purchase request using a server located in the target country location.

31. The method of embodiment 30, wherein the user device is a mobile device.

32. The method of embodiment 31, wherein the mobile device is one of a smart card, prepaid card, credit card, debit card, smart phone, PDA, laptop, and handheld computing device.

33. The method of embodiment 30, wherein the privacy enhanced purchase token is generated using a user account identifier.

34. The method of embodiment 33, wherein the privacy enhanced purchase token is further generated using a home country identifier.

35. The method of embodiment 30, wherein the privacy enhanced purchase token includes a user home country location identifier.

36. The method of embodiment 30, wherein the privacy enhanced purchase token is generated using user payment account data.

37. The method of embodiment 30, wherein the privacy enhanced purchase token is encrypted using the MD5 hash function.

38. The method of embodiment 30, wherein the privacy enhanced purchase token is encrypted using the Elf64 hash function.

39. The method of embodiment 30, wherein the privacy enhanced purchase token is encrypted using public key encryption.

40. The method of embodiment 30, wherein the privacy enhanced purchase token is encrypted using a bi-directional encryption algorithm.

41. The method of embodiment 30, further comprising discerning the contents of the privacy enhanced purchase token.

42. The method of embodiment 30, wherein the privacy maintenance requirement rule set requires that payments always be processed in a user's home country.

43. The method of embodiment 30, wherein the privacy maintenance requirement rule set requires that payments always be processed in a given region.

44. The method of embodiment 43, wherein the given region is the European Union.

45. The method of embodiment 30, wherein the privacy maintenance requirement rule set indicates that no requirement prevents the sharing of user information and includes rules to efficiently process payments.

46. The method of embodiment 45 wherein efficiently processing payments comprises sending payment processing to a server having a lesser load.

47. The method of embodiment 45 wherein efficiently processing payments comprises sending payment processing to a server on a network having less network congestion.

48. The method of embodiment 30, wherein determining a privacy maintenance requirement rule set comprises:
querying a data privacy country code user database using the privacy enhanced purchase token to determine a home country code for the user; and
querying a country code privacy rules database with the home country code for the user to determine the privacy maintenance requirement rule set.

49. The method of embodiment 48, wherein the data privacy country code user database contains at least a user identifier and a country code.

50. The method of embodiment 48, wherein the country code privacy rules database contains at least a country code and an indication of countries requiring heightened privacy maintenance.

51. The method of embodiment 30, wherein selecting a target country location for processing the purchase request comprises:
determining that the first country is not acceptable for processing the purchase request according to the privacy maintenance requirement rule set and choosing a second country that is acceptable for processing the purchase request from the privacy maintenance requirement rule set.

52. A payment privacy token arbitration processor-implemented system embodiment, comprising:
means to receive, from a user mobile device in a first country location, a purchase request;
means to respond to the purchase request with a request for payment containing at least an amount of payment requested;
means to receive from the user mobile device, a one-way cryptographically hashed purchase token, wherein the one-way cryptographically hashed purchase token was created using at least a user account identifier;
means to query a data privacy country code user database using the one-way cryptographically hashed purchase token to determine a home country code for the user;
means to query a country code privacy rules database with the home country code for the user to determine a privacy maintenance requirement rule set;
means to generate, using the privacy maintenance requirement rule set, at least one acceptable processing location identifier;
means to select a target country location for processing the purchase request that is one of:
   the first country location, when the first country location is contained within the at least one acceptable processing location, and
   another country from the at least one acceptable processing location, when the first country is not contained within the at least one acceptable processing location;
means to communicate the one-way cryptographically hashed purchase token to a server in the target country location for processing the purchase request;
means to receive confirmation from the server in the target country location that the payment request has been successfully processed; and
means to transmit to the user mobile device a confirmation that the purchase request has been authorized in the amount of payment requested.

53. A payment privacy token arbitration processor-implemented system embodiment, comprising:
means to receive, from a user device in a first country location, a purchase request and a privacy enhanced purchase token;
means to determine a privacy maintenance requirement rule set using the privacy enhanced purchase token;
means to select a target country location for processing the purchase request based on the privacy maintenance requirement rule set; and
means to process the purchase request using a server located in the target country location.

54. The system of embodiment 53, wherein the user device is a mobile device.

55. The system of embodiment 53, wherein the mobile device is one of a smart card, prepaid card, credit card, debit card, smart phone, PDA, laptop, and handheld computing device.

56. The system of embodiment 53, wherein the privacy enhanced purchase token is generated using a user account identifier.

57. The system of embodiment 56, wherein the privacy enhanced purchase token is further generated using a home country identifier.

58. The system of embodiment 53, wherein the privacy enhanced purchase token includes a user home country location identifier.

59. The system of embodiment 53, wherein the privacy enhanced purchase token is generated using user payment account data.

60. The system of embodiment 53, wherein the privacy enhanced purchase token is encrypted using the MD5 hash function.

61. The system of embodiment 53, wherein the privacy enhanced purchase token is encrypted using the Elf64 hash function.

62. The system of embodiment 53, wherein the privacy enhanced purchase token is encrypted using public key encryption.

63. The system of embodiment 53, wherein the privacy enhanced purchase token is encrypted using a bi-directional encryption algorithm.

64. The system of embodiment 53, further comprising means to discern the contents of the privacy enhanced purchase token.

65. The system of embodiment 53, wherein the privacy maintenance requirement rule set requires that payments always be processed in a user's home country.

66. The system of embodiment 53, wherein the privacy maintenance requirement rule set requires that payments always be processed in a given region.

67. The system of embodiment 66, wherein the given region is the European Union.

68. The system of embodiment 53, wherein the privacy maintenance requirement rule set indicates that no requirement prevents the sharing of user information and includes rules to efficiently process payments.

69. The system of embodiment 68 wherein efficiently processing payments comprises sending payment processing to a server having a lesser load.

70. The system of embodiment 68 wherein efficiently processing payments comprises sending payment processing to a server on a network having less network congestion.

71. The system of embodiment 53, wherein to determine a privacy maintenance requirement rule set comprises:
query a data privacy country code user database using the privacy enhanced purchase token to determine a home country code for the user; and
query a country code privacy rules database with the home country code for the user to determine the privacy maintenance requirement rule set.

72. The system of embodiment 71, wherein the data privacy country code user database contains at least a user identifier and a country code.

73. The system of embodiment 71, wherein the country code privacy rules database contains at least a country code and an indication of countries requiring heightened privacy maintenance.

74. The system of embodiment 53, wherein select a target country location for processing the purchase request further comprises:
means to determine that the first country is not acceptable for processing the purchase request according to the privacy maintenance requirement rule set and choosing a second country that is acceptable for processing the purchase request from the privacy maintenance requirement rule set.

75. A payment privacy token arbitration processor-implemented apparatus embodiment, comprising:
a memory;
a processor disposed in communication with said memory, and configured to issue a plurality of processing instructions stored in the memory, wherein the processor issues instructions to:
   receive, from a user mobile device in a first country location, a purchase request;
   respond to the purchase request with a request for payment containing at least an amount of payment requested;
   receive from the user mobile device, a one-way cryptographically hashed purchase token, wherein the one-way cryptographically hashed purchase token was created using at least a user account identifier;
   query a data privacy country code user database using the one-way cryptographically hashed purchase token to determine a home country code for the user;
   query a country code privacy rules database with the home country code for the user to determine a privacy maintenance requirement rule set;
   generate, using the privacy maintenance requirement rule set, at least one acceptable processing location identifier;
   select a target country location for processing the purchase request that is one of:
      the first country location, when the first country location is contained within the at least one acceptable processing location, and
      another country from the at least one acceptable processing location, when the first country is not contained within the at least one acceptable processing location;
   communicate the one-way cryptographically hashed purchase token to a server in the target country location for processing the purchase request;
   receive confirmation from the server in the target country location that the payment request has been successfully processed; and
   transmit to the user mobile device a confirmation that the purchase request has been authorized in the amount of payment requested.

76. A payment privacy token arbitration processor-implemented apparatus embodiment, comprising:
a memory;
a processor disposed in communication with said memory, and configured to issue a plurality of processing instructions stored in the memory, wherein the processor issues instructions to:
   receive, from a user device in a first country location, a purchase request and a privacy enhanced purchase token;
   determine a privacy maintenance requirement rule set using the privacy enhanced purchase token;
   select a target country location for processing the purchase request based on the privacy maintenance requirement rule set; and
   process the purchase request using a server located in the target country location.

77. The apparatus of embodiment 76, wherein the user device is a mobile device.

78. The apparatus of embodiment 77, wherein the mobile device is one of a smart card, prepaid card, credit card, debit card, smart phone, PDA, laptop, and handheld computing device.

79. The apparatus of embodiment 76, wherein the privacy enhanced purchase token is generated using a user account identifier.

80. The apparatus of embodiment 79, wherein the privacy enhanced purchase token is further generated using a home country identifier.

81. The apparatus of embodiment 76, wherein the privacy enhanced purchase token includes a user home country location identifier.

82. The apparatus of embodiment 76, wherein the privacy enhanced purchase token is generated using user payment account data.

83. The apparatus of embodiment 76, wherein the privacy enhanced purchase token is encrypted using the MD5 hash function.

84. The apparatus of embodiment 76, wherein the privacy enhanced purchase token is encrypted using the Elf64 hash function.

85. The apparatus of embodiment 76, wherein the privacy enhanced purchase token is encrypted using public key encryption.

86. The apparatus of embodiment 76, wherein the privacy enhanced purchase token is encrypted using a bi-directional encryption algorithm.

87. The apparatus of embodiment 76, further comprising discerning the contents of the privacy enhanced purchase token.

88. The apparatus of embodiment 76, wherein the privacy maintenance requirement rule set requires that payments always be processed in a user's home country.

89. The apparatus of embodiment 76, wherein the privacy maintenance requirement rule set requires that payments always be processed in a given region.

90. The apparatus of embodiment 89, wherein the given region is the European Union.

91. The apparatus of embodiment 76, wherein the privacy maintenance requirement rule set indicates that no requirement prevents the sharing of user information and includes rules to efficiently process payments.

92. The apparatus of embodiment 91 wherein efficiently processing payments comprises sending payment processing to a server having a lesser load.

93. The apparatus of embodiment 91 wherein efficiently processing payments comprises sending payment processing to a server on a network having less network congestion.

94. The apparatus of embodiment 76, wherein to determine a privacy maintenance requirement rule set comprises:
query a data privacy country code user database using the privacy enhanced purchase token to determine a home country code for the user; and
query a country code privacy rules database with the home country code for the user to determine the privacy maintenance requirement rule set.

95. The apparatus of embodiment 94, wherein the data privacy country code user database contains at least a user identifier and a country code.

96. The apparatus of embodiment 94, wherein the country code privacy rules database contains at least a country code and an indication of countries requiring heightened privacy maintenance.

97. The apparatus of embodiment 76, wherein select a target country location for processing the purchase request comprises:
determine that the first country is not acceptable for processing the purchase request according to the privacy maintenance requirement rule set and choosing a second country that is acceptable for processing the purchase request from the privacy maintenance requirement rule set.

98. A payment privacy token arbitration processor-readable non-transitory medium embodiment storing processor-issuable instructions to:
receive, from a user mobile device in a first country location, a purchase request;
respond to the purchase request with a request for payment containing at least an amount of payment requested;
receive from the user mobile device, a one-way cryptographically hashed purchase token, wherein the one-way cryptographically hashed purchase token was created using at least a user account identifier;
query a data privacy country code user database using the one-way cryptographically hashed purchase token to determine a home country code for the user;
query a country code privacy rules database with the home country code for the user to determine a privacy maintenance requirement rule set;
generate, using the privacy maintenance requirement rule set, at least one acceptable processing location identifier;
select a target country location for processing the purchase request that is one of:
   the first country location, when the first country location is contained within the at least one acceptable processing location, and
   another country from the at least one acceptable processing location, when the first country is not contained within the at least one acceptable processing location;
communicate the one-way cryptographically hashed purchase token to a server in the target country location for processing the purchase request;
receive confirmation from the server in the target country location that the payment request has been successfully processed; and
transmit to the user mobile device a confirmation that the purchase request has been authorized in the amount of payment requested.

99. A payment privacy token arbitration processor-readable non-transitory medium embodiment storing processor-issuable instructions to:
receive, from a user device in a first country location, a purchase request and a privacy enhanced purchase token;
determine a privacy maintenance requirement rule set using the privacy enhanced purchase token;
select a target country location for processing the purchase request based on the privacy maintenance requirement rule set; and
process the purchase request using a server located in the target country location.

100. The medium of embodiment 99, wherein the user device is a mobile device.

101. The medium of embodiment 100, wherein the mobile device is one of a smart card, prepaid card, credit card, debit card, smart phone, PDA, laptop, and handheld computing device.

102. The medium of embodiment 99, wherein the privacy enhanced purchase token is generated using a user account identifier.

103. The medium of embodiment 102, wherein the privacy enhanced purchase token is further generated using a home country identifier.

104. The medium of embodiment 99, wherein the privacy enhanced purchase token includes a user home country location identifier.

105. The medium of embodiment 99, wherein the privacy enhanced purchase token is generated using user payment account data.

106. The medium of embodiment 99, wherein the privacy enhanced purchase token is encrypted using the MD5 hash function.

107. The medium of embodiment 99, wherein the privacy enhanced purchase token is encrypted using the Elf64 hash function.

108. The medium of embodiment 99, wherein the privacy enhanced purchase token is encrypted using public key encryption.

109. The medium of embodiment 99, wherein the privacy enhanced purchase token is encrypted using a bi-directional encryption algorithm.

110. The medium of embodiment 99, further comprising discerning the contents of the privacy enhanced purchase token.

111. The medium of embodiment 99, wherein the privacy maintenance requirement rule set requires that payments always be processed in a user's home country.

112. The medium of embodiment 99, wherein the privacy maintenance requirement rule set requires that payments always be processed in a given region.

113. The medium of embodiment 112, wherein the given region is the European Union.

114. The medium of embodiment 99, wherein the privacy maintenance requirement rule set indicates that no requirement prevents the sharing of user information and includes rules to efficiently process payments.

115. The medium of embodiment 114 wherein efficiently processing payments comprises sending payment processing to a server having a lesser load.

116. The medium of embodiment 114 wherein efficiently processing payments comprises sending payment processing to a server on a network having less network congestion.

117. The medium of embodiment 99, wherein to determine a privacy maintenance requirement rule set comprises:
query a data privacy country code user database using the privacy enhanced purchase token to determine a home country code for the user; and
query a country code privacy rules database with the home country code for the user to determine the privacy maintenance requirement rule set.

118. The medium of embodiment 117, wherein the data privacy country code user database contains at least a user identifier and a country code.

119. The medium of embodiment 117, wherein the country code privacy rules database contains at least a country code and an indication of countries requiring heightened privacy maintenance.

120. The medium of embodiment 99, wherein select a target country location for processing the purchase request comprises:
determine that the first country is not acceptable for processing the purchase request according to the privacy maintenance requirement rule set and choosing a second country that is acceptable for processing the purchase request from the privacy maintenance requirement rule set.

In order to address various issues and advance the art, the entirety of this application for PAYMENT PRIVACY TOKENIZATION APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a PPT individual and/or enterprise user, database configuration and/or relational model, data type, data transmission and/or network framework, syntax structure, and/or the like, various embodiments of the PPT may be implemented that enable a great deal of flexibility and customization. For example, aspects of the PPT may be adapted for compression algorithms, security systems, communications optimization, and/or the like. While various embodiments and discussions of the PPT have been directed to purchase transactions, however, it is to be understood that the embodiments described herein may be readily configured and/or customized for a wide variety of other applications and/or implementations.

What is claimed is:

1. A payment privacy tokenization apparatus, comprising:
a processor;
a network communication device operatively connected to the processor; and
a memory operatively connected to the processor and storing processor-executable instructions to:
obtain in the memory, via the network communication device, a purchase transaction request including a payment token in lieu of payment information, and an originating location identifier for a geographical origin of the purchase transaction request;
extract, via the processor, the payment token included in the purchase transaction request;
query a database, using the extracted payment token, for a transaction processing privacy rule set associated with the payment token;
obtain in the memory, from the database, the transaction processing privacy rule set associated with the payment token;
extract, via the processor, a privacy rule from the obtained transaction processing privacy rule set;
determine, via the processor, whether the privacy rule prohibits submitting the purchase transaction request for processing in a country associated with the originating location identifier; and
provide, via the network communication device, the purchase transaction request to a payment network server according to the determination of whether the privacy rule prohibits submitting the purchase transaction for processing in the country associated with the originating location identifier.

2. The apparatus of claim 1, the memory further storing instructions to:
identify, via the processor, an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

3. The apparatus of claim 1, the memory further storing instructions to:
identify, via the processor, an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

4. The apparatus of claim 1, the memory further storing instructions to:
identify, via the processor, an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

5. The apparatus of claim 1, the memory further storing instructions to:
query a database for a set of factors for selecting a payment network server to which to provide the purchase transaction request, upon determining that the privacy rule permits submitting the purchase transaction for processing in one of a plurality of countries; and
obtain, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

6. The apparatus of claim 5, wherein network congestion is included in the set of factors for selecting the payment network server to which to provide the purchase transaction request.

7. The apparatus of claim 5, wherein server load balancing is included in the set of factors for selecting the payment network server to which to provide the purchase transaction request.

8. A non-transitory medium storing processor-issuable payment privacy tokenization instructions to:
obtain in a memory, via a network communication device, a purchase transaction request including a payment token in lieu of payment information, and an originating location identifier for a geographical origin of the purchase transaction request;
extract, via a processor, the payment token included in the purchase transaction request;
query a database, using the extracted payment token, for a transaction processing privacy rule set associated with the payment token;
obtain in the memory, from the database, the transaction processing privacy rule set associated with the payment token;
extract, via the processor, a privacy rule from the obtained transaction processing privacy rule set;
determine, via the processor, whether the privacy rule prohibits submitting the purchase transaction request for processing in a country associated with the originating location identifier; and
provide, via the network communication device, the purchase transaction request to a payment network server according to the determination of whether the privacy rule prohibits submitting the purchase transaction for processing in the country associated with the originating location identifier.

9. The medium of claim 8, further storing instructions to:
identify, via the processor, an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

10. The medium of claim 8, further storing instructions to:
identify, via the processor, an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

11. The medium of claim 8, further storing instructions to:
identify, via the processor, an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

12. The medium of claim 8, further storing instructions to:
query a database for a set of factors for selecting a payment network server to which to provide the purchase transaction request, upon determining that the privacy rule permits submitting the purchase transaction for processing in one of a plurality of countries; and
obtain, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

13. The medium of claim 12, wherein network congestion is included in the set of factors for selecting the payment network server to which to provide the purchase transaction request.

14. The medium of claim 12, wherein server load balancing is included in the set of factors for selecting the payment network server to which to provide the purchase transaction request.

15. A payment privacy tokenization means, comprising means for:
obtaining a purchase transaction request including a payment token in lieu of payment information, and an originating location identifier for a geographical origin of the purchase transaction request;
extracting the payment token included in the purchase transaction request;
querying a database, using the extracted payment token, for a transaction processing privacy rule set associated with the payment token;
obtaining the transaction processing privacy rule set associated with the payment token;
extracting a privacy rule from the obtained transaction processing privacy rule set;
determining whether the privacy rule prohibits submitting the purchase transaction request for processing in a country associated with the originating location identifier; and
providing the purchase transaction request to a payment network server according to the determination of whether the privacy rule prohibits submitting the purchase transaction for processing in the country associated with the originating location identifier.

16. The means of claim 15, further comprising means for:
identifying an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

17. The means of claim 15, further comprising means for:
identifying an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

18. The means of claim 15, further comprising means for:
identifying an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

19. The means of claim 15, further comprising means for:
querying a database for a set of factors for selecting a payment network server to which to provide the purchase transaction request, upon determining that the privacy rule permits submitting the purchase transaction for processing in one of a plurality of countries;
obtaining, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

20. The means of claim 19, wherein network congestion is included in the set of factors for selecting the payment network server to which to provide the purchase transaction request.

21. The means of claim 19, wherein server load balancing is included in the set of factors for selecting the payment network server to which to provide the purchase transaction request.

22. A payment privacy tokenization processor-implemented method, comprising:
obtaining in a memory, via a network communication device, a purchase transaction request including a payment token in lieu of payment information, and an originating location identifier for a geographical origin of the purchase transaction request;
extracting, via a processor, the payment token included in the purchase transaction request;
querying a database, using the extracted payment token, for a transaction processing privacy rule set associated with the payment token;
obtaining in the memory, from the database, the transaction processing privacy rule set associated with the payment token;
extracting, via the processor, a privacy rule from the obtained transaction processing privacy rule set;
determining, via the processor, whether the privacy rule prohibits submitting the purchase transaction request for processing in a country associated with the originating location identifier; and
providing, via the network communication device, the purchase transaction request to a payment network server according to the determination of whether the privacy rule prohibits submitting the purchase transaction for processing in the country associated with the originating location identifier.

23. The method of claim 22, further comprising:
identifying, via the processor, an address of the payment network server located outside the country associated with the originating location identifier, upon determining that the privacy rule prohibits submitting the purchase transaction for processing in the country associated with the originating location identifier; and
wherein the purchase transaction request is provided to the identified address of the payment network server located outside the country associated with the originating location identifier.

24. The method of claim 22, further comprising:
identifying, via the processor, an address of the payment network server located inside the country associated with the originating location identifier, upon determining that the privacy rule requires submitting the purchase transaction for processing in the country associated with the originating location identifier; and
wherein the purchase transaction request is provided to the identified address of the payment network server located inside the country associated with the originating location identifier.

25. The method of claim 22, further comprising:
identifying, via the processor, an address of the payment network server located inside the country associated with the originating location identifier, upon determining that the privacy rule permits submitting the purchase transaction for processing in the country associated with the originating location identifier; and
wherein the purchase transaction request is provided to the identified address of the payment network server located inside the country associated with the originating location identifier.

26. The method of claim 22, further comprising:
querying a database for a set of factors for selecting a payment network server to which to provide the purchase transaction request, upon determining that the privacy rule permits submitting the purchase transaction for processing in one of a plurality of countries; and
obtaining, in the memory, from the database, the set of factors for selecting a payment network server to which to provide the purchase transaction request from the database, and weights associated with each of the factors;
identifying a set of candidate payment network servers to which the purchase transaction may be provided for transaction processing;
calculating weighted scores for each of the candidate payment network server, using the factors and their associated weights;
selecting one from the set of candidate payment network servers based on the calculated weighted scores; and
wherein the purchase transaction request is provided to an address associated with the selected payment network server.

27. The method of claim 26, wherein network congestion is included in the set of factors for selecting the payment network server to which to provide the purchase transaction request.

28. The method of claim 26, wherein server load balancing is included in the set of factors for selecting the payment network server to which to provide the purchase transaction request.
